(19) United States
(12) Patent Application Publication
(10) Pub. No.: US 2026/0016716 A1
(43) Pub. Date: Jan. 15, 2026

(54) OPTICAL UNIT AND IMAGE DISPLAY SYSTEM

(71) Applicant: FUJIFILM Corporation, Tokyo (JP)

(72) Inventor: Hiroshi SATO, Minamiashigara-shi (JP)

(73) Assignee: FUJIFILM Corporation, Tokyo (JP)

(21) Appl. No.: 19/337,934

(22) Filed: Sep. 24, 2025

Related U.S. Application Data
(63) Continuation of application No. PCT/JP2024/015254, filed on Apr. 17, 2024.

(30) Foreign Application Priority Data
Apr. 18, 2023 (JP) 2023-067804

(51) Int. Cl. G02F 1/1335; G02F 1/1337

(52) U.S. Cl. CPC G02F 1/133504; G02F 1/133553; G02F 1/1337

(57) ABSTRACT

An optical unit and image display system are provided with reduced brightness unevenness when applied to an image display device. The optical unit includes first and second partial reflection elements, at least one of which includes a cholesteric liquid crystal layer. The cholesteric liquid crystal layer has an alignment pattern in which the optical axis orientation continuously rotates in at least one in-plane direction. When a length corresponding to a 180° rotation of the optical axis is defined as a single period, the cholesteric liquid crystal layer includes regions with different single-period lengths and regions with different helical pitches of helical structures in the plane.

### CROSS-REFERENCE TO RELATED APPLICATIONS

This application is a Continuation of PCT International Application No. PCT/JP2024/015254 filed on Apr. 17, 2024, which claims priority under 35 U.S.C. § 119(a) to Japanese Patent Application No. 2023-067804 filed on Apr. 18, 2023. The above applications are hereby expressly incorporated by reference, in their entirety, into the present application.

### BACKGROUND OF THE INVENTION

### 1. Field of the Invention

The present invention relates to an optical unit and an image display system.

### 2. Description of the Related Art

A virtual reality display device including a head mounted display (HMD) such as augmented reality (AR) glasses, virtual reality (VR) glasses, and mixed reality (MR) glasses, which display a virtual image and various information or the like in a superimposed manner on a scene that is actually being seen, is a display device which can obtain a realistic effect as if entering a virtual world by mounting a dedicated headset on a head and visually recognizing a video displayed through a lens.

As the virtual reality display device, an image display device including an optical unit called a pancake lens, which has an image display panel and two partial reflection elements and which reduces a thickness of the entire headset by reciprocating rays emitted from the image display panel between the two partial reflection elements, has been proposed.

In the image display device having such a pancake lens, it is necessary to dispose a member having a lens action for converging light in order to widen a field of view (FOV) which is a region where an image is displayed. In the optical unit of the pancake lens, a configuration in which a concave mirror is used is also considered in order to allow at least one partial reflection element to have the lens action. In a case where the concave mirror is to be provided in at least one of the partial reflection elements, and a general half mirror or the like is used as the partial reflection element, it is necessary to form the half mirror into a curved surface shape. In this case, since it is necessary to ensure a thickness for forming the half mirror into a curved surface shape, the thickness of the optical unit is increased, so that the thickness of the image display device is increased.

On the other hand, in order to further reduce the thickness, WO2021/150510A discloses that a hologram (diffraction element) with optical power is used as one of the two partial reflection elements. By using the hologram (diffraction element) with optical power as the partial reflection element, the optical unit (image display device) can be made thinner because the optical unit can be made to act as a concave mirror or a convex mirror while maintaining a flat shape.

### SUMMARY OF THE INVENTION

In such an optical unit, a reflective type diffraction element needs to deflect light more largely on an end part side. However, in a case where the reflective type diffraction element is used as the partial reflection element, diffraction efficiency decreases as a diffraction angle increases. Therefore, in a case where the reflective type diffraction element is incorporated into the image display device, there is a problem that brightness unevenness of an image to be displayed by the image display device increases.

An object of the present invention is to solve the above-described problem of the related art, and to provide an optical unit and an image display system, in which brightness unevenness of an image to be observed is small in a case of being applied to an image display device.

In order to solve the problems, the present invention has the following configuration.

[1] An optical unit comprising:
a first partial reflection element; and
a second partial reflection element,
in which any one of the first partial reflection element or the second partial reflection element includes a cholesteric liquid crystal layer,
the cholesteric liquid crystal layer has a liquid crystal alignment pattern in which an orientation of an optical axis derived from the liquid crystal compound changes while continuously rotating in at least one in-plane direction,
in a case where a length over which the orientation of the optical axis derived from the liquid crystal compound rotates by 180° in a plane is set as a single period, the cholesteric liquid crystal layer has regions having different lengths of the single periods in the plane, and
the cholesteric liquid crystal layer has regions having different helical pitches of helical structures in the plane.

[2] The optical unit according to [1],
in which, in a region of the cholesteric liquid crystal layer where the length of the single period in the liquid crystal alignment pattern is short, the helical pitch is large.

[3] The optical unit according to [1] or [2],
in which the cholesteric liquid crystal layer has a region where the length of the single period in the liquid crystal alignment pattern is less than 1.0 μm.

[4] The optical unit according to any one of [1] to [3],
in which any one of the first partial reflection element or the second partial reflection element includes a plurality of the cholesteric liquid crystal layers, and
at any one point in a plane, the plurality of the cholesteric liquid crystal layers have different lengths of the single periods and different helical pitches.

[5] The optical unit according to any one of [1] to [4],
in which any one of the first partial reflection element or the second partial reflection element includes a first cholesteric liquid crystal layer, a second cholesteric liquid crystal layer, and a third cholesteric liquid crystal layer,
at any one point in a plane, the first to third cholesteric liquid crystal layers have different lengths of the single periods and different helical pitches,
in a case where the lengths of the single periods in the first to third cholesteric liquid crystal layers at the any one point in the plane are respectively represented by Λ1, Λ2, and Λ3, the first to third cholesteric liquid crystal layers have a region where Λ1<Λ2<Λ3 is satisfied, and
the first cholesteric liquid crystal layer has a region for diffracting blue light, the second cholesteric liquid crystal layer has a region for diffracting green light, and the third cholesteric liquid crystal layer has a region for diffracting red light.

[6] The optical unit according to any one of [1] to [5],
in which the other of the first partial reflection element or the second partial reflection element is a volume hologram.

[7] The optical unit according to any one of [1] to [6],
in which the optical unit comprises the first partial reflection element, the second partial reflection element, and a first transmissive type polarization diffraction element in this order, and
the first transmissive type polarization diffraction element transmits and refracts a part of light transmitted through the second partial reflection element.

[8] The optical unit according to [7],
in which the first transmissive type polarization diffraction element includes a liquid crystal layer formed of a liquid crystal composition containing a liquid crystal compound,
the liquid crystal layer has a liquid crystal alignment pattern in which an orientation of an optical axis derived from the liquid crystal compound changes while continuously rotating in at least one in-plane direction,
in a case where a length over which the orientation of the optical axis derived from the liquid crystal compound rotates by 180° in a plane is set as a single period, the liquid crystal layer has, in the plane, regions having different lengths of the single periods in the liquid crystal alignment pattern, and
in the plane, the liquid crystal layer has regions in which the optical axis derived from the liquid crystal compound is twisted and rotates in a thickness direction of the liquid crystal layer, and has regions having different total magnitudes of twisted angles in the thickness direction.

[9] The optical unit according to any one of [1] to [8],
in which the optical unit comprises the first partial reflection element, the second partial reflection element, and a circularly polarizing plate in this order, and
the circularly polarizing plate transmits a part of light transmitted through the second partial reflection element.

[10] An image display system comprising:
the optical unit according to any one of [1] to [9]; and
an image display element.

[11] The image display system according to [10], further comprising:
an optical element disposed between the optical unit and the image display element,
in which the optical element has a function of refracting light emitted from the image display element, and
the optical element has regions where refraction angles are different at different in-plane positions.

[12] The image display system according to [10],
in which the image display system includes the optical unit and the image display element,
the image display element includes an optical element which has a function of refracting light emitted from a light source of the image display element, and
the optical element has regions where refraction angles are different at different in-plane positions.

[13] The image display system according to [11],
in which the optical element includes a liquid crystal layer formed of a liquid crystal composition containing a liquid crystal compound,
the liquid crystal layer has a liquid crystal alignment pattern in which an orientation of an optical axis derived from the liquid crystal compound changes while continuously rotating in at least one in-plane direction, and
in a case where a length over which the orientation of the optical axis derived from the liquid crystal compound rotates by 180° in a plane is set as a single period, the liquid crystal layer has, in the plane, regions having different lengths of the single periods in the liquid crystal alignment pattern.

[14] The image display system according to [12],
in which the optical element includes a liquid crystal layer formed of a liquid crystal composition containing a liquid crystal compound,
the liquid crystal layer has a liquid crystal alignment pattern in which an orientation of an optical axis derived from the liquid crystal compound changes while continuously rotating in at least one in-plane direction, and
in a case where a length over which the orientation of the optical axis derived from the liquid crystal compound rotates by 180° in a plane is set as a single period, the liquid crystal layer has, in the plane, regions having different lengths of the single periods in the liquid crystal alignment pattern.

According to the present invention, it is possible to provide an optical unit and an image display system, which have less brightness unevenness of an image to be observed in a case of being applied to an image display device.

### BRIEF DESCRIPTION OF THE DRAWINGS

FIG. 1 is a view conceptually showing an example of an image display system including the optical unit according to the embodiment of the present invention.

FIG. 2 is a conceptual view of the image display system shown in FIG. 1.

FIG. 3 is a view conceptually showing an image display system including another example of the optical unit according to the embodiment of the present invention.

FIG. 4 is a view conceptually showing an image display system including another example of the optical unit according to the embodiment of the present invention.

FIG. 5 is a view conceptually showing an image display system including another example of the optical unit according to the embodiment of the present invention.

FIG. 6 is a view conceptually showing an image display system including another example of the optical unit according to the embodiment of the present invention.

FIG. 7 is a view conceptually showing an image display system including another example of the optical unit according to the embodiment of the present invention.

FIG. 8 is a view conceptually showing an example of a partial reflection element included in the optical unit according to the embodiment of the present invention.

FIG. 9 is a conceptual view for describing a cholesteric liquid crystal layer of the partial reflection element shown in FIG. 8.

FIG. 10 is a plan view showing the cholesteric liquid crystal layer of the partial reflection element shown in FIG. 8.

FIG. 11 is a conceptual view for describing an action of the cholesteric liquid crystal layer of the partial reflection element shown in FIG. 8.

FIG. 12 is a plan view conceptually showing an example of a transmissive type polarization diffraction element.

FIG. 13 is a partial cross-sectional view for describing the polarization diffraction element shown in FIG. 12.

FIG. 14 is a conceptual view for describing the action of the polarization diffraction element shown in FIG. 12.

FIG. 15 is a conceptual view for describing the action of the polarization diffraction element shown in FIG. 12.

FIG. 16 is a conceptual view for describing the action of the polarization diffraction element shown in FIG. 12.

FIG. 17 is a conceptual view for describing another example of a liquid crystal layer included in the polarization diffraction element.

FIG. 18 is a conceptual view of an example of an exposure device which exposes an alignment film of the polarization diffraction element shown in FIG. 12.

FIG. 19 is a conceptual view for describing another example of the polarization diffraction element.

FIG. 20 is a conceptual view for describing the polarization diffraction element shown in FIG. 19.

FIG. 21 is a conceptual view of an example of an exposure device for producing a reflective type volume hologram.

### DESCRIPTION OF THE PREFERRED EMBODIMENTS

Hereinafter, the optical unit and the image display system according to the embodiment of the present invention will be described in detail based on suitable embodiments shown in the accompanying drawings.

Although configuration requirements to be described below are described based on representative embodiments of the present invention, the present invention is not limited to the embodiments.

In addition, the drawings shown below are conceptual views for describing the embodiment of the present invention. Therefore, in each drawing, the shape, size, thickness, positional relationship such as interval, and the like of each member does not necessarily match the actual object.

Any numerical range expressed using “to” in the present specification refers to a range including the numerical values before and after the “to” as a lower limit value and an upper limit value, respectively.

In the present specification, for example, angles such as “45°”, “parallel”, “perpendicular”, and “orthogonal” mean that a difference from an exact angle is within a range of less than 5 degrees, unless otherwise noted. The difference from the exact angle is preferably less than 3 degrees and more preferably less than 1 degree.

In the present specification, the meaning of the term “same”, “equal”, and the like includes a case in which an error range generally allowable in the technical field.

In the present specification, “(meth)acrylate” is used to mean “either or both of acrylate and methacrylate”.

In the present specification, visible light is light having a wavelength which can be seen by human eyes among electromagnetic waves, and refers to light in a wavelength range of 380 to 780 nm. Non-visible light refers to light in a wavelength range of less than 380 nm or more than 780 nm.

In the present specification, Re(λ) represents an in-plane retardation at a wavelength λ.

Unless otherwise specified, the wavelength λ is 550 nm.

In the present specification, Re(λ) is a value measured at the wavelength λ using AxoScan (manufactured by Axometrics, Inc.). By inputting an average refractive index ((nx+ny+nz)/3) and a film thickness (d (μm)) to AxoScan, the following expression can be calculated.

$$Slow axis direction ( ° )$$

$$R e ( λ ) = R 0 ( λ )$$

Although R0(λ) is described as a numerical value calculated by AxoScan, it means Re(λ).

### [Optical Unit and Image Display System]

The optical unit according to the embodiment of the present invention is an optical unit includes a first partial reflection element; and a second partial reflection element, in which any one of the first partial reflection element or the second partial reflection element includes a cholesteric liquid crystal layer, the cholesteric liquid crystal layer has a liquid crystal alignment pattern in which an orientation of an optical axis derived from the liquid crystal compound changes while continuously rotating in at least one in-plane direction, in a case where a length over which the orientation of the optical axis derived from the liquid crystal compound rotates by 180° in a plane is set as a single period, the cholesteric liquid crystal layer has regions having different lengths of the single periods in the plane, and the cholesteric liquid crystal layer has regions having different helical pitches of helical structures in the plane.

In addition, the image display system according to the embodiment of the present invention is an image display system including the optical unit and an image display device.

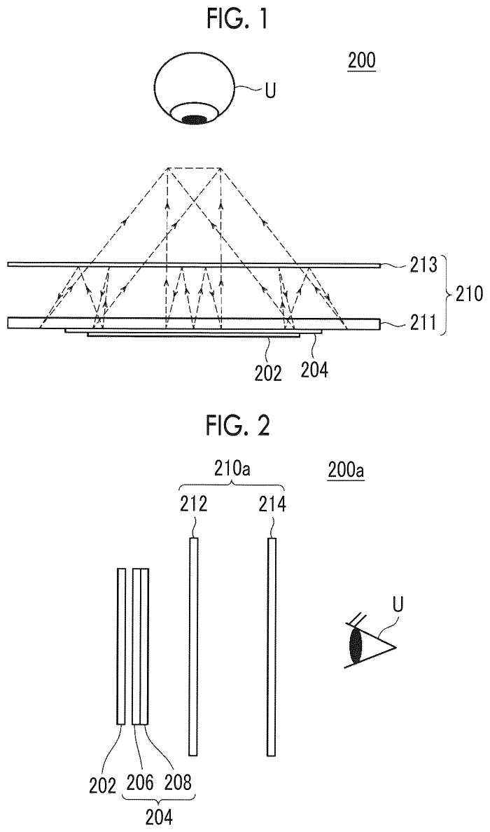

FIG. 1 conceptually shows an example of the image display system including the optical unit according to the embodiment of the present invention.

An image display system (virtual reality display device) 200 shown in FIG. 1 includes an image display element 202, a circularly polarizing plate 204, and an optical unit 210 in this order. The optical unit 210 includes a first partial reflection element 211 and a second partial reflection element 213.

The image display element 202 is a known display. Examples of the image display element 202 include a liquid crystal display element (LCD), an organic electroluminescent display element (organic light emitting diode; OLED), a cathode-ray tube (CRT), a plasma display element, an electronic paper, a light emitting diode (LED) display element, a micro LED display element, a digital light processing (DLP)-type display device, and a micro-electro-mechanical system (MEMS)-type display element. In the present invention, the liquid crystal display element includes liquid crystal on silicon (LCOS). In addition, the image display element may be a transparent display capable of transmitting light.

The image display element may display a monochrome image, a two-color image, or a color image.

In addition, light emitted from the image display element may be unpolarized light, linearly polarized light, or circularly polarized light. In addition, an element which converts a polarization state of light (for example, a linear polarizer or a circularly polarizing plate) may be provided on a display surface (viewing) side of the image display element. In the example shown in FIG. 1, the circularly polarizing plate 204 is provided on the display surface side of the image display element 202. The circularly polarizing plate 204 has a configuration including, for example, a linear polarizer 206 and a λ/4 retardation plate 208 as shown in FIG. 2 described later.

The linear polarizer 206 is not limited. Therefore, the linear polarizer may be a reflective polarizer or an absorptive polarizer; and various known linear polarizers such as an iodine-based polarizer, a dye-based polarizer using a dichroic dye, a polyene-based polarizer, a wire grid polarizer, and a film obtained by stretching a dielectric multi-layer film described in JP2011-053705A can be used.

In addition, the λ/4 retardation plate 208 is not limited. Therefore, as the λ/4 retardation plate, various known λ/4 retardation plates such as a stretched polycarbonate film, a stretched norbornene-based polymer film, a transparent film in which inorganic particles having birefringence, such as strontium carbonate, are contained and aligned, a thin film with an inorganic dielectric obliquely deposited on a support, a film in which a polymerizable liquid crystal compound is uniaxially aligned and the alignment is fixed, and a film in which a liquid crystal compound is uniaxially aligned and the alignment is fixed can be used.

In the image display system 200 shown in FIG. 1, the first partial reflection element 211 and the second partial reflection element 213 are arranged in this order on a surface side of the circularly polarizing plate 204 opposite to the image display element 202. The first partial reflection element 211 and the second partial reflection element 213 are the optical unit 210 according to the embodiment of the present invention. In the optical unit, an optical path length can be obtained in a limited space by reciprocating light between the first partial reflection element 211 and the second partial reflection element 213, which contributes to the reduction in size of the image display unit.

In the present invention, any one of the first partial reflection element 211 or the second partial reflection element 213 includes a cholesteric liquid crystal layer. The cholesteric liquid crystal layer has a liquid crystal alignment pattern in which an orientation of an optical axis derived from the liquid crystal compound changes while continuously rotating in at least one in-plane direction; and in a case where a length over which the orientation of the optical axis derived from the liquid crystal compound rotates by 180° in a plane is set as a single period, the cholesteric liquid crystal layer has, in the plane, regions having different lengths of the single periods in the liquid crystal alignment pattern, and has region having different helical pitches of a helical structure. The partial reflection element including such a cholesteric liquid crystal layer has an action of reflecting one circularly polarized light of incident light and allowing transmission of the other circularly polarized light, and diffracting the reflected light. Therefore, the partial reflection element can act as a concave mirror while maintaining a flat shape, and thus a thickness of the optical unit (image display system) can be further reduced.

The cholesteric liquid crystal layer included in the partial reflection element will be described in detail later. Hereinafter, the partial reflection element including the cholesteric liquid crystal layer will also be referred to as a reflective type liquid crystal diffraction element.

For example, in the example shown in FIG. 1, the first partial reflection element 211 is the reflective type liquid crystal diffraction element, and the second partial reflection element 213 is a partial reflection element which does not have the diffraction action (lens action), such as a general half mirror.

In this case, as shown in FIG. 1, the light emitted from the image display element 202 and transmitted through the circularly polarizing plate 204 is transmitted through the first partial reflection element 211, and reaches the second partial reflection element 213. The second partial reflection element 213 reflects a part of the light to the first partial reflection element 211 side. The first partial reflection element 211 reflects the light reflected by the second partial reflection element 213 to the second partial reflection element 213 side. In this case, the first partial reflection element 211 acts as the concave mirror, and diffracts (deflects) the light at a larger angle toward the end part side such that the reflected light is focused. A part of the light reflected by the first partial reflection element 211 is transmitted through the second partial reflection element 213, and is visually recognized as an image by the user U.

As shown in FIG. 1, since the first partial reflection element 211 acts as the concave mirror, the light is diffracted (deflected) more largely in a region on the end part side than in a central region. However, in such a partial reflection element, as the diffraction angle increases, the diffraction efficiency decreases. Therefore, in the image display system in the related art, there is a problem that brightness of an image displayed by the image display system is high in the center portion and is low toward the end part, and thus in-plane brightness unevenness is large.

On the other hand, in the optical unit according to the embodiment of the present invention, since the cholesteric liquid crystal layer included in one partial reflection element (reflective type liquid crystal diffraction element) has the above-described configuration, the diffraction efficiency at the end part can be increased, and thus the in-plane diffraction efficiency can be made more uniform. Therefore, the image display system including the optical unit according to the embodiment of the present invention can reduce the brightness unevenness of the image to be displayed.

Hereinafter, a plurality of configuration examples of the image display system including the optical unit according to the embodiment of the present invention will be described with reference to FIGS. 2 to 7.

An image display system 200a shown in FIG. 2 includes an image display element 202, a circularly polarizing plate 204, and an optical unit 210a in this order. The optical unit 210a includes a reflective type liquid crystal diffraction element 212 and a half mirror 214 in this order from the image display element 202 side. In the example shown in FIG. 2, the reflective type liquid crystal diffraction element 212 is the first partial reflection element 211, and the half mirror 214 is the second partial reflection element 213. The same parts as those of the image display device shown in FIG. 1 are denoted by the same reference numerals, and different parts will be mainly described below.

In the example shown in FIG. 2, the image display element 202 emits unpolarized light.

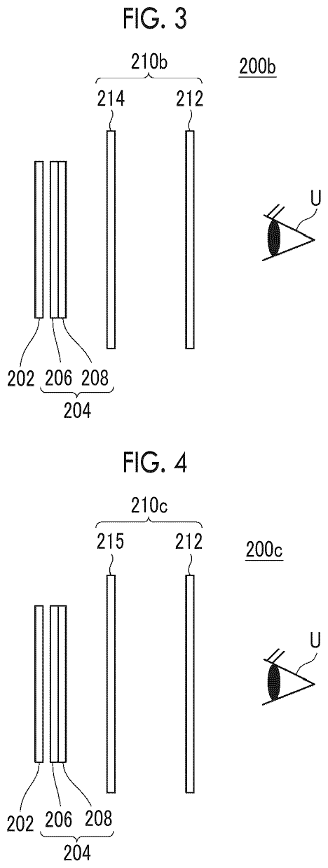

The same applies to examples shown in FIGS. 3 to 7.

The circularly polarizing plate 204 includes a linear polarizer 206 and a λ/4 retardation plate 208, and converts the unpolarized light emitted from the image display element 202 into circularly polarized light. In this case, the circularly polarizing plate 204 converts the unpolarized light into circularly polarized light having a turning direction opposite to that of circularly polarized light reflected from the reflective type liquid crystal diffraction element 212. In the following description, as an example, the circularly polarized light reflected from the reflective type liquid crystal diffraction element 212 is dextrorotatory circularly polarized light, and the circularly polarized light converted from the unpolarized light is to be levorotatory circularly polarized light by the circularly polarizing plate 204. The levorotatory circularly polarized light converted by the circularly polarizing plate 204 is incident into the reflective type liquid crystal diffraction element 212 as the first partial reflection element 211.

The reflective type liquid crystal diffraction element 212 includes the above-described cholesteric liquid crystal layer, and thus reflects dextrorotatory circularly polarized light and allows transmission of levorotatory circularly polarized light. Therefore, the reflective type liquid crystal diffraction element 212 transmits the incident levorotatory circularly polarized light.

In the levorotatory circularly polarized light transmitted through the reflective type liquid crystal diffraction element 212, a part of the light is reflected from the half mirror 214 toward the reflective type liquid crystal diffraction element 212 side, and the rest of the light is transmitted through the half mirror 214. In addition, due to the reflection from the half mirror 214, the circularly polarized light is converted into circularly polarized light having an opposite turning direction. In the present example, the light reflected from the half mirror 214 is converted into dextrorotatory circularly polarized light.

As the half mirror 214, a half mirror known in the related art, which transmits a part of incident light and reflects the rest, can be used. A reflectivity of the half mirror is preferably 50±30%, more preferably 50±10%, and most preferably 50%. The half mirror has a configuration in which, for example, a reflective layer formed of a metal such as silver and aluminum is provided on a substrate formed of a transparent resin such as polyethylene terephthalate (PET), a cycloolefin polymer (COP), and polymethyl methacrylate (PMMA), glass, or the like. The reflective layer formed of a metal such as silver and aluminum is formed on a surface of the substrate by vapor deposition or the like. A thickness of the reflective layer is preferably 1 to 20 nm, more preferably 2 to 10 nm, and still more preferably 3 to 6 nm. In addition, it is preferable that the base material does not have a retardation.

The dextrorotatory circularly polarized light reflected from the half mirror 214 is incident into the reflective type liquid crystal diffraction element 212. Since the polarization state of light is converted by the reflection from the half mirror 214, the light incident into the reflective type liquid crystal diffraction element 212 is reflected from the reflective type liquid crystal diffraction element 212. In this case, since the reflective type liquid crystal diffraction element 212 has the action of the concave mirror, the light is reflected to be focused.

The light reflected from the reflective type liquid crystal diffraction element 212 is incident into the half mirror 214. A part of the light incident into the half mirror 214 is transmitted through the half mirror 214 and emitted to the user U.

In this case, the reflective type liquid crystal diffraction element 212 acts as the concave mirror, and thus can collect reflected light to widen a field of view (FOV) which is a region where an image is displayed. In addition, since the reflective type liquid crystal diffraction element 212 includes the above-described cholesteric liquid crystal layer, a decrease in diffraction efficiency at an end part where the light is diffracted at a large diffraction angle can be suppressed, and thus the brightness unevenness of the image displayed by the image display system can be reduced.

An image display system 200b shown in FIG. 3 includes an image display element 202, a circularly polarizing plate 204, and an optical unit 210b in this order. The optical unit 210b includes a half mirror 214 and a reflective type liquid crystal diffraction element 212 in this order from the image display element 202 side. In the example shown in FIG. 3, the half mirror 214 is the first partial reflection element 211, and the reflective type liquid crystal diffraction element 212 is the second partial reflection element 213. That is, the optical unit 210b shown in FIG. 3 is different from the optical unit 210a shown in FIG. 2 in the arrangement order of the half mirror 214 and the reflective type liquid crystal diffraction element 212.

In the image display system 200b, the circularly polarizing plate 204 converts unpolarized light into circularly polarized light reflected from the reflective type liquid crystal diffraction element 212. In the following description, as an example, the circularly polarized light reflected from the reflective type liquid crystal diffraction element 212 is dextrorotatory circularly polarized light, and the circularly polarizing plate 204 converts the unpolarized light into levorotatory circularly polarized light.

In the image display system 200b, the unpolarized light emitted from the image display element 202 is transmitted through the circularly polarizing plate 204, and is converted into dextrorotatory circularly polarized light. The dextrorotatory circularly polarized light converted by the circularly polarizing plate 204 is incident into the half mirror 214 as the first partial reflection element 211.

A part of the dextrorotatory circularly polarized light incident into the half mirror 214 is transmitted, and the rest is reflected from the half mirror 214 toward the image display element 202 side.

The dextrorotatory circularly polarized light transmitted through the half mirror 214 is incident into the reflective type liquid crystal diffraction element 212. Since the reflective type liquid crystal diffraction element 212 reflects the dextrorotatory circularly polarized light, the dextrorotatory circularly polarized light incident into the reflective type liquid crystal diffraction element 212 is reflected toward the half mirror 214 side by the reflective type liquid crystal diffraction element 212. In this case, since the reflective type liquid crystal diffraction element 212 has the action of the concave mirror, the light is reflected to be focused.

The light reflected from the reflective type liquid crystal diffraction element 212 is incident into the half mirror 214. A part of the light incident into the half mirror 214 is reflected from the half mirror 214 toward the reflective type liquid crystal diffraction element 212 side, and the rest of the light is transmitted through the half mirror 214. In addition, due to the reflection from the half mirror 214, the circularly polarized light is converted into circularly polarized light having an opposite turning direction. In the present example, the light reflected from the half mirror 214 is converted into levorotatory circularly polarized light.

The levorotatory circularly polarized light reflected from the half mirror 214 is incident into the reflective type liquid crystal diffraction element 212. Since the reflective type liquid crystal diffraction element 212 reflects dextrorotatory circularly polarized light and transmits levorotatory circularly polarized light, the incident levorotatory circularly polarized light is transmitted to be emitted to the user U.

In this case, since the light is reflected by the reflective type liquid crystal diffraction element 212 to be focused, the field of view (FOV) as a region where an image is displayed can be widened. In addition, since the reflective type liquid crystal diffraction element 212 includes the above-described cholesteric liquid crystal layer, a decrease in diffraction efficiency at an end part where the light is diffracted at a large diffraction angle can be suppressed, and thus the brightness unevenness of the image displayed by the image display system can be reduced.

An image display system 200c shown in FIG. 4 includes an image display element 202, a circularly polarizing plate 204, and an optical unit 210c in this order. The optical unit 210c includes a reflective volume hologram 215 and a reflective type liquid crystal diffraction element 212 in this order from the image display element 202 side. In the example shown in FIG. 4, the reflective volume hologram 215 is the first partial reflection element 211, and the reflective type liquid crystal diffraction element 212 is the second partial reflection element 213. That is, the optical unit 210c shown in FIG. 4 is obtained by replacing the half mirror 214 of the optical unit 210b shown in FIG. 3 with the reflective volume hologram 215.

The reflective volume hologram 215 reflects a part of incident light and transmits the rest, diffracts light during reflection according to the recorded hologram, and can act as a concave mirror or a convex mirror while maintaining a flat shape.

As the reflective volume hologram 215, a known reflective type volume hologram can be used. The reflective type volume hologram-type diffraction element can be obtained, for example, by performing interference exposure on a hologram photosensitive material based on a profile in which different diffraction angles are exhibited for each in-plane position. The reflective type volume hologram is described in Proc. SPIE 7619, Practical Holography XXIV: Materials and Applications, 76190I, and the like.

In the example shown in FIG. 4, the reflective volume hologram 215 acts as the concave mirror. In addition, the reflective type liquid crystal diffraction element 212 acts as the concave mirror.

In the image display system 200c, the unpolarized light emitted from the image display element 202 is transmitted through the circularly polarizing plate 204, and is converted into dextrorotatory circularly polarized light. The dextrorotatory circularly polarized light converted by the circularly polarizing plate 204 is incident into the reflective volume hologram 215 as the first partial reflection element 211.

A part of the dextrorotatory circularly polarized light incident into the reflective volume hologram 215 is transmitted, and the rest is reflected from the reflective volume hologram 215 toward the image display element 202 side.

The dextrorotatory circularly polarized light transmitted through the reflective volume hologram 215 is incident into the reflective type liquid crystal diffraction element 212. Since the reflective type liquid crystal diffraction element 212 reflects the dextrorotatory circularly polarized light, the dextrorotatory circularly polarized light incident into the reflective type liquid crystal diffraction element 212 is reflected toward the reflective volume hologram 215 side by the reflective type liquid crystal diffraction element 212. In this case, since the reflective type liquid crystal diffraction element 212 has the action of the concave mirror, the light is reflected to be focused.

The light reflected from the reflective type liquid crystal diffraction element 212 is incident into the reflective volume hologram 215. A part of the light incident into the reflective volume hologram 215 is reflected from the reflective volume hologram 215 toward the reflective type liquid crystal diffraction element 212 side, and the rest of the light is transmitted through the reflective volume hologram 215. In addition, due to the reflection from the reflective volume hologram 215, the circularly polarized light is converted into circularly polarized light having an opposite turning direction. In the present example, the light reflected from the reflective volume hologram 215 is converted into levorotatory circularly polarized light. In addition, since the reflective volume hologram 215 has the action of the concave mirror, the light is reflected to be focused.

The levorotatory circularly polarized light reflected from the reflective volume hologram 215 is incident into the reflective type liquid crystal diffraction element 212. Since the reflective type liquid crystal diffraction element 212 reflects dextrorotatory circularly polarized light and transmits levorotatory circularly polarized light, the incident levorotatory circularly polarized light is transmitted to be emitted to the user U.

In this case, since the light is reflected by the reflective type liquid crystal diffraction element 212 to be focused, the field of view (FOV) as a region where an image is displayed can be widened. In addition, since the reflective type liquid crystal diffraction element 212 includes the above-described cholesteric liquid crystal layer, a decrease in diffraction efficiency at an end part where the light is diffracted at a large diffraction angle can be suppressed, and thus the brightness unevenness of the image displayed by the image display system can be reduced.

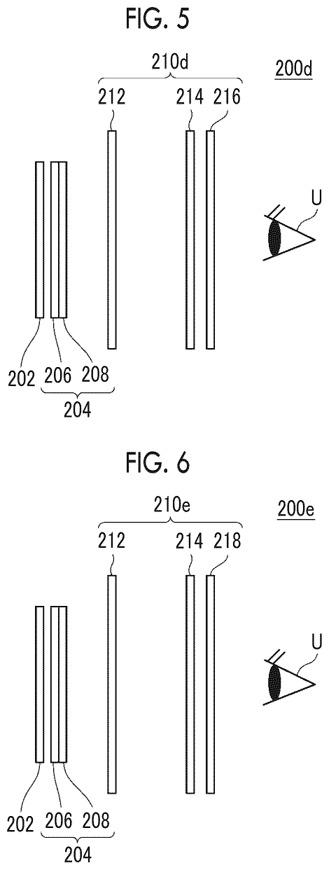

In the example shown in FIG. 4, the first partial reflection element 211 is the reflective volume hologram 215 and the second partial reflection element 213 is the reflective type liquid crystal diffraction element 212, that is, the half mirror 214 in the example shown in FIG. 3 is replaced with the reflection volume hologram 215; but the present invention is not limited thereto. In the example shown in FIG. 2 or examples shown in FIGS. 5 to 7 described later, the configuration in which the half mirror 214 is replaced with the reflective volume hologram 215 may be adopted.

An image display system 200d shown in FIG. 5 includes an image display element 202, a circularly polarizing plate 204, and an optical unit 210d in this order. The optical unit 210d includes a reflective type liquid crystal diffraction element 212, a half mirror 214, and a circularly polarizing plate 216 in this order from the image display element 202 side. In the example shown in FIG. 5, the reflective type liquid crystal diffraction element 212 is the first partial reflection element 211, and the half mirror 214 is the second partial reflection element 213. That is, as a preferred aspect, the optical unit 210d shown in FIG. 5 is obtained by further providing the circularly polarizing plate 216 to the optical unit 210a shown in FIG. 2.

The circularly polarizing plate 216 has a configuration of, for example, including a linear polarizer and a λ/4 retardation plate, similar to the circularly polarizing plate 204. In the image display system 200d, the circularly polarizing plate 216 allows transmission of circularly polarized light reflected from the reflective type liquid crystal diffraction element 212, and shields (reflects or absorbs) circularly polarized light having an opposite turning direction. In the following description, as an example, the circularly polarized light reflected from the reflective type liquid crystal diffraction element 212 is dextrorotatory circularly polarized light, and the circularly polarizing plate 216 transmits dextrorotatory circularly polarized light.

In the image display system 200d, the unpolarized light emitted from the image display element 202 is transmitted through the circularly polarizing plate 204, and is converted into levorotatory circularly polarized light. The levorotatory circularly polarized light converted by the circularly polarizing plate 204 is incident into the reflective type liquid crystal diffraction element 212 as the first partial reflection element 211.

The reflective type liquid crystal diffraction element 212 reflects dextrorotatory circularly polarized light and allows transmission of levorotatory circularly polarized light. Therefore, the reflective type liquid crystal diffraction element 212 transmits the incident levorotatory circularly polarized light.

In the levorotatory circularly polarized light transmitted through the reflective type liquid crystal diffraction element 212, a part of the light is reflected from the half mirror 214 toward the reflective type liquid crystal diffraction element 212 side, and the rest of the light is transmitted through the half mirror 214. In addition, due to the reflection from the half mirror 214, the circularly polarized light is converted into circularly polarized light having an opposite turning direction. In the present example, the light reflected from the half mirror 214 is converted into dextrorotatory circularly polarized light.

The dextrorotatory circularly polarized light reflected from the half mirror 214 is incident into the reflective type liquid crystal diffraction element 212. Since the polarization state of light is converted by the reflection from the half mirror 214, the light incident into the reflective type liquid crystal diffraction element 212 is reflected from the reflective type liquid crystal diffraction element 212. In this case, since the reflective type liquid crystal diffraction element 212 has the action of the concave mirror, the light is reflected to be focused.

The dextrorotatory circularly polarized light reflected from the reflective type liquid crystal diffraction element 212 is incident into the half mirror 214. A part of the dextrorotatory circularly polarized light incident into the half mirror 214 is transmitted through the half mirror 214. The dextrorotatory circularly polarized light transmitted through the half mirror 214 is incident into the circularly polarizing plate 216. The circularly polarizing plate 216 transmits the dextrorotatory circularly polarized light, and the light is emitted to the user U.

In this case, since the light is reflected by the reflective type liquid crystal diffraction element 212 to be focused, the field of view (FOV) as a region where an image is displayed can be widened. In addition, since the reflective type liquid crystal diffraction element 212 includes the above-described cholesteric liquid crystal layer, a decrease in diffraction efficiency at an end part where the light is diffracted at a large diffraction angle can be suppressed, and thus the brightness unevenness of the image displayed by the image display system can be reduced.

Here, in the optical unit 210d shown in FIG. 5, as a preferred aspect, the circularly polarizing plate 216 is provided on a surface side of the second partial reflection element 213, opposite to the first partial reflection element 211, that is, on the viewing side.

In the image display system, a part of the ray emitted from the image display element may reach the viewing side through an unintended optical path other than the optical path in which the ray reciprocates between the first partial reflection element and the second partial reflection element, due to disturbance of polarization, undesirable reflection on the surface of each member, or the like, and thus may become leakage light. Such leakage light leads to occurrence of a double image, a decrease in contrast, and the like. On the other hand, by disposing the circularly polarizing plate 216 on the viewing side, it is possible to shield the leakage light which has passed through the unintended optical path, and it is possible to suppress the occurrence of a double image, a decrease in contrast, and the like.

As shown in FIG. 5, in a case where the first partial reflection element 211 is the reflective type liquid crystal diffraction element 212 and the second partial reflection element 213 is the half mirror 214, the circularly polarizing plate 216 may transmit the circularly polarized light reflected by the reflective type liquid crystal diffraction element 212 and shield circularly polarized light having an opposite turning direction. In addition, in a case where the first partial reflection element 211 is the half mirror 214 and the second partial reflection element 213 is the reflective type liquid crystal diffraction element 212, the circularly polarizing plate 216 may shield the circularly polarized light reflected by the reflective type liquid crystal diffraction element 212 and transmit circularly polarized light having an opposite turning direction.

An image display system 200e shown in FIG. 6 includes an image display element 202, a circularly polarizing plate 204, and an optical unit 210e in this order. The optical unit 210e includes a reflective type liquid crystal diffraction element 212, a half mirror 214, and a first transmissive type polarization diffraction element 218 in this order from the image display element 202 side. In the example shown in FIG. 6, the reflective type liquid crystal diffraction element 212 is the first partial reflection element 211, and the half mirror 214 is the second partial reflection element 213. That is, as a preferred aspect, the optical unit 210e shown in FIG. 6 is an optical unit in which the first transmissive type polarization diffraction element 218 is further provided in the optical unit 210a shown in FIG. 2.

The first transmissive type polarization diffraction element 218 transmits and refracts a part of the light transmitted through the second partial reflection element 213. In the first transmissive type polarization diffraction element 218, the light is diffracted (deflected) more in the end part side region than in the central region, and the first transmissive type polarization diffraction element 218 acts as a condenser lens or a diverging lens while maintaining a flat shape.

In addition, as a preferred aspect, the first transmissive type polarization diffraction element 218 includes a liquid crystal layer formed of a liquid crystal composition containing a liquid crystal compound, the liquid crystal layer has a liquid crystal alignment pattern in which an orientation of an optical axis derived from the liquid crystal compound changes while continuously rotating in at least one in-plane direction, in a case where a length over which the orientation of the optical axis derived from the liquid crystal compound rotates by 180° in a plane is set as a single period, the liquid crystal layer has, in the plane, regions having different lengths of the single periods in the liquid crystal alignment pattern, and in the plane, the liquid crystal layer has regions in which the optical axis derived from the liquid crystal compound is twisted and rotates in a thickness direction of the liquid crystal layer, and has regions having different total magnitudes of twisted angles in the thickness direction.

The first transmissive type polarization diffraction element 218 will be described in detail later.

In the image display system 200e, the action of the image display element 202 in the path reciprocating between the reflective type liquid crystal diffraction element 212 and the half mirror 214 is the same as that of the image display system 200d shown in FIG. 5, and thus the description thereof will not be repeated.

In the image display system 200e, the dextrorotatory circularly polarized light reflected from the reflective type liquid crystal diffraction element 212 and transmitted through the half mirror 214 is incident into the first transmissive type polarization diffraction element 218.

For example, the first transmissive type polarization diffraction element 218 acts as a condenser lens for dextrorotatory circularly polarized light and focuses the incident dextrorotatory circularly polarized light. As a result, the field of view (FOV), which is a region where the image is displayed, can be further widened.

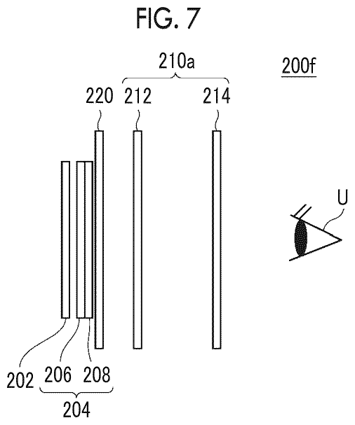

An image display system 200f shown in FIG. 7 includes an image display element 202, a circularly polarizing plate 204, an optical element 220, and an optical unit 210a in this order. The optical unit 210a has the same configuration as the optical unit 210a of the image display system 200a shown in FIG. 2. That is, as a preferred aspect, the image display system 200f shown in FIG. 7 includes the optical element 220 between the image display element 202 and the optical unit 210a in the image display system 200a shown in FIG. 2.

The optical element 220 has a function of refracting the light emitted from the image display element 202, and has regions where refraction angles are different at different positions in a plane of the optical element 220. In the optical element 220, the light is diffracted (refracted) more in the end part side region than in the central region, and the optical element 220 acts as a condenser lens or a diverging lens while maintaining a flat shape.

In addition, as a preferred aspect, the optical element 220 includes a liquid crystal layer formed of a liquid crystal composition containing a liquid crystal compound, the liquid crystal layer has a liquid crystal alignment pattern in which an orientation of an optical axis derived from the liquid crystal compound changes while continuously rotating in at least one in-plane direction, and in a case where a length over which the orientation of the optical axis derived from the liquid crystal compound rotates by 180° in a plane is set as a single period, the liquid crystal layer has, in the plane, regions having different lengths of the single periods in the liquid crystal alignment pattern.

The optical element 220 including such a liquid crystal layer is a transmissive type polarization diffraction element. Hereinafter, the optical element 220 is also referred to as a second transmissive type polarization diffraction element.

The second polarization diffraction element will be described in detail later.

In the image display system, in order to widen the field of view (FOV), it is necessary to bend the optical path passing through an end part side of the optical unit more greatly. Therefore, there is a concern that the brightness decreases toward the end part side of the displayed image. On the other hand, by disposing, between the image display element 202 and the optical unit 210a, the optical element 220 having regions where the refraction angles are different at different in-plane positions to impart directivity to the light emitted from the image display element 202 according to the in-plane position, the brightness on the end part side of the image to be displayed can be improved, and thus the brightness distribution can be made uniform.

A configuration in which the brightness distribution of emitted light from the image display element is adjusted using the transmissive type liquid crystal diffraction element is described in, for example, Crystals 2021, 11, 107.

In addition, in the example shown in FIG. 7, the optical element 220 is provided between the image display element 202 and the optical unit 210a, but the present invention is not limited thereto. The image display system according to the embodiment of the present invention may include the image display element and the optical unit, in which the image display element includes a light source and an optical element which has a function of refracting light emitted from the light source, and the optical element has regions where refraction angles are different at different in-plane positions. The above-described second transmissive type polarization diffraction element can also be used as the optical element in this case.

In the present invention, the configurations of the optical unit and the image display system are not limited to the examples shown in FIGS. 2 to 7, and the respective configurations may be appropriately combined. For example, the optical unit may have a configuration in which the first transmissive type polarization diffraction element 218 and the circularly polarizing plate 216 are provided on the visible side with respect to the second partial reflection element 213, in addition to the first and second partial reflection elements. Alternatively, the image display system may have a configuration in which the optical element (second transmissive type polarization diffraction element) 220 is provided between the optical unit 210d including the first and second partial reflection elements and the circularly polarizing plate 216, and the image display element 202. Alternatively, the image display system may have a configuration in which the optical element (second transmissive type polarization diffraction element) 220 is provided between the optical unit 210e including the first and second partial reflection elements and the first transmissive type polarization diffraction element 218, and the image display element 202. Alternatively, the image display system may have a configuration in which the optical element (second transmissive type polarization diffraction element) 220 is provided between the optical unit including the first and second partial reflection elements, the first transmissive type polarization diffraction element 218, and the circularly polarizing plate 216, and the image display element 202.

In each of the above-described examples, one partial reflection element is used as the reflective type liquid crystal diffraction element which acts as the concave mirror, and the other partial reflection element is used as the half mirror which does not have a general lens action; but, the present invention is not limited thereto, and the other partial reflection element may act as a concave mirror or may act as a convex mirror. In addition, in a case where the other partial reflection element consisting of the half mirror, the reflective volume hologram, or the like acts as the concave mirror, the partial reflection element consisting of the reflective type liquid crystal diffraction element may act as the convex mirror.

### [Reflective Type Liquid Crystal Diffraction Element]

Hereinafter, the partial reflection element (reflective type liquid crystal diffraction element) including a cholesteric liquid crystal layer will be described.

As described above, the reflective type liquid crystal diffraction element includes a cholesteric liquid crystal layer, in which the cholesteric liquid crystal layer has a liquid crystal alignment pattern in which an orientation of an optical axis derived from the liquid crystal compound changes while continuously rotating in at least one in-plane direction; and in a case where a length over which the orientation of the optical axis derived from the liquid crystal compound rotates by 180° in a plane is set as a single period, the cholesteric liquid crystal layer has, in the plane, regions having different lengths of the single periods in the liquid crystal alignment pattern, and has region having different helical pitches of a helical structure.

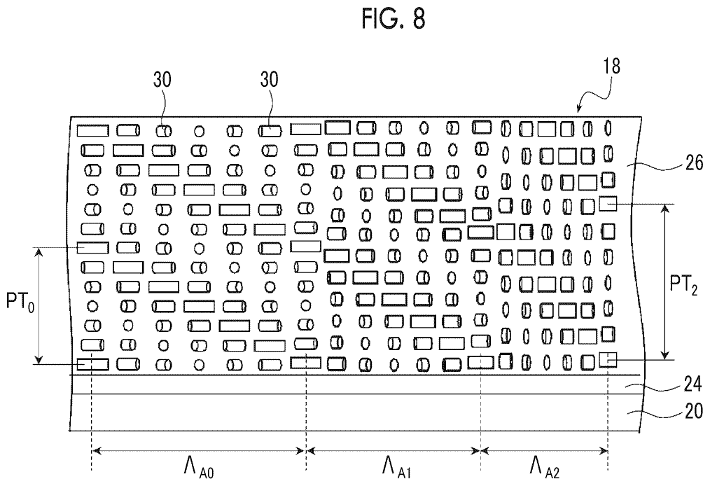

FIG. 8 conceptually shows an example of the reflective type liquid crystal diffraction element.

A reflective type liquid crystal diffraction element 18 shown in FIG. 8 includes a support 20, an alignment film 24, and a cholesteric liquid crystal layer 26.

The cholesteric liquid crystal layer 26 of the reflective type liquid crystal diffraction element 18 in the example shown in the drawing selectively reflects light having a specific wavelength, and reflects light in a direction different from specular reflection (mirror reflection). Hereinafter, the reflection of light in a direction different from specular reflection is also referred to as diffraction (deflection) of the reflected light.

In addition, the reflective type liquid crystal diffraction element 18 in the example shown in the drawing includes the support 20 and the alignment film 24, but the reflective type liquid crystal diffraction element may not include the support 20 and the alignment film 24. From the above-described configuration, The reflective type liquid crystal diffraction element may be configured to include only the alignment film 24 and the cholesteric liquid crystal layer 26 by peeling off the support 20, or may be configured to include only the cholesteric liquid crystal layer 26 by peeling off the support 20 and the alignment film 24.

That is, the reflective type liquid crystal diffraction element can have various layer configurations as long as the cholesteric liquid crystal layer has the liquid crystal alignment pattern in which the orientation of the optical axis derived from the liquid crystal compound changes while continuously rotating in at least one in-plane direction, and has regions having different pitches of helical structures in the cholesteric liquid crystal layer in a plane, and in a case where a length over which the orientation of the optical axis derived from the liquid crystal compound rotates by 180° in a plane is set as a single period, the cholesteric liquid crystal layer has regions having different lengths of the single periods.

Regarding the above points, the same applies to the reflective type liquid crystal diffraction elements according to the respective aspects of the present invention described below.

### <Cholesteric Liquid Crystal Layer>

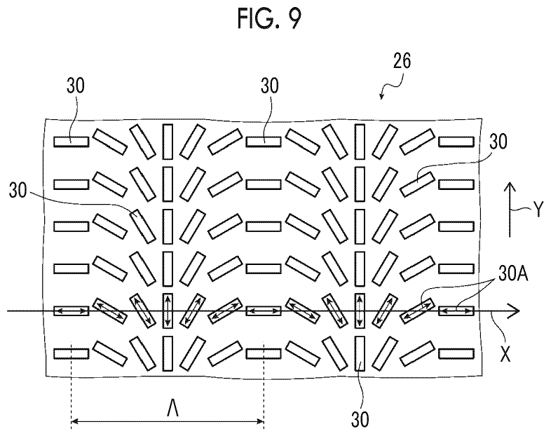

FIG. 9 is a plan view showing the cholesteric liquid crystal layer shown in FIG. 8.

The plan view is a view in a case where the reflective type liquid crystal diffraction element 18 is seen from the top in FIG. 8, that is, a view in a case where the reflective type liquid crystal diffraction element 18 is seen from the thickness direction (laminating direction of the respective layers (films)). In order to simplify the drawing to clarify the configuration of the reflective type liquid crystal diffraction element 18 in FIG. 9, only the liquid crystal compound 30 (liquid crystal compound molecule) on the surface of the alignment film in the cholesteric liquid crystal layer 26 is conceptually shown. However, as conceptually shown in FIG. 8, the cholesteric liquid crystal layer 26 has a helical structure in which the liquid crystal compounds 30 are helically turned and stacked as in a cholesteric liquid crystal layer obtained by immobilizing a typical cholesteric liquid crystalline phase. In the helical structure, a configuration in which the liquid crystal compounds 30 helically rotate once (rotates by 360) and are stacked is set as one helical pitch, and plural pitches of the helically turned liquid crystal compounds 30 are laminated.

In addition, the cholesteric liquid crystal layer 26 will be described as a representative example in FIG. 9, but a cholesteric liquid crystal layer described later also basically has the same configuration and the same effects as the cholesteric liquid crystal layer described below, except that the length Λ of the single period of the liquid crystal alignment pattern and the reflection wavelength range are different.

As is well known, the cholesteric liquid crystal layer has wavelength-selective reflectivity. For example, in a case where the cholesteric liquid crystal layer 26 is a cholesteric liquid crystal layer having a selective reflection center wavelength in a green wavelength range, the cholesteric liquid crystal layer 26 reflects dextrorotatory circularly polarized light of green light and allows transmission of the other light.

Here, since the liquid crystal compound 30 rotates to be aligned in the plane direction, the cholesteric liquid crystal layer 26 diffracts (refracts) incident circularly polarized light to be reflected in a direction in which the orientation of the optical axis continuously rotates. At this time, the diffraction direction varies depending on a turning direction of the incident circularly polarized light. That is, the cholesteric liquid crystal layer 26 reflects dextrorotatory circularly polarized light or levorotatory circularly polarized light, having a selective reflection wavelength, and diffracts the reflected light.

The optical axis 30A derived from the liquid crystal compound 30 is an axis having the highest refractive index in the liquid crystal compound 30, that is, a so-called slow axis. For example, in a case where the liquid crystal compound 30 is a rod-like liquid crystal compound, the optical axis 30A is along a major axis direction of the rod shape. In addition, in a case where the liquid crystal compound 30 is a disk-like liquid crystal compound, the optical axis 30A is along a direction perpendicular to a disc plane. In the following description, the optical axis 30A derived from the liquid crystal compound 30 will also be referred to as “optical axis 30A of the liquid crystal compound 30” or “optical axis 30A”.

As shown in FIG. 9, on the surface of the alignment film 24, the liquid crystal compound 30 forming the cholesteric liquid crystal layer 26 is two-dimensionally arranged according to the alignment pattern formed on the alignment film 24 as a lower layer, in a predetermined one direction indicated by an arrow X and a direction orthogonal to the one direction (arrow X direction).

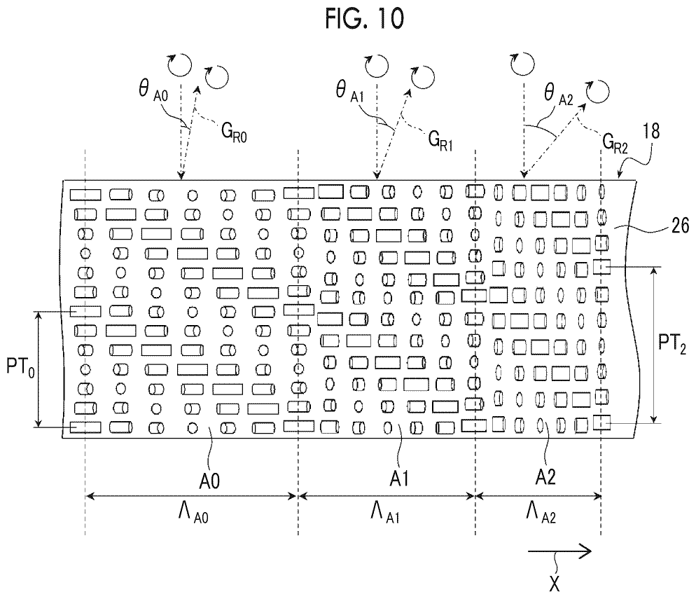

In the following description, a direction orthogonal to the arrow X direction will be referred to as a Y direction, for convenience of description. That is, in FIG. 8 and FIG. 10 described later, the Y direction is a direction orthogonal to the paper plane.

In addition, the liquid crystal compound 30 forming the cholesteric liquid crystal layer 26 has the liquid crystal alignment pattern in which the orientation of the optical axis 30A changes while continuously rotating in the arrow X direction in a plane of the cholesteric liquid crystal layer 26. In the example shown in the drawing, the liquid crystal compound 30 has the liquid crystal alignment pattern in which the optical axis 30A of the liquid crystal compound 30 changes while continuously rotating clockwise in the arrow X direction.

Specifically, the “orientation of the optical axis 30A of the liquid crystal compound 30 changes while continuously rotating in the arrow X direction (predetermined one direction)” means that an angle between the optical axis 30A of the liquid crystal compound 30, which is arranged in the arrow X direction, and the arrow X direction varies depending on positions in the arrow X direction, and the angle between the optical axis 30A and the arrow X direction sequentially changes from θ to θ+180° or to θ−180° in the arrow X direction. Hereinafter, the predetermined one direction (arrow X direction) in which the liquid crystal compounds are arranged such that the orientation of the optical axis 30A change while continuously rotating is also referred to as an arrangement axis (direction).

A difference between the angles of the optical axes 30A of the liquid crystal compounds 30 adjacent to each other in the arrow X direction is preferably 45° or less, more preferably 15° or less, and still more preferably less than 15°.

On the other hand, in the liquid crystal compound 30 forming the cholesteric liquid crystal layer 26, orientations of the optical axes 30A are the same in the Y direction orthogonal to the arrow X direction, that is, the Y direction orthogonal to the one direction in which the optical axis 30A continuously rotates. In other words, in the liquid crystal compound 30 forming the cholesteric liquid crystal layer 26, angles between the optical axes 30A of the liquid crystal compound 30 and the arrow X direction are the same in the Y direction.

In such a liquid crystal alignment pattern of the liquid crystal compound 30, the length (distance) over which the optical axis 30A of the liquid crystal compound 30 rotates by 180° in the arrow X direction that the optical axis 30A continuously change while continuously rotating in a plane is defined by a length Λ of a single period in the liquid crystal alignment pattern. That is, in the arrow X direction, a distance between centers of two liquid crystal compounds 30 having the same angle with respect to the arrow X direction is set as the length Λ of the single period. Specifically, as shown in FIG. 9, the distance between the centers of two liquid crystal compounds 30 in which the arrow X direction and the direction of the optical axis 30A coincide with each other in the arrow X direction is set as the length Λ of the single period. In the description below, the length Λ of the single period is also referred to as “single period Λ”.

In the liquid crystal alignment pattern of the cholesteric liquid crystal layer in the reflective type liquid crystal diffraction element 18, the single period Λ is repeated in the arrow X direction, that is, in the one direction in which the orientation of the optical axis 30A changes while continuously rotating.

The cholesteric liquid crystal layer 26 has the liquid crystal alignment pattern in which the optical axis 30A changes while continuously rotating in the arrow X direction (predetermined one direction) in a plane. The cholesteric liquid crystal layer 26 having such a liquid crystal alignment pattern reflects incident light in a direction having an angle in the arrow X direction with respect to the specular reflection. For example, the cholesteric liquid crystal layer 26 does not reflect, in the normal direction, the light which has been incident from the normal direction, but reflects the light by inclining the light to the arrow X direction with respect to the normal direction. The light incident from the normal direction refers to light incident from the front side, that is, light incident to be perpendicular to the main surface. The main surface refers to the maximum surface of the sheet-shaped material.

A reflection angle of the light from the cholesteric liquid crystal layer having the liquid crystal alignment pattern varies depending on the length Λ of the single period of the liquid crystal alignment pattern in which the optical axis 30A rotates by 180° in the arrow X direction, that is, the single period Λ. Specifically, as the single period Λ decreases, the angle of reflected light with respect to the incidence light increases.

Here, in the present invention, as conceptually shown in FIG. 8, the cholesteric liquid crystal layer in the reflective type liquid crystal diffraction element has regions where the lengths Λ of the single periods of the liquid crystal alignment pattern in the cholesteric liquid crystal layer are different in a plane. Furthermore, as conceptually shown in FIG. 8, the cholesteric liquid crystal layer in the reflective type liquid crystal diffraction element has regions where pitches of helical structures in the cholesteric liquid crystal layer are different in a plane.

Specifically, the cholesteric liquid crystal layer 26 in FIG. 8 is configured such that a helical pitch PT₂ in the right side region of FIG. 8 is longer than a helical pitch PT₀ in the left side region of FIG. 8, and a helical pitch PT₁ (not shown) in the intermediate region in the left-right direction in FIG. 8 is longer than the helical pitch PT₀ and is shorter than the helical pitch PT₂. That is, the helical pitch increases from the left side region toward the right side region in FIG. 8. The helical pitch is the distance over which the liquid crystal compound rotates helically once (360° rotation), but in FIG. 8, schematically, distances over which the liquid crystal compound rotates half a rotation (180° rotation) are represented by PT₀ and PT₂.

In addition, in the cholesteric liquid crystal layer 26 in FIG. 8, a length Λ_{A2} of the single period in the right side region of FIG. 8 is shorter than a length Λ_{A0} of the single period in the left side region of FIG. 8, and a length Λ_{A1} of the single period in the intermediate region in the left-right direction in FIG. 8 is shorter than the length Λ_{A0} of the single period and is longer than the length Λ_{A2} of the single period. That is, the length Λ of the single period decreases from the left side region toward the right side region in FIG. 8.

Hereinafter, the action of the cholesteric liquid crystal layer will be described in more detail with reference to FIG. 10.

In FIG. 10, in order to clearly show the action of the reflective type liquid crystal diffraction element 18, only the cholesteric liquid crystal layer 26 is shown. In addition, for the same reason, it is assumed that light is incident into the reflective type liquid crystal diffraction element 18 from the normal direction (front side). In addition, for the sake of description, the cholesteric liquid crystal layer 26 selectively reflects dextrorotatory circularly polarized light G_{R} of green light and transmits the other light.

In addition, in the portion shown in FIG. 10, the cholesteric liquid crystal layer 26 includes three regions A0, A1, A2 in order from the left side in FIG. 10, and the respective regions have different lengths of the helical pitches and different lengths Λ of the single periods. Specifically, the helical pitch increases in order of the regions A0, A1, and A2, and the length Λ of the single period decreases in order of the regions A0, A1, and A2. However, FIG. 10 shows a part of the cholesteric liquid crystal layer 26, and the cholesteric liquid crystal layer 26 may have four or more regions where the lengths of the helical pitches and the lengths Λ of the single periods are different from each other.

In the reflective type liquid crystal diffraction element 18, in a case where dextrorotatory circularly polarized light G_{R1} of green light is incident into an in-plane region A1 of the cholesteric liquid crystal layer 26, as described above, the light is reflected in a direction which is tilted by a predetermined angle in the arrow X direction, that is, in the one direction in which the orientation of the optical axis of the liquid crystal compound changes while continuously rotating with respect to the incident direction. In the same manner, in a case where dextrorotatory circularly polarized light G_{R2} of green light is incident into an in-plane region A2 of the cholesteric liquid crystal layer 26, the light is reflected in a direction which is tilted by a predetermined angle in the arrow X direction with respect to the incident direction. In the same manner, in a case where dextrorotatory circularly polarized light G_{R2} of green light is incident into an in-plane region A0 of the cholesteric liquid crystal layer 26, the light is reflected in a direction which is tilted by a predetermined angle in the arrow X direction with respect to the incident direction.

Regarding the refraction angles (diffraction angles) by the cholesteric liquid crystal layer 26, since a single period Λ_{A2} of the liquid crystal alignment pattern in the region A2 is shorter than a single period Λ_{A1} of the liquid crystal alignment pattern in the region A1, as shown in FIG. 10, a refraction angle θ_{A2} of reflected light in the region A2 with respect to the incidence light is more than a refraction angle θ_{A1} of reflected light in the region A1 with respect to the incidence light. In addition, since a single period Λ_{A0} of the liquid crystal alignment pattern in the region A0 is longer than the single period Λ_{A1} of the liquid crystal alignment pattern in the region A1, as shown in FIG. 10, a reflection angle θ_{A0} of reflected light in the region A0 with respect to the incidence light is less than the reflection angle θ_{A1} of reflected light in the region A1 with respect to the incidence light.

Here, in the reflection of light from the cholesteric liquid crystal layer, a so-called blue shift (short-wavelength shift) in which a wavelength of light to be selectively reflected shifts to a short wavelength side occurs depending on the angle of the incidence light. Therefore, in the cholesteric liquid crystal layer having the liquid crystal alignment pattern in which the orientation of the optical axis of the liquid crystal compound changes while continuously rotating in at least one in-plane direction, there is a problem in that the amount of reflected light decreases due to the influence of the blue shift (short-wavelength shift) as the reflection angle increases. Therefore, in a case where the cholesteric liquid crystal layer has regions having different lengths of the single periods, over which the orientation of the optical axis of the liquid crystal compound rotates by 180° in a plane, the reflection angle varies depending on an incidence position of light, so that the amount of reflected light varies depending on the incidence position in the plane. That is, a region where the reflected light is dark is provided depending on the incidence position in the plane.

On the other hand, the reflective type liquid crystal diffraction element has the cholesteric liquid crystal layer having regions where helical pitches are different in a plane. In the cholesteric liquid crystal layer 26 of the example shown in FIG. 10, a length PL_{A2} of the pitch of the helical structure in the region A2 is more than a length PL_{A1} of the pitch of the helical structure in the region A1, and a length PL_{A0} of the pitch of the helical structure in the region A0 is more than the length PL_{A1} of the pitch of the helical structure in the region A1.

As a result, the influence of the blue shift in which the wavelength of light to be selectively reflected shifts to a short wavelength side can be reduced, and thus a decrease in the amount of reflected light in the region where the reflection angle of reflected light is large can be suppressed. Specifically, by increasing the length of the pitch of the helical structure such that the selective reflection wavelength by the blue shift is the same as the wavelength of incident light, the reflection efficiency at the wavelength of incident light can be increased. Accordingly, generation of a region where the brightness of reflected light is low depending on the incidence position in the plane can be suppressed.

In the example shown in FIG. 10, a reflection angle θA₁ of the reflected light in the region A1 is larger than a reflection angle θ_{A0} of the reflected light in the region A0. That is, the length Λ_{A1} of the single period in the region A1 is shorter than the length Λ_{A0} of the single period in the region A0. Therefore, the helical pitch PL_{A1} in the region A1 is to be longer than the helical pitch PL_{A0} in the region A0. In addition, the helical pitch PL_{A2} in the region A2 where the reflection angle θ_{A2} of reflected light is the largest, that is, the length Λ_{A2} of the single period is the shortest is to be longer than the helical pitch in the region A0 and the helical pitch in the region A1. As a result, the decrease in the amount of light reflected from the regions A1 and A2 can be suppressed, and the amount of reflected light can be made uniform regardless of the incidence position in the plane.

As described above, in the reflective type liquid crystal diffraction element 18, in the in-plane region where the reflection angle from the cholesteric liquid crystal layer is large, the incidence light is reflected from the region where the pitch of the helical structure is long. On the other hand, in the in-plane region where the reflection angle from the cholesteric liquid crystal layer is small, the incidence light is reflected from the region where the pitch of the helical structure is short. That is, in the reflective type liquid crystal diffraction element 18, by setting the length of the pitch of the helical structure in the plane according to the magnitude of the reflection angle of the cholesteric liquid crystal layer, the brightness of reflected light can be increased with respect to the brightness of the incidence light. Therefore, with the reflective type liquid crystal diffraction element 18, the reflection angle dependence of the amount of light reflected in the plane can be reduced.

In the reflective type liquid crystal diffraction element, as described above, as the single period Λ of the liquid crystal alignment pattern decreases, the reflection angle increases. Therefore, by setting the length PL of the pitch of the helical structure to be long in the region where the length of the single period Λ of the liquid crystal alignment pattern is short, the brightness of reflected light can be increased. Therefore, in the reflective type liquid crystal diffraction element, in regions having different lengths of the single periods of the liquid crystal alignment pattern, it is preferable that a permutation of the lengths of the single periods and a permutation of the magnitudes of the lengths of the pitches of the helical structure are different from each other.

However, the present invention is not limited thereto, and in the reflective type liquid crystal diffraction element, the cholestatic liquid crystal layer may have regions in which the permutation of the lengths of the single periods and the permutation of the lengths of the pitches of the helical structure match each other in the regions where the lengths of the single periods of the liquid crystal alignment pattern are different from each other. In the reflective type liquid crystal diffraction element, the length of the pitch of the helical structure has a preferred range and may be appropriately set according to the single period Λ of the liquid crystal alignment pattern in the plane.

In the cholesteric liquid crystal layer of the present invention, having the liquid crystal alignment pattern in which the orientation of the optical axis derived from the liquid crystal compound changes while continuously rotating in at least one in-plane direction, by adjusting the pitch of the helical structure in the cholesteric liquid crystalline phase, a slope pitch of inclined surfaces of bright portions and dark portions with respect to a main surface in a case where a cross section of the cholesteric liquid crystal layer is observed with a scanning electron microscope (SEM) (interval between the bright portions or between the dark portions in the normal direction with respect to the slope is set as ½ surface pitch) can be adjusted, and the selective reflection center wavelength with respect to oblique light can be adjusted.

In the reflective type liquid crystal diffraction element, it is preferable that the cholesteric liquid crystal layer has a radial pattern in which the one direction in which the optical axis 30A of the liquid crystal compound 30 changes while continuously rotating in the liquid crystal alignment pattern is provided in a radial shape from the inside toward the outer side.

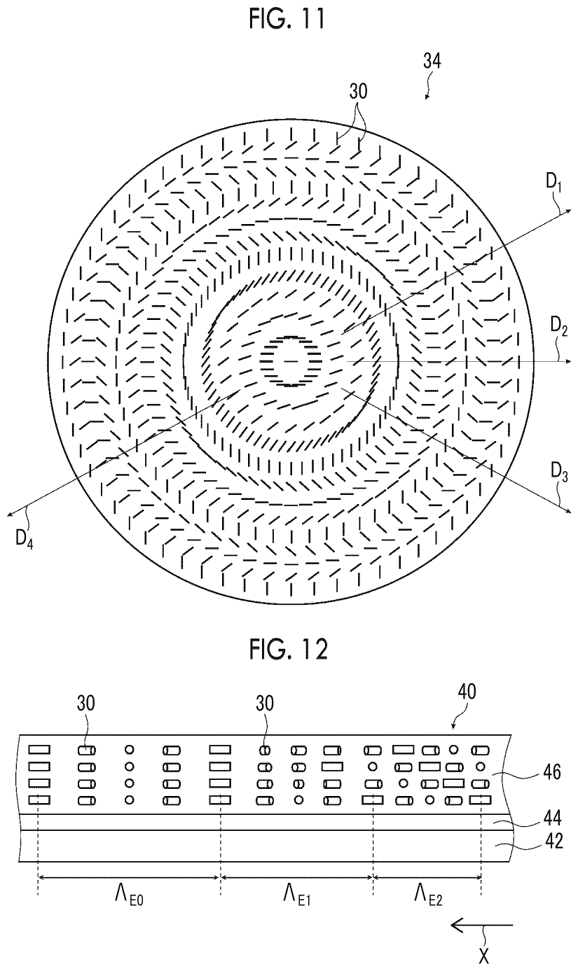

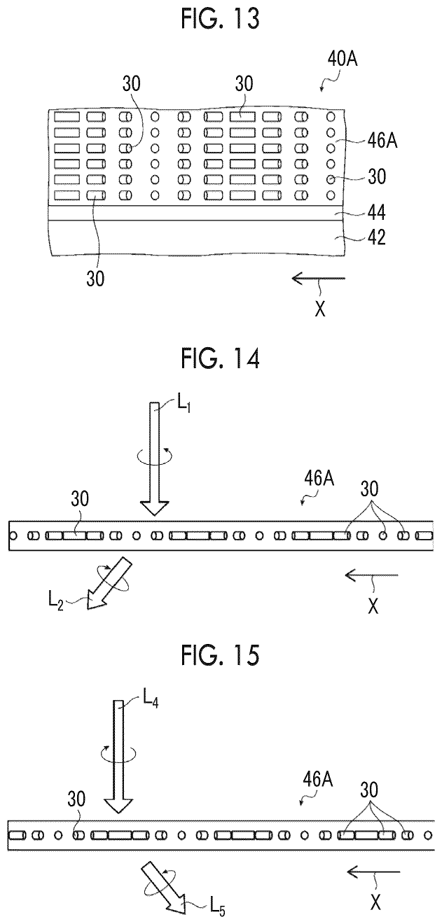

FIG. 11 shows a plan view of the cholesteric liquid crystal layer having the radial liquid crystal alignment pattern. FIG. 11 shows only the liquid crystal compound 30 on the surface of the alignment film as in FIG. 9, but as in the example shown in FIG. 8, a cholesteric liquid crystal layer 34 has the helical structure in which the liquid crystal compounds 30 on the surface of the alignment film are helically turned and stacked as described above.

In the cholesteric liquid crystal layer 34 shown in FIG. 11, the optical axis (not shown) of the liquid crystal compound 30 is a longitudinal direction of the liquid crystal compound 30. In the cholesteric liquid crystal layer 34, the orientation of the optical axis of the liquid crystal compound 30 changes while continuously rotating along a plurality of directions from the center of the cholesteric liquid crystal layer 34 toward the outer side, for example, along a direction indicated by an arrow D₁, a direction indicated by an arrow D₂, a direction indicated by an arrow D₃, and the like. That is, the cholesteric liquid crystal layer 34 has a radial shape in the arrow D direction from the inside toward the outer side.

In addition, in the example shown in FIG. 11, as a preferred aspect, the direction of the optical axis changes in the same direction in a radial shape from the center of the cholesteric liquid crystal layer 34. In the aspect shown in FIG. 11, counterclockwise alignment is shown. In each arrow direction of arrows D₁, D₂, D₃, D₄, and the like in FIG. 11, the rotation direction of the optical axis is counterclockwise from the center toward the outer side.

In such a cholesteric liquid crystal layer, a line connecting the liquid crystal compounds of which the optical axes are directed in the same direction is circular, and concentric circular line segments are arranged in a concentric circular pattern.

The cholesteric liquid crystal layer 34 having the radial liquid crystal alignment pattern can reflect incidence light as diverging light or converging light, depending on the rotation direction of the optical axis of the liquid crystal compound 30 and the direction of circularly polarized light to be reflected.

That is, by setting the liquid crystal alignment pattern of the cholesteric liquid crystal layer in a radial shape, the reflective type liquid crystal diffraction element exhibits, for example, a function as a concave mirror or a convex mirror.

Here, in a case where the liquid crystal alignment pattern of the cholesteric liquid crystal layer is concentric circular such that the reflective type liquid crystal diffraction element acts as a concave mirror, it is preferable that the length of the single period Λ over which the optical axis rotates by 180° in the liquid crystal alignment pattern gradually decreases from the center of the cholesteric liquid crystal layer 34 toward the outer direction in the one direction in which the optical axis continuously rotates.

As described above, the reflection angle of light with respect to the incidence direction increases as the length of the single period Λ in the liquid crystal alignment pattern decreases. Accordingly, the single period Λ in the liquid crystal alignment pattern gradually decreases from the center of the cholesteric liquid crystal layer 34 toward the outer direction in the one direction in which the optical axis continuously rotates, and as a result, light can be further focused and the performance as a concave mirror can be improved.

Here, as described above, in the cholesteric liquid crystal layer, in a region where the length Λ of the single period in the liquid crystal alignment pattern is short and the reflection angle is large, the amount of reflected light is small. That is, in the example shown in FIG. 11, in an outer region where the reflection angle is large, the amount of reflected light is small.

On the other hand, the reflective type liquid crystal diffraction element has regions where pitches of helical structures of the cholesteric liquid crystal layer are different. In the example shown in FIG. 11, by gradually increasing the pitch of the helical structure in the outer direction in the one direction in which the optical axis continuously rotates from the center, the decrease in the amount of reflected light from the outer region of the cholesteric liquid crystal layer 34 can be suppressed.

In the present invention, in a case where the reflective type liquid crystal diffraction element acts as a convex mirror, it is preferable that the continuous rotation direction of the optical axis in the liquid crystal alignment pattern is a direction opposite to that of the case of the above-described concave mirror from the center of the cholesteric liquid crystal layer 34.

In addition, by gradually decreasing the length of the single period Λ over which the optical axis rotates by 180° from the center of the cholesteric liquid crystal layer 34 toward the outer direction in the one direction in which the optical axis continuously rotates, light incident into the cholesteric liquid crystal layer can be further dispersed, and the performance as a convex mirror can be improved.

Furthermore, in the cholesteric liquid crystal layer 34, by gradually increasing the pitch of the helical structure from the center toward the outer direction in the one direction in which the optical axis continuously rotates, the decrease in the amount of reflected light in the outer region of the cholesteric liquid crystal layer 34 can be suppressed.

In the present invention, in a case where the reflective type liquid crystal diffraction element acts as a convex mirror, it is preferable that a direction of circularly polarized light to be reflected (sense of a helical structure) from the cholesteric liquid crystal layer is reversed to be opposite to that in the case of the concave mirror, that is, the helical turning direction of the cholesteric liquid crystal layer is reversed.

Even in this case, by gradually decreasing the length of the single period Λ over which the optical axis rotates by 180° from the center of the cholesteric liquid crystal layer 34 toward the outer direction in the one direction in which the optical axis continuously rotates, light reflected from the cholesteric liquid crystal layer can be further dispersed, and the performance as a convex mirror can be improved.

In a case where the helical turning direction of the cholesteric liquid crystal layer is reversed, it is preferable that the continuous rotation direction of the optical axis in the liquid crystal alignment pattern is reversed from the center of the cholesteric liquid crystal layer 34, so that the reflective type liquid crystal diffraction element can act as a concave mirror.

In the present invention, in a case where the reflective type liquid crystal diffraction element acts as a convex mirror or a concave mirror, it is preferable to satisfy the following expression (4).

$$Φ ( r ) = ( π / λ ) [ {( {r}^{2} + {f}^{2} )}^{1 / 2} - f ] \qquad ( 4 )$$

Here, r represents a distance from a center of a concentric circle, and is represented by Expression “r=(x²+y²)^{1/2}”. x and y represent in-plane positions, and (x,y)=(0,0) represents the center of the concentric circle. Φ(r) represents an angle of an optical axis at the distance r from the center, λ represents a selective reflection center wavelength of the cholesteric liquid crystal layer, and f represents a desired focal length.

In the present invention, depending on the uses of the reflective type liquid crystal diffraction element, conversely, the length of the single period Λ in the concentric circular liquid crystal alignment pattern may gradually increase from the center of the cholesteric liquid crystal layer 34 toward the outer direction in the one direction in which the optical axis continuously rotates.

Furthermore, depending on the uses of the reflective type liquid crystal diffraction element such as a case where it is desired to provide a light amount distribution in the reflected light, a configuration in which regions having partially different lengths of the single periods A in the one direction in which the optical axis continuously rotates are provided can also be used instead of the configuration in which the length of the single period Λ gradually changes in the one direction in which the optical axis continuously rotates.

As the exposure method and the exposure device for the alignment film for aligning the cholesteric liquid crystal layer, the same exposure method and exposure device as those in a case of the first transmissive type polarization diffraction element described below can be used. In addition, as a material for forming the cholesteric liquid crystal layer, the same material as the material for forming the liquid crystal layer of the first transmissive type polarization diffraction element described below can be used, except that a chiral agent for helically cholesterically aligning the liquid crystal compound is added. In addition, as a method of forming the cholesteric liquid crystal layer, the same method as that in a case of the first transmissive type polarization diffraction element described below can be used, except that the liquid crystal compound is cholesterically aligned.

More detailed configurations, materials, a production method of the cholesteric liquid crystal layer, an exposure method of the alignment film for aligning the cholesteric liquid crystal layer, and the like are described in WO2019/189852A and the like.

A thickness of the cholesteric liquid crystal layer is not particularly limited, and the thickness with which a required reflectivity of light can be obtained may be appropriately set depending on the uses of the reflective type liquid crystal diffraction element 18, the light reflectivity required for the cholesteric liquid crystal layer, the material for forming the cholesteric liquid crystal layer, and the like.

From the viewpoint of widening the field of view (FOV) of the image display system, it is preferable that the reflective type liquid crystal diffraction element 18 reflects and diffracts light at a larger diffraction angle in the vicinity of the end part. Therefore, it is preferable that the cholesteric liquid crystal layer has a region where the length of the single period Λ in the liquid crystal alignment pattern is less than 1.0 μm.

Here, in the example shown in FIG. 8, the reflective type liquid crystal diffraction element 18 has a configuration in which one cholesteric liquid crystal layer is provided; but the present invention is not limited thereto, and two or more cholesteric liquid crystal layers may be provided. In addition, the reflective type liquid crystal diffraction element 18 may include one or more of the cholesteric liquid crystal layers and one or more of cholesteric liquid crystal layers in the related art.

In addition, in a case where the reflective type liquid crystal diffraction element 18 includes a plurality of cholesteric liquid crystal layers, it is preferable that, at any one point in a plane, the lengths of the single periods and the helical pitches of the plurality of cholesteric liquid crystal layers are different from each other.

For example, in the image display system, in a case where the image display element 202 emits light having a plurality of wavelengths, it is preferable that the reflective type liquid crystal diffraction element 18 includes cholesteric liquid crystal layers which reflect light having each wavelength. A selective reflection wavelength in the cholesteric liquid crystal layer depends on the helical pitch. Accordingly, the plurality of cholesteric liquid crystal layers can be set to reflect light having each wavelength by setting the helical pitch according to each wavelength and making the helical pitches different from each other. In this case, it is necessary to match diffraction directions (diffraction angles) of the light having each wavelength at an in-plane point (region) of the reflective type liquid crystal diffraction element 18. Here, a reflection angle of light from the cholesteric liquid crystal layer having the liquid crystal alignment pattern also depends on a wavelength of the light. Therefore, by setting the helical pitches of the cholesteric liquid crystal layers at any one point in a plane to be different from each other, light components having different wavelengths can be reflected at the same diffraction angle.

For example, in the image display system, in a case where the image display element 202 emits light of three colors of red light, green light, and blue light, it is preferable that the reflective type liquid crystal diffraction element 18 includes three cholesteric liquid crystal layers corresponding to the respective colors.

Assuming that a first cholesteric liquid crystal layer reflects and diffracts blue light, a second cholesteric liquid crystal layer reflects and diffracts green light, and a third cholesteric liquid crystal layer reflects and diffracts red light, it is preferable that, at any one point in a plane, the first to third cholesteric liquid crystal layers have different lengths of the single periods and different helical pitches, and in a case where the lengths of the single periods in the first to third cholesteric liquid crystal layers at the any one point in the plane are respectively represented by Λ1, Λ2, and Λ3, the first to third cholesteric liquid crystal layers have a region where Λ1<Λ2<Λ3 is satisfied.

That is, the length of the single period may be longer as the helical pitch of the cholesteric liquid crystal layer which reflects light having a longer wavelength is longer.

### [First Transmissive Type Polarization Diffraction Element]

Hereinafter, the first transmissive type polarization diffraction element will be described.

It is preferable that the first transmissive type polarization diffraction element includes a liquid crystal layer formed of a liquid crystal composition containing a liquid crystal compound, the liquid crystal layer has a liquid crystal alignment pattern in which an orientation of an optical axis derived from the liquid crystal compound changes while continuously rotating in at least one in-plane direction, in a case where a length over which the orientation of the optical axis derived from the liquid crystal compound rotates by 180° in a plane is set as a single period, the liquid crystal layer has, in the plane, regions having different lengths of the single periods in the liquid crystal alignment pattern, and in the plane, the liquid crystal layer has regions in which the optical axis derived from the liquid crystal compound is twisted and rotates in a thickness direction of the liquid crystal layer, and has regions having different total magnitudes of twisted angles in the thickness direction.

The first transmissive type polarization diffraction element is a transmissive liquid crystal diffraction lens which selectively focuses dextrorotatory circularly polarized light or levorotatory circularly polarized light. Hereinafter, the transmissive type polarization diffraction element will also be simply referred to as a polarization diffraction element.

FIG. 12 conceptually shows an example of a polarization diffraction element 40. FIG. 12 is a cross-sectional view in the thickness direction. In addition, a plan view of the polarization diffraction element 40 is the same as that in FIG. 11.

As shown in FIGS. 11 and 12, the polarization diffraction element 40 has a liquid crystal layer 46 formed of a liquid crystal composition containing a liquid crystal compound 30.

The liquid crystal layer 46 has a liquid crystal alignment pattern in which an orientation of an optical axis derived from the liquid crystal compound 30 changes while continuously rotating in at least one in-plane direction. In addition, in the liquid crystal alignment pattern, in a case where a length over which the direction of the optical axis derived from the liquid crystal compound 30 rotates by 180° in a plane is set as a single period, the liquid crystal layer 46 has regions having different lengths of the single period in the plane.

Furthermore, in the plane, the liquid crystal layer 46 has regions in which the optical axis derived from the liquid crystal compound 30 is twisted and rotates in a thickness direction of the liquid crystal layer 46, and has regions having different total magnitudes of twisted angles in the thickness direction.

As shown in FIGS. 11 and 12, the polarization diffraction element 40 includes a substrate 42, an alignment film 44, and a liquid crystal layer 46. In the polarization diffraction element 40, the liquid crystal layer 46 acts as a polarization diffraction element.

Accordingly, the polarization diffraction element 40 may be composed only of the liquid crystal layer 46, may be formed by peeling off the substrate 42 and then including the alignment film 44 and the liquid crystal layer 46, or may be formed by peeling off the substrate 42 and the alignment film 44 from the liquid crystal layer 46 and laminating the liquid crystal layer 46 on another substrate.

In the polarization diffraction element 40 shown in FIGS. 11 and 12, the liquid crystal layer 46 is a liquid crystal layer which is formed on the alignment film 44 using a composition containing the liquid crystal compound 30, in which the liquid crystal compound 30 is aligned and immobilized in the following liquid crystal alignment pattern.

Specifically, the liquid crystal layer 46 has a liquid crystal alignment pattern in which an orientation of an optical axis derived from the liquid crystal compound 30 changes while continuously rotating in one direction in a radial shape from an inner side toward an outer side. That is, the liquid crystal alignment pattern in the liquid crystal layer 46 shown in FIGS. 11 and 12 is a radial pattern including the one direction in which the orientation of the optical axis derived from the liquid crystal compound 30 changes while continuously rotating in a radial shape from the inner side toward the outer side. In such a liquid crystal layer, a line connecting the liquid crystal compounds of which the optical axes are directed in the same direction is circular, and concentric circular line segments are arranged in a concentric circular pattern.

As described above, in FIG. 11, in order to simplify the drawing and clarify the configuration of the liquid crystal layer 46, only the liquid crystal compound 30 at the interface of the liquid crystal layer 46 on the alignment film 44 side is shown. However, as shown in FIG. 12, the liquid crystal layer 46 has a configuration in which the liquid crystal compounds 30 are laminated in the thickness direction, similarly to a typical liquid crystal layer formed of a composition containing a liquid crystal compound. In addition, in the present invention, as described above, the liquid crystal layer 46 has regions in which the optical axis derived from the liquid crystal compound 30 is twisted and rotates in a thickness direction, and has regions having different total magnitudes of twisted angles in the thickness direction.

Furthermore, in FIGS. 11 and 12, for example, a rod-like liquid crystal compound is exemplified as the liquid crystal compound 30, so that the direction of the optical axis matches with a longitudinal direction of the liquid crystal compound 30.

Specifically, in the liquid crystal layer 46, the orientation of the optical axis of the liquid crystal compound 30 changes while continuously rotating along a plurality of directions from the center, that is, the optical axis of the liquid crystal layer 46 toward the outer side, for example, along a direction indicated by an arrow D₁, a direction indicated by an arrow D₂, a direction indicated by an arrow D₃, a direction indicated by an arrow D₄, and the like.

Accordingly, in the liquid crystal layer 46, the rotation direction of the optical axes of the liquid crystal compounds 30 is the same in all directions (one direction). In the example shown in the drawing, the rotation direction of the optical axes of the liquid crystal compounds 30 is counterclockwise, in all the directions including the direction indicated by the arrow D₁, the direction indicated by the arrow D₂, the direction indicated by the arrow D₃, and the direction indicated by the arrow D₄.

That is, in a case where the arrow D₁ and the arrow D₄ are regarded as one straight line, the rotation direction of the optical axes of the liquid crystal compounds 30 is reversed at the center of the liquid crystal layer 46 on the straight line. For example, the straight line formed by the arrow D₁ and the arrow D₄ is directed in the right direction (arrow D₁ direction) in the drawing. In this case, the optical axis of the liquid crystal compound 30 initially rotates clockwise from the outer side toward the center of the liquid crystal layer 46, the rotation direction is reversed at the center of the liquid crystal layer 46, and then the optical axis of the liquid crystal compound 30 rotates counterclockwise from the center to the outer side of the liquid crystal layer 46. The center of the liquid crystal layer 46 is the optical axis of the polarization diffraction element.

As is well known, the liquid crystal layer having the liquid crystal alignment pattern in which the orientation of the optical axis derived from the liquid crystal compound 30 changes while continuously rotating in the one direction acts as a transmissive liquid crystal diffraction element which diffracts incident circularly polarized light in the one direction and the reverse direction according to the rotation direction of the optical axis and the turning direction of the incident circularly polarized light.

In the liquid crystal layer 46 having the liquid crystal alignment pattern in which the orientation of the optical axis of the liquid crystal compound 30 changes while continuously rotating in the one direction, a diffraction direction (refraction direction) of transmitted light depends on the rotation direction of the optical axes of the liquid crystal compounds 30. That is, in the liquid crystal alignment pattern, in a case where the rotation directions of the optical axes of the liquid crystal compounds 30 in the one direction are opposite to each other, the diffraction direction of transmitted light is opposite to the one direction in which the optical axis rotates.

In addition, in the liquid crystal layer 46 having the liquid crystal alignment pattern in which the orientation of the optical axis of the liquid crystal compound 30 changes while continuously rotating in the one direction, the diffraction direction of transmitted light varies depending on the turning direction of the incident circularly polarized light. That is, in the liquid crystal alignment pattern, the diffraction direction of transmitted light is reversed between a case where the incident light is dextrorotatory circularly polarized light and a case where the incident light is levorotatory circularly polarized light.

Furthermore, in a case where an in-plane retardation (retardation in the plane direction) value is set to λ/2, the liquid crystal layer 46 has a function as a typical λ/2 plate, that is, has a function of imparting a phase difference of a half wavelength, that is, 180° to a polarized light component incident into the liquid crystal layer.

Accordingly, the circularly polarized light which is incident into and diffracted by the liquid crystal layer 46 has an opposite turning direction. That is, the dextrorotatory circularly polarized light incident into and diffracted by the liquid crystal layer 46 is emitted as levorotatory circularly polarized light; and the levorotatory circularly polarized light is emitted as dextrorotatory circularly polarized light.

In the liquid crystal layer 46 of the polarization diffraction element 40, in the liquid crystal alignment pattern, in a case where the length over which the orientation of the optical axis derived from the liquid crystal compound rotates by 180° in one direction in which the orientation of the optical axis derived from the liquid crystal compound 30 changes while continuously rotating is set as a single period, the length of the single period gradually decreases from the inner side toward the outer side.

Here, in the liquid crystal layer having the liquid crystal alignment pattern in which the orientation of the optical axis of the liquid crystal compound 30 changes while continuously rotating in the one direction, the diffraction angle increases as the length of the single period decreases. Accordingly, in the liquid crystal layer 46 having the concentric circular liquid crystal alignment pattern, the diffraction angle gradually increases from the center of the concentric circle toward the outer direction.

Accordingly, the liquid crystal layer 46 having the concentric circular liquid crystal alignment pattern with the liquid crystal alignment pattern in which the optical axis derived from the liquid crystal compound changes while continuously rotating in a radial shape can transmit incidence light by diverging or focusing the ray depending on the rotation direction of the optical axis of the liquid crystal compound 30 and the turning direction of the incident circularly polarized light.

In other words, the polarization diffraction element 40 including the liquid crystal layer 46 acts as a concave lens in a case where dextrorotatory circularly polarized light is incident and acts as a convex lens in a case where levorotatory circularly polarized light, depending on the turning direction of the incident circularly polarized light. Alternatively, the polarization diffraction element 40 acts as a convex lens in a case where dextrorotatory circularly polarized light is incident, and acts as a concave lens in a case where levorotatory circularly polarized light is incident. In the example shown in the drawing, as described above, the liquid crystal layer 46 acts as a convex lens in a case where levorotatory circularly polarized light is incident, and focuses the levorotatory circularly polarized light.

A partially enlarged plan view of the liquid crystal layer 46 is the same configuration as that of FIG. 9.

Hereinafter, the action of the liquid crystal layer 46 will be described in detail with reference to a liquid crystal layer 46A having a liquid crystal alignment pattern in which an optical axis 30A derived from the liquid crystal compound 30 changes while continuously rotating in one direction indicated by an arrow X as shown in FIG. 9.

Even in the concentric circular liquid crystal alignment pattern shown in FIG. 11 in which the optical axis changes while continuously rotating in one direction in a radial shape from the inner side toward the outer side, the same optical effects as those of the liquid crystal alignment pattern shown in FIG. 9 can be exhibited for the one direction in which the optical axis changes while continuously rotating.

In the following description, the optical axis 30A derived from the liquid crystal compound 30 will also be referred to as “optical axis 30A of the liquid crystal compound 30” or “optical axis 30A”.

In the liquid crystal layer 46A, the liquid crystal compound 30 is two-dimensionally aligned in a plane parallel to the one direction indicated by the arrow X and a Y direction orthogonal to the arrow X direction. In FIG. 9, the Y direction is a direction orthogonal to the paper plane.

In the following description, “one direction indicated by the arrow X” will also be simply referred to as “arrow X direction”.

In the liquid crystal layer 46 shown in FIG. 11, a circumferential direction of the concentric circle in the concentric circular liquid crystal alignment pattern corresponds to the Y direction in FIG. 9.

The liquid crystal layer 46A has a liquid crystal alignment pattern in which the orientation of the optical axis 30A derived from the liquid crystal compound 30 changes while continuously rotating in the arrow X direction in a plane of the liquid crystal layer 46A.

Specifically, the “orientation of the optical axis 30A of the liquid crystal compound 30 changes while continuously rotating in the arrow X direction (predetermined one direction)” means that an angle between the optical axis 30A of the liquid crystal compound 30, which is arranged in the arrow X direction, and the arrow X direction varies depending on positions in the arrow X direction, and the angle between the optical axis 30A and the arrow X direction sequentially changes from θ to θ+180° or to θ−180° in the arrow X direction.

Meanwhile, regarding the liquid crystal compound 30 forming the liquid crystal layer 46A, the liquid crystal compounds 30 in which the orientations of the optical axes 30A are the same as one another are arranged at equal intervals in the Y direction orthogonal to the arrow X direction, that is, the Y direction orthogonal to one direction in which the optical axes 30A continuously rotate.

In other words, regarding the liquid crystal compound 30 forming the liquid crystal layer 46, in the liquid crystal compounds 30 arranged in the Y direction, angles between the orientations of the optical axes 30A and the arrow X direction are the same.

In the liquid crystal layer 46 shown in FIG. 11, a region where the orientations of the optical axes 30A are the same is formed in an annular shape where the centers match with each other, and a concentric circular liquid crystal alignment pattern is formed.

In the liquid crystal alignment pattern in which the optical axis 30A continuously rotates in the one direction, the length (distance) over which the optical axis 30A of the liquid crystal compound 30 rotates by 180° is a length Λ of the single period in the liquid crystal alignment pattern.

That is, in the liquid crystal layer 46A shown in FIG. 9, the length (distance) over which the optical axis 30A of the liquid crystal compound 30 rotates by 180° in the arrow X direction in which the orientation of the optical axis 30A changes while continuously rotating in a plane is set as the single period Λ in the liquid crystal alignment pattern. In other words, the single period Λ in the liquid crystal alignment pattern is defined as a distance from θ to θ+180° of the angle between the optical axis 30A of the liquid crystal compound 30 and the arrow X direction.

That is, a distance between centers of two liquid crystal compounds 30 in the arrow X direction is the single period Λ, the two liquid crystal compounds having the same angle in the arrow X direction. Specifically, as shown in FIG. 9, a distance between centers of two liquid crystal compounds 30 in the arrow X direction, in which the arrow X direction and the direction of the optical axis 30A match with each other, is the single period Λ.

In the liquid crystal alignment pattern in the liquid crystal layer 46A (liquid crystal layer 46), the single period Λ is repeated in the arrow X direction, that is, in one direction in which the orientation of the optical axis 30A changes while continuously rotating.

As described above, the liquid crystal layer 46A having such a liquid crystal alignment pattern is also a transmissive liquid crystal diffraction element, and the single period Λ is the period (single period) of the diffraction structure.

In the liquid crystal layer 46A, the liquid crystal compounds arranged in the Y direction have the same angle between the optical axis 30A and the arrow X direction. A region where the liquid crystal compounds 30 in which the angles between the optical axes 30A and the arrow X direction are the same are arranged in the Y direction will be referred to as a region R.

In this case, it is preferable that a value of in-plane retardation (Re) each of the regions R is a half wavelength, that is, λ/2. The in-plane retardation is calculated from a product of a difference in refractive index Δn due to refractive index anisotropy of the region R and a thickness of the liquid crystal layer. Here, the difference in refractive index due to the refractive index anisotropy of the regions R in the liquid crystal layer is defined by a difference between a refractive index of a direction of an in-plane slow axis of the region R and a refractive index of a direction orthogonal to the direction of the slow axis. That is, the difference Δn in refractive index due to the refractive index anisotropy of the regions R is the same as a difference between a refractive index of the liquid crystal compound 30 in the direction of the optical axis 30A and a refractive index of the liquid crystal compound 30 in a direction perpendicular to the optical axis 30A in a plane of the region R. That is, the above-described difference in refractive index Δn is the same as the difference in refractive index of the liquid crystal compound.

In the polarization diffraction element 40 having the concentric circular liquid crystal alignment pattern with the liquid crystal alignment pattern in which the optical axis 30A continuously rotates in one direction in a radial shape, regions where the orientations of the optical axes 30A are the same and that are formed in an annular shape where the centers match with each other correspond to the region R.

In a case where circularly polarized light is incident into the liquid crystal layer 46A, the light is diffracted and a direction of the circularly polarized light is changed.

The action is conceptually shown in FIGS. 14 and 15. In the liquid crystal layer 46A, the value of the product of the difference in refractive index of the liquid crystal compound and the thickness of the liquid crystal layer is λ/2.

As described above, the action is also the same in the polarization diffraction element 40 having the concentric circular liquid crystal alignment pattern with the liquid crystal alignment pattern in which the optical axis 30A continuously rotates in the one direction in a radial shape.

As shown in FIG. 14, in a case where the value of the product of the difference in refractive index of the liquid crystal compound of the liquid crystal layer 46 and the thickness of the liquid crystal layer 46 is λ/2, and an incidence ray L₁ as levorotatory circularly polarized light is incident into the liquid crystal layer 46, the incidence ray L₁ transmits through the liquid crystal layer 46A to be imparted with a retardation of 180°, and thus is converted into a transmitted ray L₂ as dextrorotatory circularly polarized light.

In addition, the liquid crystal alignment pattern formed in the liquid crystal layer 46 is a pattern which is periodic in the arrow X direction, so that the transmitted ray L₂ travels in a direction different from a traveling direction of the incidence ray L₁. In this way, the incidence ray L₁ of the levorotatory circularly polarized light is converted into the transmitted ray L₂ of the dextrorotatory circularly polarized light, which is tilted by a predetermined angle in the arrow X direction with respect to an incidence direction.

On the other hand, as conceptually shown in FIG. 15, in a case where the value of the product of the difference in refractive index of the liquid crystal compound of the liquid crystal layer 46A and the thickness of the liquid crystal layer 46A is λ/2, and an incidence ray L₄ as dextrorotatory circularly polarized light is incident into the liquid crystal layer 46A, the incidence ray L₄ transmits through the liquid crystal layer 46 to be imparted with a retardation of 180°, and thus is converted into a transmitted ray L₅ as levorotatory circularly polarized light.

In addition, the liquid crystal alignment pattern formed in the liquid crystal layer 46A is a pattern which is periodic in the arrow X direction, so that the transmitted ray L₅ travels in a direction different from a traveling direction of the incidence ray L₄. In this case, the transmitted ray L₅ travels in a direction different from the transmitted ray L₂, that is, in a direction opposite to the arrow X direction with respect to the incidence direction. In this way, the incidence ray L₄ is converted into the transmitted ray L₅ of the levorotatory circularly polarized light, which is tilted by a predetermined angle in the arrow X direction with respect to the incidence direction.

In the liquid crystal layer 46A, it is preferable that the in-plane retardation value of the plurality of the regions R is a half wavelength, and it is preferable that an in-plane retardation Re(550)=Δn₅₅₀×d of the plurality of the regions R of the liquid crystal layer 46A with respect to an incidence ray having a wavelength of 550 nm is in a range defined by the following expression (1). Here, Δn₅₅₀ is a difference in refractive index due to the refractive index anisotropy of the region R in a case where the wavelength of the incidence light is 550 nm, and d represents a thickness of the liquid crystal layer 46A.

$$200 nm \leq Δ {n}_{550} \times d \leq 350 nm \qquad ( 1 )$$

That is, in a case where the “in-plane retardation Re(550)=Δn₅₅₀×d” of the plurality of the regions R of the liquid crystal layer 46A satisfies the expression (1), a sufficient amount of circularly polarized light components of light which has been incident into the liquid crystal layer 46A can be converted into circularly polarized light traveling in a direction tilted in a forward or backward direction with respect to the arrow X direction. It is more preferable that the in-plane retardation Re(550)=Δn₅₅₀×d is 225 nm≤Δn₅₅₀×d≤340 nm, and it is still more preferable that the in-plane retardation Re(550)=Δn₅₅₀×d is 250 nm≤Δn₅₅₀×d≤330 nm.

The above expression (1) is a range with respect to the incident light having a wavelength of 550 nm, but an in-plane retardation Re(λ)=Δn_{λ}×d of the plurality of the regions R of the liquid crystal layer with respect to incidence light having a wavelength of λ nm is preferably in a range defined by the following expression (1-2), and can be appropriately set.

$$0.7 \times ( λ / 2 ) nm \leq Δ {n}_{λ} \times d \leq 1.3 \times ( λ / 2 ) nm \qquad ( 1 - 2 )$$

In addition, a value of the in-plane retardation of the plurality of the regions R of the liquid crystal layer 46A in a range outside the range of the above expression (1) can also be used. Specifically, by adopting Δn₅₅₀×d<200 nm or 350 nm<Δn₅₅₀×d, light can be classified into light which travels in the same direction as a traveling direction of the incidence ray and light which travels in a direction different from a traveling direction of the incidence ray. In a case where Δn₅₅₀×d approaches 0 nm or 550 nm, the light component traveling in the same direction as the traveling direction of the incidence ray increases, and the light component traveling in a direction different from the traveling direction of the incidence ray decreases.

Furthermore, it is preferable that an in-plane retardation Re(450)=Δn₄₅₀×d of each of the regions R of the liquid crystal layer 46A with respect to incident light having a wavelength of 450 nm and the in-plane retardation Re(550)=Δn₅₅₀×d of each of the regions R of the liquid crystal layer 46A with respect to incident light having a wavelength of 550 nm satisfy the following expression (2). Here, Δn₄₅₀ represents a difference in refractive index due to the refractive index anisotropy of the region R in a case where the wavelength of the incidence ray is 450 nm.

$$( Δ {n}_{450} \times d ) / ( Δ {n}_{550} \times d ) < 1. \qquad ( 2 )$$

The expression (2) represents that the liquid crystal compound 30 contained in the liquid crystal layer 46A has reverse dispersibility. That is, by satisfying the expression (2), the liquid crystal layer 46A can respond to incident light having a wide wavelength range.

By changing the single period Λ of the liquid crystal alignment pattern formed in the liquid crystal layer 46A, diffraction angles of the transmitted rays L₂ and L₅ can be adjusted. Specifically, as the single period Λ of the liquid crystal alignment pattern decreases, light transmitted through the liquid crystal compounds 30 adjacent to each other more strongly interfere with each other, so that the transmitted rays L₂ and L₅ can be more largely diffracted.

In addition, in the liquid crystal layer 46A, by reversing the rotation direction of the optical axes 30A of the liquid crystal compounds 30 which rotate in the arrow X direction, the diffraction direction of the transmitted light can be reversed.

Furthermore, in the liquid crystal layer 46A, the diffraction direction of the transmitted light is reversed depending on the turning direction of the incident circularly polarized light. That is, in the liquid crystal layer 46A, the diffraction directions of the transmitted light are opposite to each other between the dextrorotatory circularly polarized light and the levorotatory circularly polarized light.

Regarding the above points, the same applies to the liquid crystal layer 46 having the concentric circular liquid crystal alignment pattern as described above.

Furthermore, the liquid crystal layer 46 has regions in which the optical axis is twisted and rotates in a thickness direction of the liquid crystal layer 46, and has regions having different twisted angles in the thickness direction. This point will be described below.

The liquid crystal layer 46 is formed of a liquid crystal composition containing a rod-like liquid crystal compound or a disk-like liquid crystal compound, and has a liquid crystal alignment pattern in which optical axes of the rod-like liquid crystal compounds or the disk-like liquid crystal compounds are aligned as described above.

By forming, on the substrate 42, the alignment film 44 having the alignment pattern corresponding to the above-described liquid crystal alignment pattern and applying the liquid crystal composition onto the alignment film 44, and curing the applied liquid crystal composition, the liquid crystal layer 46 including the cured layer of the liquid crystal composition can be formed.

The liquid crystal composition for forming the liquid crystal layer 46 contains a rod-like liquid crystal compound or a disk-like liquid crystal compound, and may further contain other components such as a leveling agent, an alignment control agent, a polymerization initiator, and an alignment assistant.

In addition, it is preferable that the liquid crystal layer 46 has a wide range for the wavelength of incidence light, and is formed of a liquid crystal material having a reverse birefringence index dispersion. In addition, it is also preferable that the liquid crystal layer 46 can be made to have a substantially wide range for the wavelength of incidence light by imparting a torsion component to the liquid crystal composition or by laminating different retardation layers. For example, in the liquid crystal layer 46, a method of realizing λ/2 plate having a wide-range pattern by laminating two liquid crystal layers having different twisted directions is described in, for example, JP2014-089476A and can be preferably used in the present invention.

### —Rod-Like Liquid Crystal Compound—

As the rod-like liquid crystal compound, azomethines, azoxys, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, and alkenylcyclohexylbenzonitriles are preferably used. In addition to the above-described low-molecular-weight liquid crystal molecules, a high-molecular-weight liquid crystal molecular can also be used.

In the liquid crystal layer 46, it is preferable that the alignment of the rod-like liquid crystal compound is fixed by polymerization; and examples of the polymerizable rod-like liquid crystal compound include compounds described in Makromol. Chem., (1989), Vol. 190, p. 2255, Advanced Materials (1993), Vol. 5, p. 107, U.S. Pat. Nos. 4,683,327A, 5,622,648A, 5,770,107A, WO95/22586A, WO95/24455A, WO97/00600A, WO98/23580A, WO98/52905A, JP1989-272551A (JP-H1-272551A), JP1994-16616A (JP-H6-16616A), JP1995-110469A (JP-H7-110469A), JP1999-80081A (JP-H11-80081A), and JP2001-64627A. Furthermore, as the rod-like liquid crystal compound, for example, compounds described in JP1999-513019A (JP-H11-513019A) and JP2007-279688A can also be preferably used.

### —Disk-Like Liquid Crystal Compound—

As the disk-like liquid crystal compound, for example, compounds described in JP2007-108732A, JP2010-244038A, and the like can be preferably used.

In a case where the disk-like liquid crystal compound is used in the liquid crystal layer, the liquid crystal compound 30 rises in the thickness direction in the liquid crystal layer, and the optical axis 30A derived from the liquid crystal compound is defined as an axis perpendicular to a disc plane, that is, a so-called fast axis.

### —Photoreactive Chiral Agent—

The liquid crystal composition for forming the liquid crystal layer 46 may contain a photoreactive chiral agent.

The photoreactive chiral agent contains, for example, a compound represented by General Formula (I), and has properties capable of controlling an aligned structure of the liquid crystal compound and changing a helical pitch of the liquid crystal compound, that is, a helical twisting power (HTP) of a helical structure during light irradiation. That is, the photoreactive chiral agent is a compound which causes a helical twisting power of a helical structure derived from a liquid crystal compound, preferably, a nematic liquid crystal compound to change during light irradiation (ultraviolet rays to visible rays to infrared rays), and includes a chiral portion and a portion in which a structural change occurs during the light irradiation as required portions (molecular structural units). Moreover, the photoreactive chiral agent represented by General Formula (I) can significantly change the HTP of liquid crystal molecules.

The above-described HTP represents a helical twisting power of a helical structure of liquid crystals, that is, HTP=1/(Pitch×Concentration of chiral agent [mass fraction]). For example, the HTP can be obtained by measuring a helical pitch (single period of the helical structure; m) of a liquid crystal molecule at a certain temperature and converting the measured value into a value [μm⁻¹] in terms of the concentration of the chiral agent. In a case where a selective reflection color is formed by the photoreactive chiral agent depending on irradiation with light, a rate of change in HTP (=HTP before irradiation/HTP after irradiation) is preferably 1.5 or more and more preferably 2.5 or more in a case where the HTP decreases after the irradiation, and is preferably 0.7 or less and more preferably 0.4 or less in a case where the HTP increases after the irradiation.

Next, the compound represented by General Formula (I) will be described.

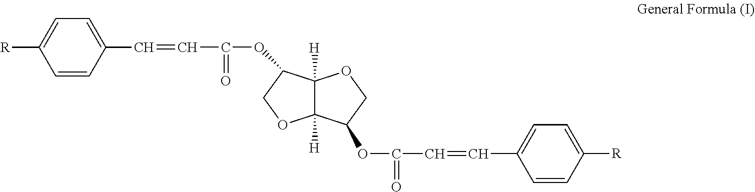

In the formula, R represents a hydrogen atom, an alkoxy group having 1 to 15 carbon atoms, an acryloyloxyalkyloxy group having 3 to 15 carbon atoms in total, or a methacryloyloxyalkyloxy group having 4 to 15 carbon atoms in total.

Examples of the above-described alkoxy group having 1 to 15 carbon atoms include a methoxy group, an ethoxy group, a propoxy group, a butoxy group, a hexyloxy group, and a dodecyloxy group; and among these, an alkoxy group having 1 to 12 carbon atoms is preferable, and an alkoxy group having 1 to 8 carbon atoms is more preferable.

Examples of the above-described acryloyloxyalkyloxy group having 3 to 15 carbon atoms in total include an acryloyloxyethyloxy group, an acryloyloxybutyloxy group, and an acryloyloxydecyloxy group; and among these, an acryloyloxyalkyloxy group having 5 to 13 carbon atoms is preferable, and an acryloyloxyalkyloxy group having 5 to 11 carbon atoms is more preferable.

Examples of the above-described methacryloyloxyalkyloxy group having 4 to 15 carbon atoms in total include a methacryloyloxyethyloxy group, a methacryloyloxybutyloxy group, and a methacryloyloxydecyloxy group; and among these, a methacryloyloxyalkyloxy group having 6 to 14 carbon atoms is preferable, and a methacryloyloxyalkyloxy group having 6 to 12 carbon atoms is more preferable.

A molecular weight of the photoreactive chiral agent represented by General Formula (I) is preferably 300 or more. In addition, a photoreactive optically active compound having high solubility in the liquid crystal compound, which will be described later, is preferable, and a photoreactive optically active compound having a solubility parameter SP value close to that of the liquid crystal compound is more preferable.

Hereinafter, specific examples (exemplary compounds (1) to (15)) of the compound represented by General Formula (I) are shown below, but the present invention is not limited thereto.

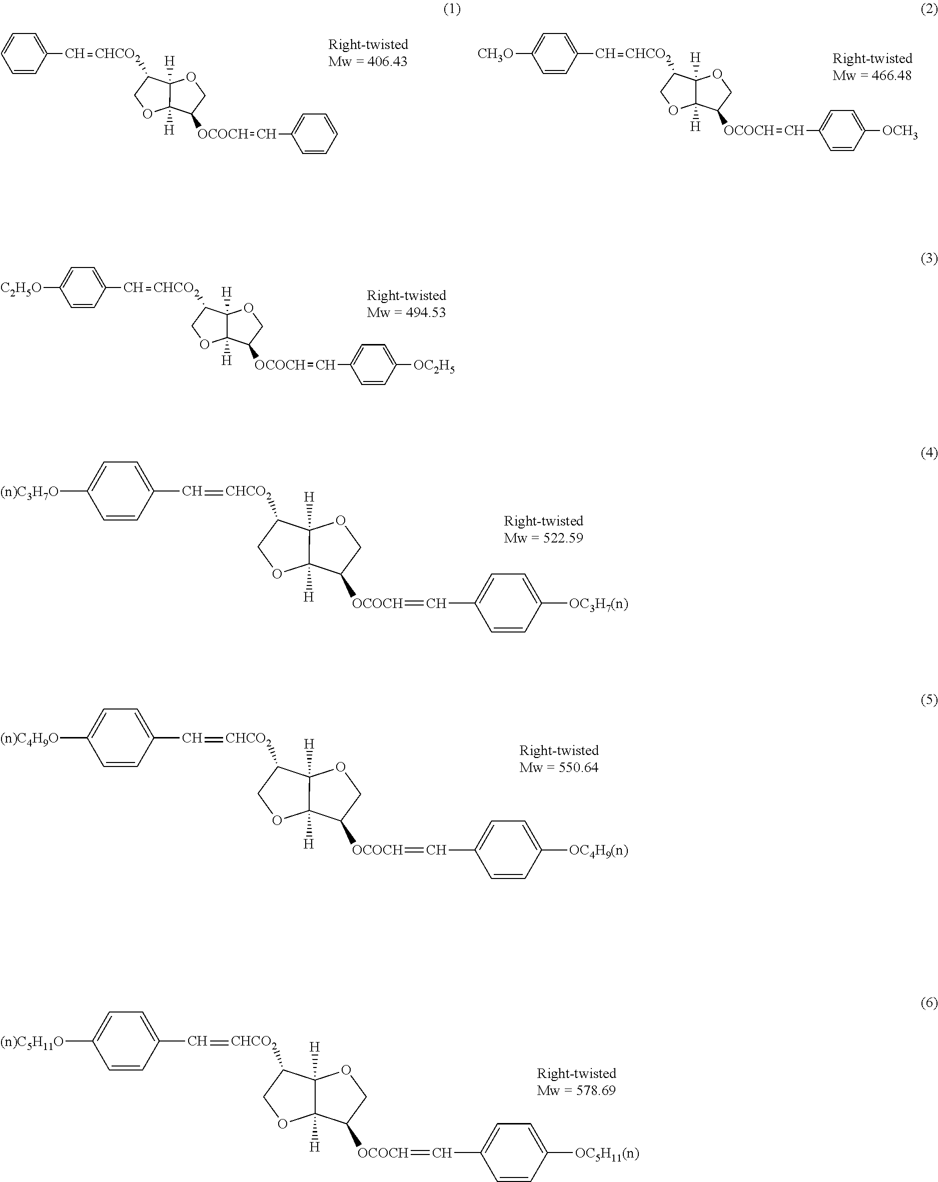

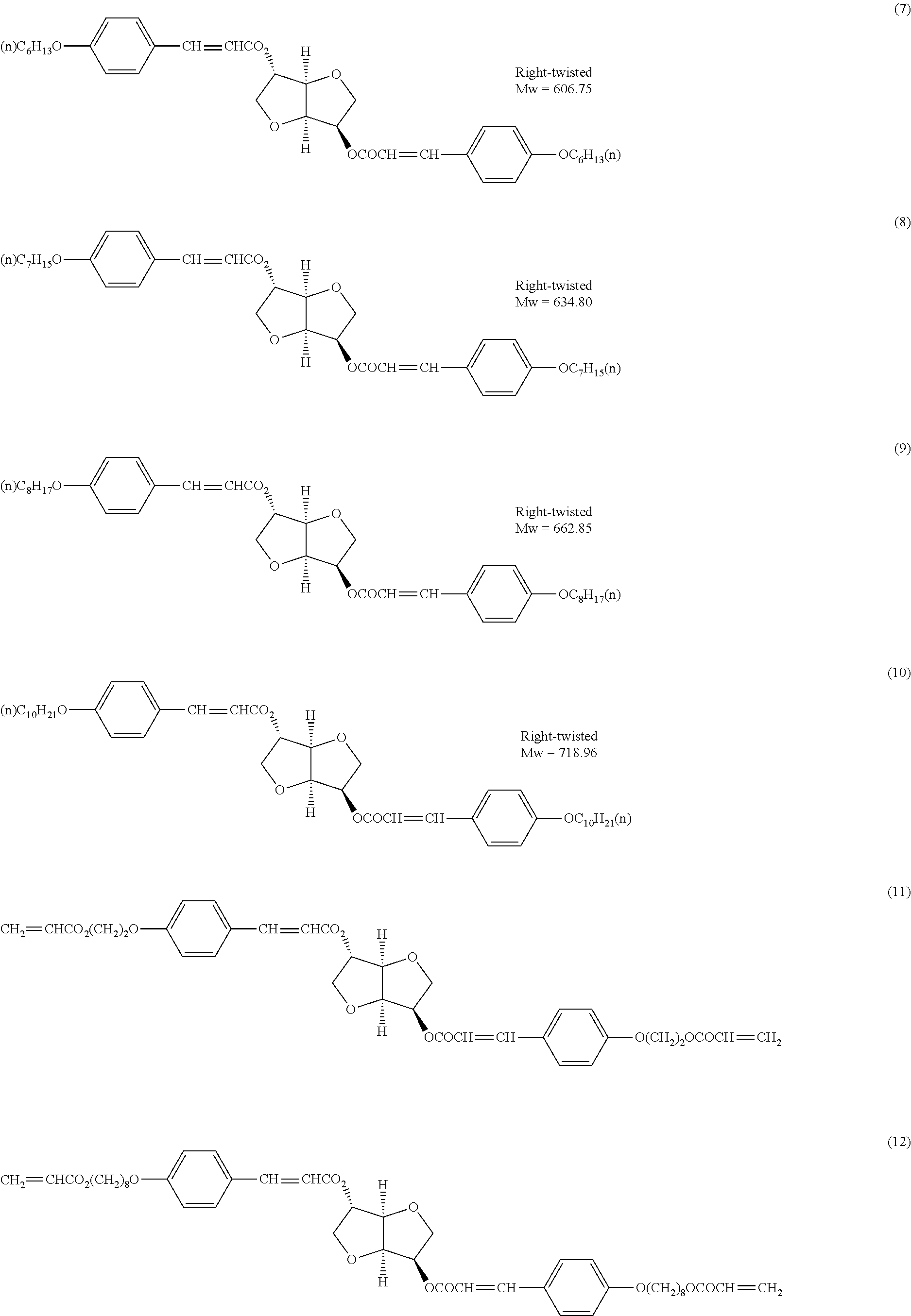

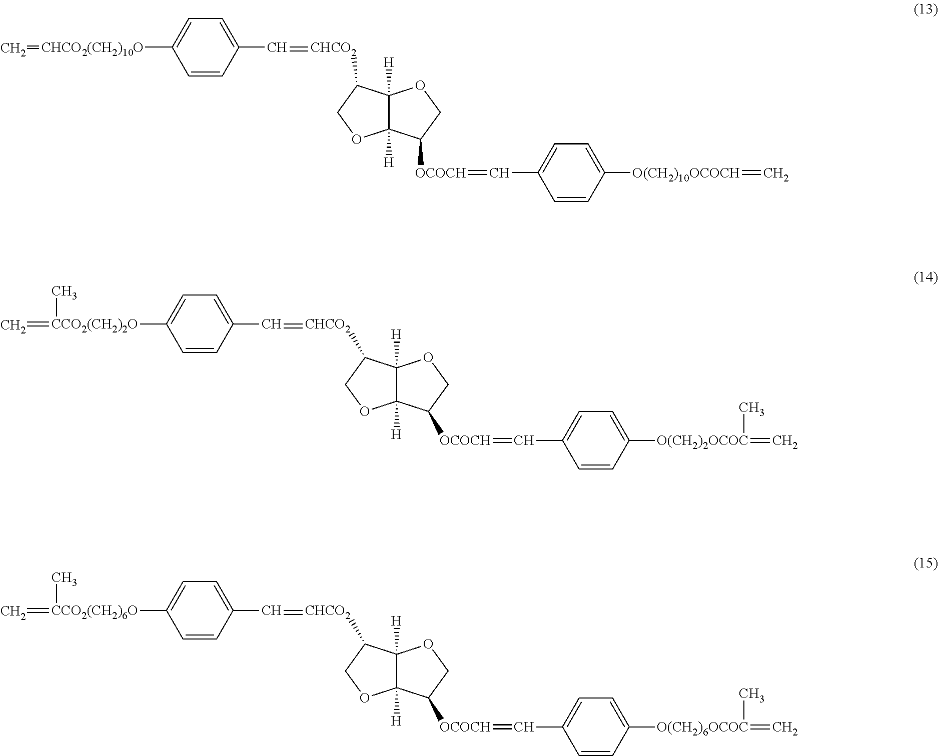

In the present invention, as the photoreactive chiral agent, for example, a photoreactive optically active compound represented by General Formula (II) is also used.

### General Formula (II)

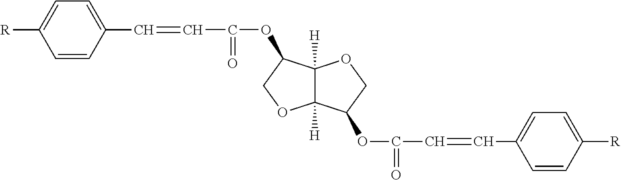

In the formula, R represents a hydrogen atom, an alkoxy group having 1 to 15 carbon atoms, an acryloyloxyalkyloxy group having 3 to 15 carbon atoms in total, or a methacryloyloxyalkyloxy group having 4 to 15 carbon atoms in total.

Examples of the above-described alkoxy group having 1 to 15 carbon atoms include a methoxy group, an ethoxy group, a propoxy group, a butoxy group, a hexyloxy group, an octyloxy group, and a dodecyloxy group; and among these, an alkoxy group having 1 to 10 carbon atoms is preferable, and an alkoxy group having 1 to 8 carbon atoms is more preferable.

Examples of the above-described acryloyloxyalkyloxy group having 3 to 15 carbon atoms in total include an acryloyloxy group, an acryloyloxyethyloxy group, an acryloyloxypropyloxy group, an acryloyloxyhexyloxy group, an acryloyloxybutyloxy group, and an acryloyloxydecyloxy group; and among these, an acryloyloxyalkyloxy group having 3 to 13 carbon atoms is preferable, and an acryloyloxyalkyloxy group having 3 to 11 carbon atoms is more preferable.

Examples of the above-described methacryloyloxyalkyloxy group having 4 to 15 carbon atoms in total include a methacryloyloxy group, a methacryloyloxyethyloxy group, and a methacryloyloxyhexyloxy group; and among these, a methacryloyloxyalkyloxy group having 4 to 14 carbon atoms is preferable, and a methacryloyloxyalkyloxy group having 4 to 12 carbon atoms is more preferable.

A molecular weight of the photoreactive optically active compound represented by General Formula (II) is preferably 300 or more. In addition, a photoreactive optically active compound having high solubility in the liquid crystal compound, which will be described later, is preferable, and a photoreactive optically active compound having a solubility parameter SP value close to that of the liquid crystal compound is more preferable.

Hereinafter, specific examples (exemplary compounds (21) to (32)) of the photoreactive optically active compound represented by General Formula (II) are shown below, but the present invention is not limited thereto.

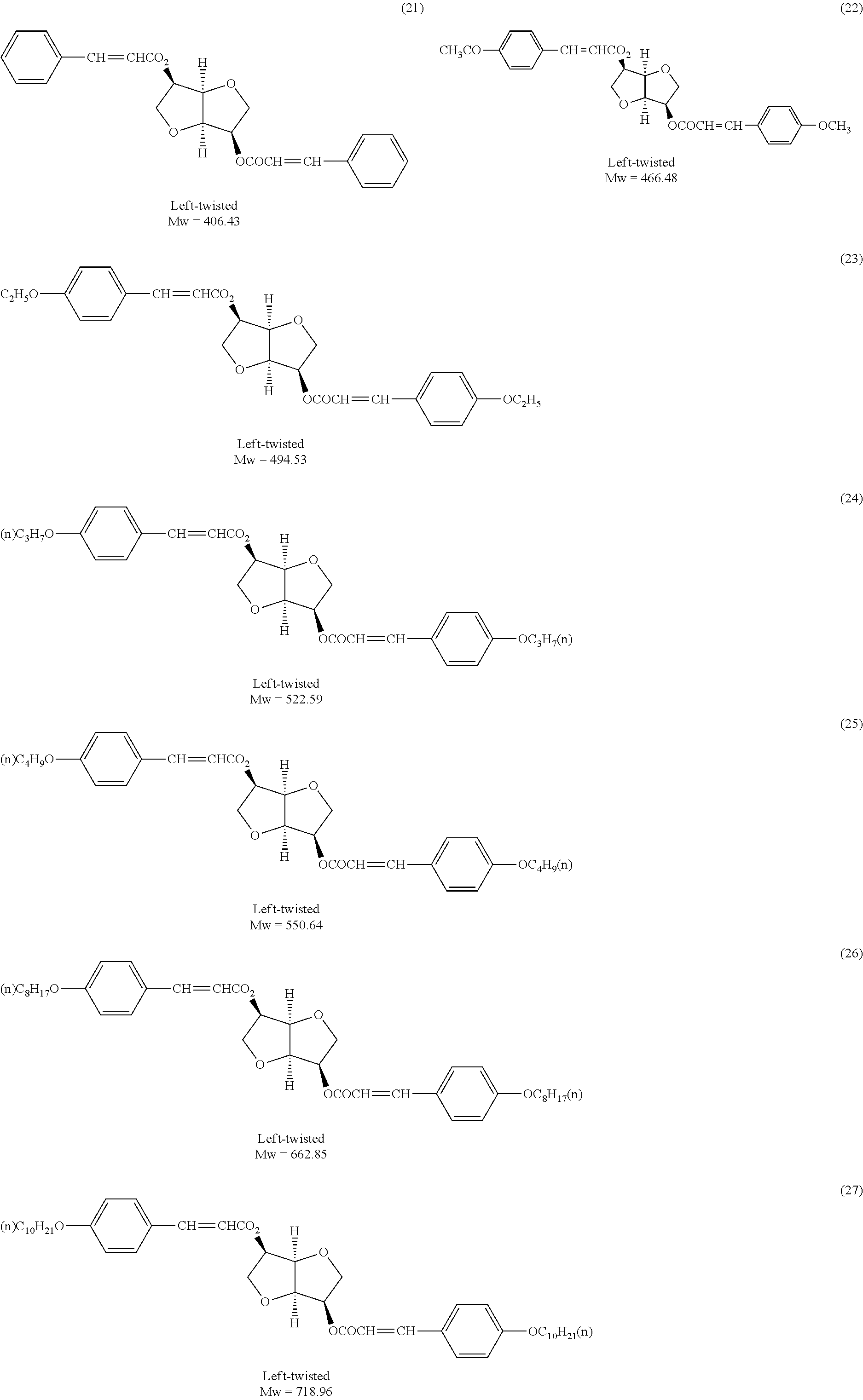

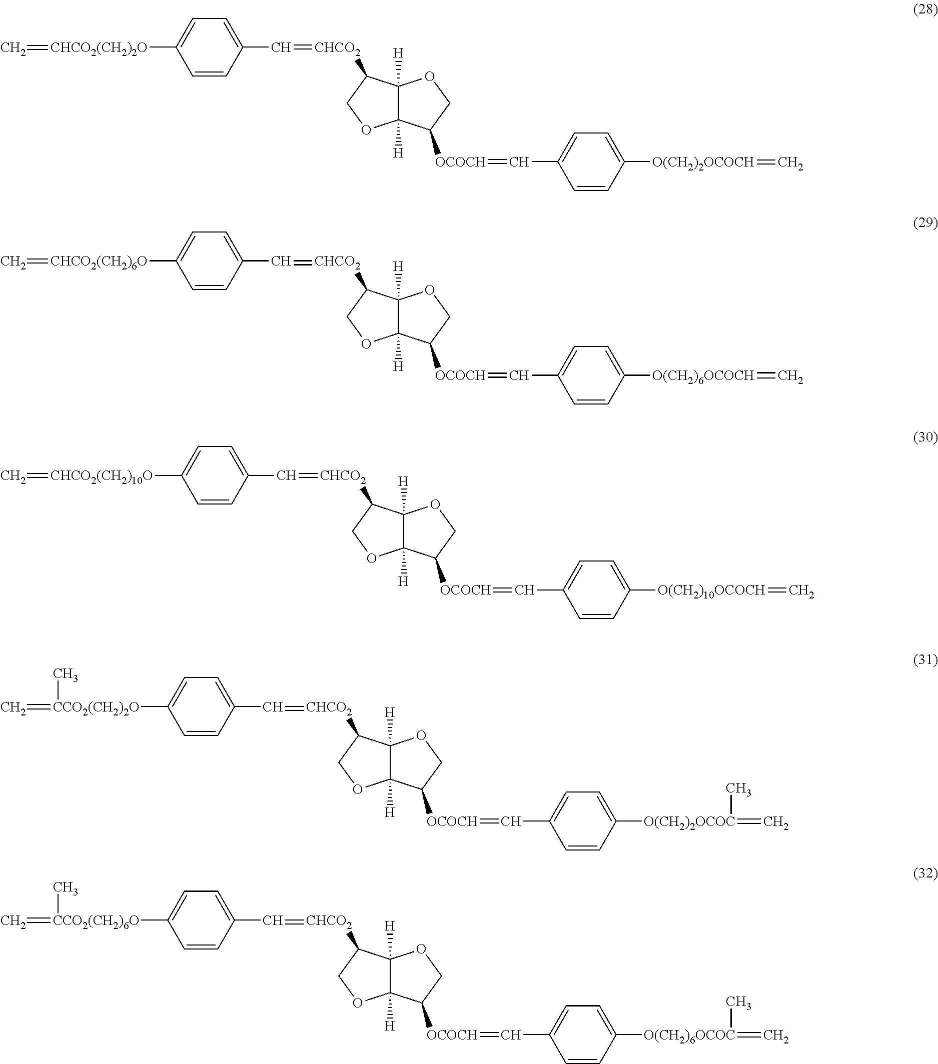

In addition, the photoreactive chiral agent can also be used in combination with a chiral agent having no photoreactivity, such as a chiral compound having a large temperature dependence of the helical twisting power. Examples of known chiral agents having no photoreactivity include chiral agents described in JP2000-44451A, JP1998-509726A (JP-H10-509726A), WO98/00428A, JP2000-506873A, JP1997-506088A (JP-H9-506088A), Liquid Crystals (1996, 21, 327), Liquid Crystals (1998, 24, 219), and the like.

Hereinafter, the action of the polarization diffraction element (liquid crystal layer) will be described.

As described above, in the liquid crystal layer which is formed of the composition containing the liquid crystal compound and has the liquid crystal alignment pattern in which the direction of the optical axis 30A rotates in the arrow X direction, circularly polarized light is refracted, and as the single period Λ of the liquid crystal alignment pattern decreases, the refraction (diffraction) angle increases.

Therefore, for example, in a case where a pattern is formed such that the single periods A of the liquid crystal alignment patterns are different from each other in different in-plane regions, light which is incident into the different in-plane regions and refracted at different angles such that the brightness of the transmitted light varies depending on the refraction angles. In particular, in a case where the refraction angle is large, the brightness of the transmitted light is low.

On the other hand, in the optical unit according to the embodiment of the present invention, the liquid crystal layer 46 constituting the polarization diffraction element 40 has the liquid crystal alignment pattern in which the orientation of the optical axis derived from the liquid crystal compound rotates in one direction, and further has regions in which the optical axis is twisted and rotates in the thickness direction of the liquid crystal layer and regions having different total magnitudes of twisted angles of rotation in the plane. The structure in which the optical axis of the liquid crystal compound is twisted and rotates in the thickness direction of the liquid crystal layer can be formed by adding the above-described chiral agent to the liquid crystal composition. In addition, the configuration in which the in-plane regions have different twisted angles in the thickness direction can be formed by adding the above-described photoreactive chiral agent to the liquid crystal composition, and irradiating each region with light at different irradiation amounts.

With the polarization diffraction element including such a liquid crystal layer, refractive angle dependence of the amount of transmitted light in the plane is small; and for example, in a case where light incident in different regions in the plane is refracted at different angles, brightness of transmitted light can be increased.

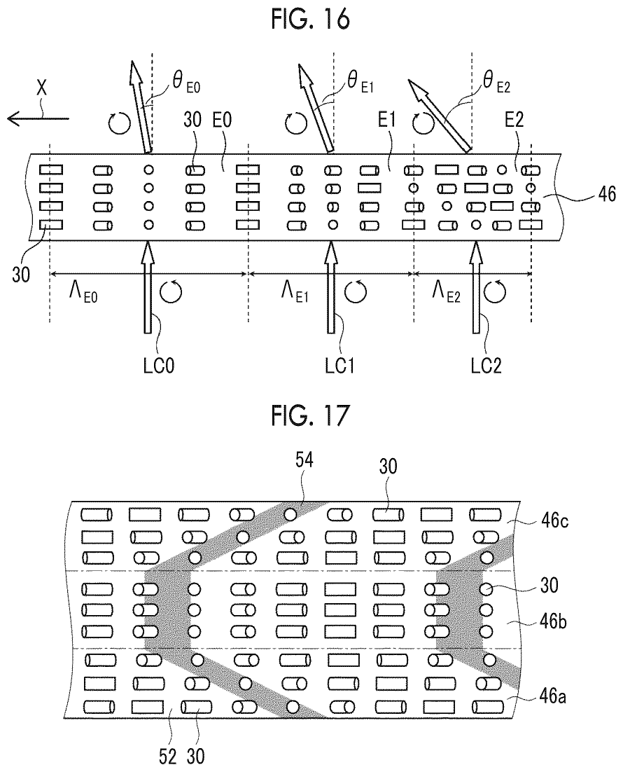

Hereinafter, the action of the polarization diffraction element 40 will be described in detail with reference to the conceptual views of FIG. 16.

In the polarization diffraction element 40, basically, only the liquid crystal layer exhibits the optical action. Therefore, in order to simplify the drawing and to clarify the configuration and the effects, FIG. 16 only shows the liquid crystal layer 46 in the polarization diffraction element 40.

As described above, the liquid crystal layer 46 of the polarization diffraction element 40 refracts incidence light in a predetermined direction to transmit circularly polarized light. In FIG. 16, the incidence light is levorotatory circularly polarized light.

In the portion shown in FIG. 16, the liquid crystal layer 46 has three regions E0, E1, and E2 in order from the left side in FIG. 16, and the respective regions have different lengths Λ of single periods. Specifically, the length Λ of the single period decreases in order of the regions E0, E1, and E2. In addition, the regions E1 and E2 have a structure in which the optical axis is twisted and rotates in the thickness direction of the liquid crystal layer. In the following description, the structure in which the optical axis is twisted and rotates in the thickness direction of the liquid crystal layer will also be referred to as “twisted structure”.

The twisted angle of the region E1 in the thickness direction is smaller than the twisted angle of the region E2 in the thickness direction. The region E0 is a region which does not have the twisted structure. That is, the region E0 is a region where the twisted angle is 0°.

The twisted angle is a twisted angle in the entire thickness direction.

In a polarization diffraction element 40A, in a case where levorotatory circularly polarized light LC1 is incident into the in-plane region E1 of the liquid crystal layer 46, as described above, the levorotatory circularly polarized light LC1 is refracted and transmitted at a predetermined angle in the arrow X direction with respect to the incident direction, that is, in the one direction in which the orientation of the optical axis of the liquid crystal compound changes while continuously rotating. Similarly, in a case where levorotatory circularly polarized light LC2 is incident into the in-plane region E2 of the liquid crystal layer 46, the levorotatory circularly polarized light LC2 is refracted and transmitted at a predetermined angle in the arrow X direction with respect to the incident direction. Similarly, in a case where levorotatory circularly polarized light LC0 is incident into the in-plane region E0 of the liquid crystal layer 46, the levorotatory circularly polarized light LC0 is refracted and transmitted at a predetermined angle in the arrow X direction with respect to the incident direction.

Here, regarding the refraction angles by the liquid crystal layer 46, since a single period Λ_{E2} of the liquid crystal alignment pattern in the region E2 is shorter than a single period Λ_{E1} of the liquid crystal alignment pattern in the region E1, as shown in FIG. 16, a refraction angle θ_{E2} of transmitted light in the region E2 with respect to the incidence light is more than a refraction angle θ_{E1} of transmitted light in the region E1 with respect to the incidence light. In addition, since a single period Λ_{E0} of the liquid crystal alignment pattern in the region E0 is longer than the single period Λ_{E1} of the liquid crystal alignment pattern in the region E1, as shown in FIG. 16, a refraction angle θ_{E0} of transmitted light in the region E0 with respect to the incidence light is less than the refraction angle θ_{E1} of transmitted light in the region E1 with respect to the incidence light.

Here, in the diffraction of light by the liquid crystal layer having the liquid crystal alignment pattern in which the orientation of the optical axis of the liquid crystal compound changes while continuously rotating in a plane, there is a problem in that, in a case where the diffraction angle increases, the diffraction efficiency decreases, that is, the intensity of diffracted light decreases.

Therefore, in a case where the liquid crystal layer has regions having different lengths of the single periods, over which the orientation of the optical axis of the liquid crystal compound rotates by 180° in a plane, the diffraction angle varies depending on an incidence position of light, so that the amount of diffracted light varies depending on the incidence position in the plane. That is, a region where the transmitted and diffracted light is dark is provided depending on the incidence position in the plane.

On the other hand, in the present invention, it is preferable that the liquid crystal layer of the polarization diffraction element has a region where the liquid crystal layer is twisted and rotates in the thickness direction, and has regions where the magnitudes of the twisted angles are different in the thickness direction.

In the example shown in FIG. 16, a twisted angle φ_{E2} of the region E2 of the liquid crystal layer 46 in the thickness direction is larger than a twisted angle φ_{E1} of the region E1 in the thickness direction. In addition, the region E0 does not have the twisted structure in the thickness direction.

As a result, a decrease in the diffraction efficiency of refracted light can be suppressed.

In the example shown in FIG. 16, by imparting the twisted structure to the regions E1 and E2 in which the diffraction angle is more than that of the region E0, a decrease in amount of light refracted from the regions E1 and E2 can be suppressed. In addition, the twisted angle of the twisted structure of the region E2 in which the diffraction angle is more than that of the region E1 is adjusted to be more than that of the region E1 such that the decrease in amount of light refracted from the region E2 can be suppressed. As a result, the amounts of light transmitted through the incidence positions in the plane can be made to be uniform.

As described above, in the in-plane region where the refraction by the liquid crystal layer is large, the incidence light is refracted by being transmitted through the layer having a large twisted angle in the thickness direction. On the other hand, in the in-plane region where the refraction by the liquid crystal layer is small, the incidence light is refracted by being transmitted through the layer having a small twisted angle in the thickness direction.

That is, in the liquid crystal layer 46, by setting the twisted angle in the thickness direction in the plane according to the magnitude of refraction by the liquid crystal layer, the brightness of the transmitted light with respect to the incidence light can be increased.

Therefore, refractive angle dependence of the amount of transmitted light in the plane of the polarization diffraction element 40 can be reduced. That is, the in-plane brightness unevenness of the polarization diffraction element 40 can be reduced. Accordingly, for example, in a case of being used in an image display system such as a VR system, an image with less brightness unevenness of the image to be observed can be displayed.

As described above, the angle of the refracted light in the plane of the liquid crystal layer 46 increases as the single period Λ of the liquid crystal alignment pattern decreases.

In addition, in the liquid crystal alignment pattern, with regard to the twisted angle of the liquid crystal compound 30 in the thickness direction in the plane of the liquid crystal layer 46, a region with a short single period Λ over which the orientation of the optical axis 30A rotates 180° in the arrow X direction has a larger area than a region with a long single period Λ. In the liquid crystal layer 46 in the example shown in the drawing, as an example, as shown in FIG. 16, the single period Λ_{E2} of the liquid crystal alignment pattern in the region E2 of the liquid crystal layer 46 is shorter than the single period Λ_{E1} of the liquid crystal alignment pattern in the region E1, and the twisted angle φ_{E2} in the thickness direction is large. That is, the region E2 side of the liquid crystal layer 46 on the light incidence side largely refracts light.

Accordingly, by setting the twisted angle ϕ in the thickness direction in the plane with respect to the single period Λ of the liquid crystal alignment pattern as a target, the brightness of transmitted light refracted from different in-plane regions at different angles can be suitably increased.

That is, it is preferable that, in the liquid crystal layer 46, in a region where the single period in the liquid crystal alignment pattern is shorter, the twisted angle of the liquid crystal compound 30 in the thickness direction is larger (total twisted angles in the thickness direction are larger).

In the liquid crystal layer 46 in the example shown in the drawing, the single period Λ of the liquid crystal alignment pattern gradually decreases from the center toward the outer direction. Therefore, it is preferable that the twisted angle of the liquid crystal compound 30 in the thickness direction gradually increases from the center toward the outer direction.

The change in single period Λ and/or the change in twisted angle of the liquid crystal compound 30 in the thickness direction may be stepwise or continuous.

As described above, as the single period Λ of the liquid crystal alignment pattern in the liquid crystal layer 46 is shorter, the refraction angle increases. Therefore, the twisted angle in the thickness direction can be increased in the region where the single period Λ of the liquid crystal alignment pattern decreases, and thus the brightness of transmitted light can be increased.

Therefore, in regions having different lengths of single periods of the liquid crystal alignment pattern, it is preferable that a permutation of the lengths of the single periods and a permutation of the magnitudes of the twisted angles in the thickness direction are different from each other.

However, the present invention is not limited thereto, and in the transmissive type polarization diffraction element, the liquid crystal layer 46 may have regions in which the permutation of the lengths of the single periods and the permutation of the magnitudes of the twisted angles in the thickness direction match each other in the regions where the lengths of the single periods of the liquid crystal alignment pattern are different from each other. In the optical unit according to the embodiment of the present invention, the twisted angle in the thickness direction has a preferred range and may be appropriately set according to the single period Λ of the liquid crystal alignment pattern in the plane.

In the present invention, it is preferable that the liquid crystal layer 46 of the polarization diffraction element 40 has a region where the magnitude of the twisted angle in the thickness direction is 10° to 360°.

In addition, in the present invention, the twisted angle of the liquid crystal layer 46 of the polarization diffraction element 40 in the thickness direction may be appropriately set according to the single period Λ of the liquid crystal alignment pattern in the plane.

Furthermore, in the present invention, the single period Λ of the liquid crystal alignment pattern in the liquid crystal layer 46 may be appropriately set according to the refraction (diffraction) angle required for the polarization diffraction element 40. Here, it is preferable that the liquid crystal layer 46 has a region where the length of the single period is 0.6 μm or less. With such a configuration, the refraction angle of the liquid crystal layer 46 can be increased, a suitable wide FOV can be realized; and according to the present invention, even in a case where the refraction angle is large, a decrease in brightness can be prevented, and brightness unevenness of an image to be observed can be suppressed.

The configuration in which the liquid crystal layer 46 has regions having different twisted angles of the twisted structure in the plane can be formed by using a liquid crystal composition containing a liquid crystal compound and the above-described photoreactive chiral agent in which a helical twisting power (HTP) of a helical structure changes upon irradiation of light, and irradiating each region with light having a wavelength at which the HTP of the chiral agent changes before or during the curing of the liquid crystal composition for forming the liquid crystal layer 46 while changing the irradiation amount.

For example, by using a photoreactive chiral agent in which the HTP decreases upon irradiation of light, the HTP of the chiral agent decreases upon irradiation of light. Here, by changing the irradiation amount of light depending on the regions, for example, in a region where the irradiation amount is high, the decrease in HTP is large, the induction of helix is small, and thus the twisted angle of the twisted structure decreases. On the other hand, in a region where the irradiation amount is small, the decrease in HTP is small, and thus the twisted angle of the twisted structure increases.

The method of changing the irradiation amount of light depending on the regions is not particularly limited, and a method of irradiating light through a gradation mask, a method of changing the irradiation time depending on the regions, a method of changing the irradiation intensity depending on the regions, or the like can be used.

The gradation mask refers to a mask in which a transmittance with respect to light for irradiation changes in a plane.

In the present invention, the liquid crystal layer of the polarization diffraction element may have regions where the directions in which the liquid crystal layer is twisted and rotates in the thickness direction (orientations of the twisted angle) are different from each other.

For example, the liquid crystal layer may have a liquid crystal alignment pattern in which the orientation of the optical axis rotates in one direction, may have regions in which the optical axis is twisted and rotates in the thickness direction of the liquid crystal layer, may have the regions have different twisted angles of rotation in a plane, and may have regions in which the directions of twisting and rotation are different from each other in the thickness direction.

In this way, by having regions where the directions of twisting and rotation are different in the thickness direction, in the region having the twisted angle in the thickness direction, transmitted light for incidence light in various polarized states can be efficiently refracted.

In a cross-sectional image obtained by observing a cross section of the liquid crystal layer having the above-described liquid crystal alignment pattern with a scanning electron microscope (SEM) in a thickness direction along a direction in which the optical axis continuously rotates, the liquid crystal layer has bright portions and dark portions, which extend from one surface to the other surface.

In the bright portions and the dark portions, tilt directions and tilt angles vary depending on the presence or absence of the twist of the liquid crystal compound 30 in the thickness direction, the twisted direction, the twisted angle, and the single period of the liquid crystal alignment pattern.

For example, in a case where the liquid crystal compound 30 is not twisted and rotates in the thickness direction as in the above-described region E0, the liquid crystal layer has the bright portions and the dark portions extending in the thickness direction.

In addition, in a case where the liquid crystal compound 30 is twisted and rotates in the thickness direction as in the above-described region E1 and region E2, the liquid crystal layer has the bright portions and the dark portions, which are tilted with respect to the thickness direction. Here, in a case where the twisted direction (rotation direction) of the liquid crystal compound is opposite to each other, the tilt directions of the bright portions and the dark portions are opposite to each other.

As the liquid crystal layer, for example, as in a liquid crystal layer conceptually shown in FIG. 17, a configuration is exemplified in which a region 46a and a region 46c, in which a twisted direction of the liquid crystal compound 30 in the thickness direction is opposite to each other, sandwich a region 46b in which the liquid crystal compound 30 is not twisted in the thickness direction, to sandwich a region having the bright portion 52 and the dark portion 54 extending in the thickness direction in the regions in which the tilt directions of the bright portion 52 and the dark portion 54 are opposite to each other.

In addition, in the present invention, the configuration in which the liquid crystal layer has a plurality of regions having different twisted directions of the liquid crystal compound 30 is not limited to the regions shown in FIG. 17, and various configurations can be used.

That is, in the present invention, various configurations can be used as the liquid crystal layer, for example, a configuration consisting of two regions of the region 46a in which the twisted directions of the liquid crystal compound 30 in the thickness direction are opposite to each other, and the region 46c; a configuration consisting of four regions in which two of the two regions are laminated; a configuration consisting of two regions of the region 46a and the region 46b in which the liquid crystal compound 30 is not twisted in the thickness direction; a configuration having a plurality of regions in which the tilt directions of the dark portions are the same and the tilt angles, that is, the twisted angles of the liquid crystal compounds are different; and a configuration in which the region 46b in which the liquid crystal compound 30 is not twisted is further laminated on the three regions shown in FIG. 17.

In a case where the liquid crystal layer has the plurality of regions having different twisted directions of the liquid crystal compound 30 as shown in FIG. 17, the twisted angle of the liquid crystal compound 30 in the liquid crystal layer is the sum of magnitudes of the twisted angles of the respective regions.

For example, in the example shown in FIG. 17, in a case where the twisted angle of the liquid crystal compound 30 in the region 46a is 80°, the twisted angle of the liquid crystal compound 30 in the middle region 46b is 0°, and the twisted angle of the liquid crystal compound 30 in the region 46c is −80°, the twisted angle of the liquid crystal compound 30 in the liquid crystal layer is 0° which is “(80°)+(0°)+(−80°)”.

According to the study by the present inventor, even in the liquid crystal layer having the plurality of regions, it is preferable that the absolute value of the sum of the twisted angles of the liquid crystal compound 30 increases toward the peripheral portion.

As described above, the polarization diffraction element 40 includes the substrate 42, the alignment film 44, and the above-described liquid crystal layer 46.

As the substrate 42 constituting the polarization diffraction element 40, various sheet-like materials can be used as long as they can support the alignment film 44 and the liquid crystal layer 46 described below.

As the substrate 42, a transparent support is preferable, and examples thereof include a polyacrylic resin film such as polymethyl methacrylate, a cellulose resin film such as cellulose triacetate, a cycloolefin polymer film (for example, trade name “ARTON”, manufactured by JSR Corporation; or trade name “ZEONOR”, manufactured by Zeon Corporation), polyethylene terephthalate (PET), polycarbonate, and polyvinyl chloride.

The alignment film 44 is formed on the surface of the substrate 42.

The liquid crystal alignment pattern in the liquid crystal layer 46 follows the alignment pattern formed on the alignment film 44. Accordingly, the same alignment pattern as the liquid crystal alignment pattern in the liquid crystal layer 46 is formed in the alignment film 44 for forming the liquid crystal layer having the liquid crystal alignment pattern.

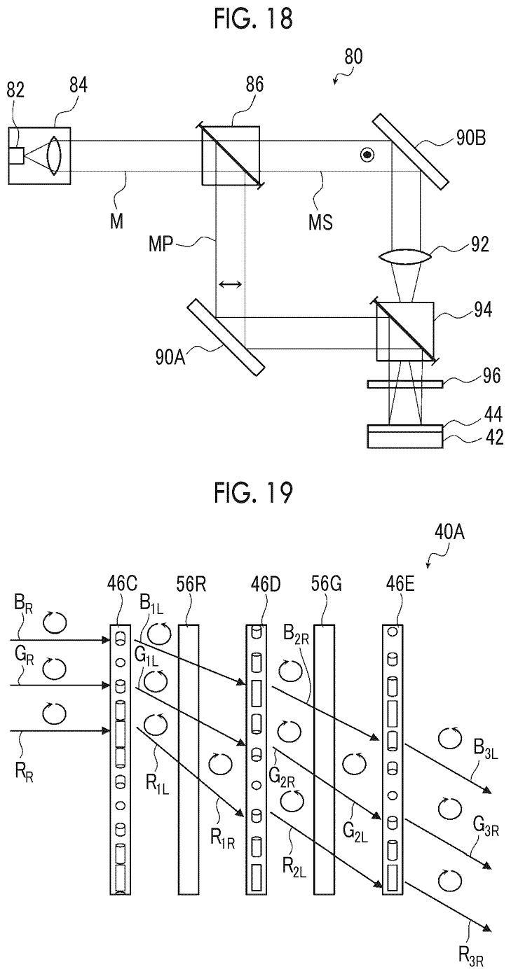

FIG. 18 conceptually shows an example of an exposure device in which the coating film serving as the alignment film 44 (photo-alignment film) for forming the liquid crystal layer 46 is exposed to form an alignment pattern corresponding to the concentric circular liquid crystal alignment pattern in which the optical axis changes while continuously rotating in a radial shape.

An exposure device 80 shown in FIG. 18 includes a light source 84 which includes a laser 82, a polarization beam splitter 86 which splits a laser light M emitted from the laser 82 into an S-polarized light MS and a P-polarized light MP, a mirror 90A which is disposed on an optical path of the P-polarized light MP and a mirror 90B which is disposed on an optical path of the S-polarized light MS, a lens 92 which is disposed on the optical path of the S-polarized light MS, a beam splitter 94, and a λ/4 plate 96.

The P-polarized light MP which is split by the polarization beam splitter 86 is reflected from the mirror 90A to be incident into the beam splitter 94. On the other hand, the S-polarized light MS which is split by the polarization beam splitter 86 is reflected from the mirror 90B and is focused by the lens 92 to be incident into the beam splitter 94.

The P polarized light MP and the S polarized light MS are combined by the beam splitter 94, are converted into dextrorotatory circularly polarized light and levorotatory circularly polarized light by the λ/4 plate 96 depending on the polarization direction, and are incident into the alignment film 44 on the substrate 42.

Due to interference between the dextrorotatory circularly polarized light and the levorotatory circularly polarized light, the polarization state of light with which the alignment film 44 is irradiated periodically changes according to interference fringes. An intersecting angle between dextrorotatory circularly polarized light and levorotatory circularly polarized light changes from the inside to the outer side of the concentric circle, so that an exposure pattern in which the pitch (single period) changes from the inner side toward the outer side can be obtained. Accordingly, a radial (concentric) alignment pattern in which the alignment states periodically change is obtained in the alignment film 44.

In the exposure device 80, the single period Λ of the liquid crystal alignment pattern in which the optical axis of the liquid crystal compound 30 continuously rotates by 180° in the one direction can be controlled by changing a focal power of the lens 92, the focal length of the lens 92, the distance between the lens 92 and the alignment film 44, and the like.

In addition, by adjusting the focal power of the lens 92 (F number of the lens 92), the length of the single period of the liquid crystal alignment pattern in which the optical axis continuously rotates in the one direction can be changed.

Specifically, the length of the single period in the liquid crystal alignment pattern in which the optical axis continuously rotates in the one direction can be changed depending on a light spread angle at which light is spread by the lens 92 due to interference with parallel light. More specifically, in a case where the focal power of the lens 92 is decreased, the light is close to the parallel light, so that the length Λ of the single period in the liquid crystal alignment pattern is gradually decreased from the inner side toward the outer side. Conversely, in a case where the focal power of the lens 92 is stronger, the length Λ of the single period in the liquid crystal alignment pattern rapidly decreases from the inner side toward the outer side.

That is, by adjusting the refractive index of the lens 92, the refractive index of the transmissive type polarization diffraction element (liquid crystal layer 46) can be adjusted to act as a concave lens or a convex lens depending on the turning direction of the incident circularly polarized light.

The liquid crystal composition containing the liquid crystal compound and the photoreactive chiral agent, which is used for forming the above-described liquid crystal layer 46, is applied onto the exposed alignment film 44 formed as described above, dried, exposed using the above-described gradation mask, and cured by ultraviolet irradiation or the like as necessary.

As a result, the liquid crystal layer 46 having the above-described concentric circular liquid crystal alignment pattern, having regions in which the length of the single period of the liquid crystal alignment pattern varies in the plane, having regions in which the liquid crystal compound is twisted and rotates in the thickness direction in the plane, and having regions in which the total magnitudes of the twisted angles are different can be formed, and the polarization diffraction element 40 as shown in FIGS. 11 and 12 can be produced.

Preferable examples of the compound having a photo-aligned group, that is, a photo-alignment material used in a photo-alignment film include: an azo compound described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking ester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-12823A.

Among these, an azo compound, a photocrosslinking polyimide, a photocrosslinking polyamide, a photocrosslinking ester, a cinnamate compound, or a chalcone compound is suitability used.

The above-described polarization diffraction element 40 includes only one liquid crystal layer 46, but the present invention is not limited thereto.

That is, in the optical unit according to the embodiment of the present invention, the polarization diffraction element may include a plurality of the liquid crystal layers.

For example, a polarization diffraction element including a plurality of the liquid crystal layers and a wavelength selective retardation layer provided between the liquid crystal layers is exemplified.

The wavelength selective retardation layer is a member which converts circularly polarized light in a specific wavelength range into circularly polarized light having an opposite turning direction.

In addition, in the configuration, it is preferable that at least one liquid crystal layer has a single period different from that of other liquid crystal layers, and it is more preferable that all the liquid crystal layers have different single periods A.

The liquid crystal layer having the above-described liquid crystal alignment pattern refracts and transmits circularly polarized light, but a refractive index thereof varies depending on a wavelength of transmitted light. That is, in the red light, the green light, and the blue light, the refractive index (refraction angle) of the red light having the longest wavelength is the highest, and the refractive index of the blue light having the shortest wavelength is the lowest.

Accordingly, in a case where the red light, the green light, and the blue light corresponding to a full color image are incident on one liquid crystal layer, the refractive index, that is, the degree of focusing is different for each light, and there is a possibility that color shift occurs in the image to be observed.

On the other hand, by providing the polarization diffraction element with a plurality of liquid crystal layers and a wavelength selective retardation layer between the liquid crystal layers, the refractive indices of the red light, the green light, and the blue light in the polarization diffraction element, that is, the refraction angles can be made to substantially coincide with each other.

FIG. 19 conceptually shows an example thereof.

In FIG. 19, a polarization diffraction element 40A includes, in the traveling direction of light, a first liquid crystal layer 46C, a second liquid crystal layer 46D, and a third liquid crystal layer 46E in this order. The single period Λ in the liquid crystal alignment pattern is the shortest in the first liquid crystal layer 46C and the longest in the second liquid crystal layer 46D. Furthermore, in the polarization diffraction element 40A, rotation directions of optical axes of the first liquid crystal layer 46C and the third liquid crystal layer 46E in one direction (arrow X direction) are the same, and a rotation direction of optical axes of the second liquid crystal layer 46D is opposite to that of the first liquid crystal layer 46C and the third liquid crystal layer 46E.

In addition, the polarization diffraction element 40A includes a wavelength selective retardation layer 56R between the first liquid crystal layer 46C and the second liquid crystal layer 46D, and includes a wavelength selective retardation layer 56G between the second liquid crystal layer 46D and the third liquid crystal layer 46E. The wavelength selective retardation layer 56R is a retardation layer which selectively converts a turning direction of circularly polarized light of the red light. On the other hand, the wavelength selective retardation layer 56G is a retardation layer which selectively converts a turning direction of circularly polarized light of the green light.

In the present example, the circularly polarized light incident into the polarization diffraction element 40A is dextrorotatory circularly polarized light. Therefore, the light is refracted in a direction opposite to the levorotatory circularly polarized light described above.

In the polarization diffraction element 40A, in a case where dextrorotatory circularly polarized light R_{R} of the red light, dextrorotatory circularly polarized light G_{R} of the green light, and dextrorotatory circularly polarized light B_{R} of the blue light are incident into the first liquid crystal layer 46C, as described above, they are refracted and converted into levorotatory circularly polarized light R_{1L} of the red light, levorotatory circularly polarized light G_{1L} of the green light, and levorotatory circularly polarized light B_{1L} of the blue light.

Here, as described above, regarding the refraction angle by the first liquid crystal layer 46C, the angle of red light having the longest wavelength is the largest, and the angle of blue light having the shortest wavelength is the smallest. Accordingly, regarding the refraction angle with respect to the incidence light, as shown in FIG. 10, an angle θ_{R1} of red light (R) is the largest, an angle θ_{G1} of green light (G) is intermediate, and an angle θ_{B1} of blue light (B) is the smallest. In addition, since the single period Λ of the liquid crystal layer is the shortest in the first liquid crystal layer 46C, the refraction angle of each light is the largest in a case of transmitting the first liquid crystal layer 46C.

Next, the levorotatory circularly polarized light R_{1L} of the red light, the levorotatory circularly polarized light G_{1L} of the green light, and the levorotatory circularly polarized light B_{1L} of the blue light, transmitted through the first liquid crystal layer 46C, are incident into the wavelength selective retardation layer 56R.

The wavelength selective retardation layer 56R converts only the circularly polarized light of the red light into circularly polarized light having an opposite turning direction, and allows transmission (passage) of the other light as it is.

Accordingly, in a case where the levorotatory circularly polarized light R_{1L} of the red light, the levorotatory circularly polarized light G_{1L} of the green light, and the levorotatory circularly polarized light B_{1L} of the blue light are incident into and transmitted through the wavelength selective retardation layer 56R, the levorotatory circularly polarized light G_{1L} of the green light and the levorotatory circularly polarized light B_{1L} of the blue light are transmitted through the wavelength selective retardation layer 56R as it is. On the other hand, the levorotatory circularly polarized light R_{1L} of the red light is converted into dextrorotatory circularly polarized light R_{1R} of the red light.

Next, the dextrorotatory circularly polarized light R_{1R} of the red light, the levorotatory circularly polarized light G_{1L} of the green light, and the levorotatory circularly polarized light B_{1L} of the blue light, transmitted through the wavelength selective retardation layer 56R, are incident into the second liquid crystal layer 46D.

In the same manner, the dextrorotatory circularly polarized light R_{1R} of the red light, the levorotatory circularly polarized light G_{1L} of the green light, and the levorotatory circularly polarized light B_{1L} of the blue light, which are incident into the second liquid crystal layer 46D, are also refracted and converted into circularly polarized light having an opposite turning direction such that levorotatory circularly polarized light R_{2L} of the red light, dextrorotatory circularly polarized light G_{2R} of the green light, and dextrorotatory circularly polarized light B_{2R} of the blue light are emitted.

Here, both the green light and the blue light incident into the second liquid crystal layer 46D are levorotatory circularly polarized light. On the other hand, the red light incident into the second liquid crystal layer 46D is dextrorotatory circularly polarized light having a different direction of circularly polarized light, which is converted by the wavelength selective retardation layer 56R, from the green light and the blue light.

In addition, as described above, the rotation directions of the optical axes 30A of the liquid crystal compounds 30 in the first liquid crystal layer 46C and the second liquid crystal layer 46D are opposite to each other.

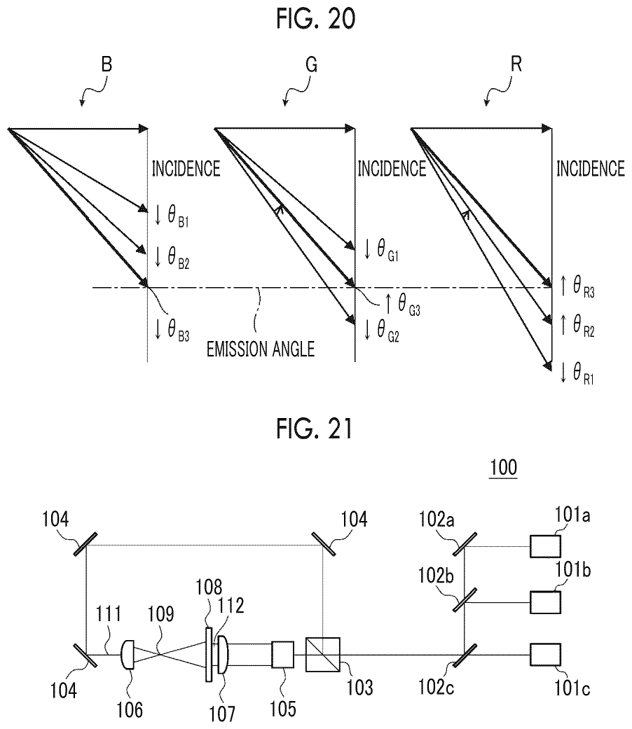

Therefore, levorotatory circularly polarized light G_{2L} of the green light and levorotatory circularly polarized light B_{2L} of the blue light, which are incident into the second liquid crystal layer 46D, are further refracted in the same direction as above, and are emitted at an angle θ_{G2} and an angle θ_{B2} with respect to the incidence light (the dextrorotatory circularly polarized light G_{R} of the green light and the dextrorotatory circularly polarized light B_{R} of the blue light) as shown in FIG. 20.

On the other hand, as shown on the right side of FIG. 19, the dextrorotatory circularly polarized light R_{1R} of the red light, which is incident into the second liquid crystal layer 46D and having an opposite turning direction, is refracted in a direction opposite to the first liquid crystal layer 46C such that the refraction is returned. As a result, the levorotatory circularly polarized light R_{2L} of the red light, emitted from the second liquid crystal layer 46D, is emitted at an angle θ_{R2} smaller than the angle θ_{R1} with respect to the incidence light (dextrorotatory circularly polarized light R_{R} of red light).

In addition, since the single period Λ of the second liquid crystal layer 46 is the longest, the refraction angle of each light is the smallest in a case of transmitting the second liquid crystal layer 46D.

Next, the levorotatory circularly polarized light R_{2L} of the red light, the dextrorotatory circularly polarized light G_{2R} of the green light, and the dextrorotatory circularly polarized light B_{2R} of the blue light, transmitted through the second liquid crystal layer 46D, are incident into the wavelength selective retardation layer 56G.

The wavelength selective retardation layer 56G converts only green circularly polarized light into circularly polarized light having an opposite turning direction, and allows transmission of the other light as it is.

Accordingly, in a case where the levorotatory circularly polarized light R_{2L} of the red light, the dextrorotatory circularly polarized light G_{2R} of the green light, and the dextrorotatory circularly polarized light B_{2R} of the blue light are incident into and transmitted through the wavelength selective retardation layer 56G, the levorotatory circularly polarized light R_{2L} of the red light and the levorotatory circularly polarized light B_{2R} of the blue light are transmitted through the wavelength selective retardation layer 56G as it is. On the other hand, the dextrorotatory circularly polarized light G_{2R} of the green light is converted into levorotatory circularly polarized light G_{2L} of the green light.

Next, the levorotatory circularly polarized light R_{2L} of the red light, the levorotatory circularly polarized light G_{2L} of the green light, and the dextrorotatory circularly polarized light B_{2R} of the blue light, transmitted through the wavelength selective retardation layer 56G, are incident into the third liquid crystal layer 46E.

In the same manner, the levorotatory circularly polarized light R_{2L} of the red light, the levorotatory circularly polarized light G_{2L} of the green light, and the levorotatory circularly polarized light B_{2R} of the blue light, which are incident into the third liquid crystal layer 46E, are also refracted and converted into circularly polarized light having an opposite turning direction such that dextrorotatory circularly polarized light R_{3R} of the red light, dextrorotatory circularly polarized light G_{3R} of the green light, and levorotatory circularly polarized light B_{3L} of the blue light are emitted.

Here, the blue light incident into the third liquid crystal layer 46E is the dextrorotatory circularly polarized light B_{2R} of the blue light. In addition, since the direction of circularly polarized light of the red light is previously converted by the wavelength selective retardation layer 56R, the red light incident into the third liquid crystal layer 46E is the levorotatory circularly polarized light R_{2L} of the red light, which has a direction of circularly polarized light which is different from that of blue light. Furthermore, the green light incident into the third liquid crystal layer 46E is the levorotatory circularly polarized light G_{2L} of the green light, in which the direction of circular polarization is converted by the wavelength selective retardation layer 56G.

That is, the blue light incident into the third liquid crystal layer 46E is dextrorotatory circularly polarized light, and the red light and the green light incident into the third liquid crystal layer 46E are levorotatory circularly polarized light having a direction of circularly polarized light, which is converted by the wavelength selective retardation layer.

In addition, as described above, the rotation directions of the optical axes 30A of the liquid crystal compounds 30 in the second liquid crystal layer 46D and the third liquid crystal layer 46E are opposite to each other.

Therefore, as shown in FIGS. 19 and 20, the dextrorotatory circularly polarized light B_{2R} of the blue light, incident into the third liquid crystal layer 46E, is further refracted in the same direction and is emitted at an angle θ_{B3} with respect to the incidence light (dextrorotatory circularly polarized light B_{R} of blue light) as shown in FIG. 19.

On the other hand, in a case where the levorotatory circularly polarized light R_{2L} of the red light, having an opposite direction of circular polarization, is incident into the third liquid crystal layer 46E, the levorotatory circularly polarized light R_{2L} is further refracted to be returned. As a result, the dextrorotatory circularly polarized light R_{3R} of the red light, emitted from the third liquid crystal layer 46E, is emitted at an angle θ_{R3} smaller than the above angle θ_{R2} with respect to the incidence light (dextrorotatory circularly polarized light R_{R} of red light).

Similarly, in a case where the levorotatory circularly polarized light G_{2L} of the green light, which is opposite in circular polarization to the blue light, is incident into the third liquid crystal layer 46E, the levorotatory circularly polarized light G_{2L} is refracted to be returned to the opposite direction as shown in the center of FIG. 20. As a result, the dextrorotatory circularly polarized light G_{3R} of the green light, emitted from the third liquid crystal layer 46E, is emitted at an angle θ_{G3} smaller than the above angle θ_{G2} with respect to the incidence light (dextrorotatory circularly polarized light G_{R} of green light).

That is, in the polarization diffraction element 40A, red light having the longest wavelength range and the largest refraction by the liquid crystal layer is refracted by the first liquid crystal layer 46C, and then is refracted twice in a direction opposite to the first liquid crystal layer 46C by the second liquid crystal layer 46D and the third liquid crystal layer 46E.

In addition, the green light having the second longest wavelength range and the second largest refraction by the liquid crystal layer is refracted in the same direction by the first liquid crystal layer 46C and the second liquid crystal layer 46D, and then is refracted once in the opposite direction by the third liquid crystal layer 46E.

Furthermore, the blue light having the shortest wavelength range and the lowest refraction by the liquid crystal layer is refracted three times in the same direction by the first liquid crystal layer 46C, the second liquid crystal layer 46D, and the third liquid crystal layer 46E.

In this way, in the polarization diffraction element 40A, initially, all the light components are largely refracted in the same direction. Thereafter, in accordance with the magnitude of refraction by the liquid crystal layer depending on the wavelength, the light having the longest wavelength is refracted the most multiple times so as to return to a direction opposite to the initial refraction direction. As the wavelength of light decreases, the number of times of refraction which returns to the direction opposite to the initial refraction direction is reduced. Regarding the light having the shortest wavelength, the number of times of refraction which returns to the direction opposite to the initial refraction direction is the smallest. As a result, the refraction angle θ_{R3} of the red light, the refraction angle θ_{G3} of the green light, and the refraction angle θ_{B3} of the blue light, with respect to the incidence light, can be made to be very close to each other.

Therefore, with the polarization diffraction element 40A including the plurality of liquid crystal layers and the wavelength selective retardation layer, incident red light, blue light, and green light can be refracted at substantially the same angle and emitted in substantially the same direction.

In a case where light components having three wavelength ranges are targets as in the polarization diffraction element 40A of the example shown in FIG. 19, a designed wavelength of light having the longest wavelength is denoted by λa, a designed wavelength of light having the intermediate wavelength is denoted by λb, a designed wavelength of light having the shortest wavelength is denoted by λc (λa>λb>λc), the single period of the liquid crystal alignment pattern in the first liquid crystal layer is denoted by Λ₁, the single period of the liquid crystal alignment pattern in the second liquid crystal layer is denoted by Λ₂, and the single period of the liquid crystal alignment pattern in the third liquid crystal layer is denoted by Λ₃, emission directions of light components having two wavelength ranges can be made to be substantially the same by satisfying the following expressions.

Λ₂=[(λa+λc)λb/(λa−λb)λc]Λ₁,

Λ₃=[(λa+λc)λb/(λb−λc)λa]Λ₁

In the expression, any one of the first liquid crystal layer 46C or the third liquid crystal layer 46E may be the first layer.

In the present invention, as described above, the wavelength selective retardation layer is a member which converts circularly polarized light in a specific wavelength range into circularly polarized light having an opposite turning direction.

In other words, the wavelength selective retardation layer shifts only a phase in a specific wavelength range by π. The wavelength selective retardation layer will also be referred to as, for example, a λ/2 plate which acts only in a specific wavelength range.

The wavelength selective retardation layer can be produced, for example, by laminating a plurality of phase difference plates having different phase differences.

As the wavelength selective retardation layer, for example, a wavelength selective retardation layer described in JP2000-510961A, SID 99 DIGEST, pp. 1072 to 1075, or the like can be used.

In the wavelength selective retardation layer, a plurality of retardation plates (retardation layers) having different slow axis angles (slow axis directions) are laminated such that linearly polarized light in a specific wavelength range into linearly polarized light having an opposite turning direction. The plurality of phase difference plates are not limited to the configuration in which all the slow axis angles are different from each other; and for example, a slow axis angle of at least one phase difference plate may be different from that of another phase difference plate.

It is preferable that at least one phase difference plate has normal dispersibility. In a case where at least one phase difference plate has normal dispersibility, by laminating a plurality of phase difference plates at different slow axis angles, a λ/2 plate which acts only in a specific wavelength range can be realized.

On the other hand, the wavelength selective retardation layer described in JP2000-510961A, SID 99 DIGEST, pp. 1072 to 1075, or the like can selectively convert linearly polarized light into linearly polarized light having an opposite turning direction.

Here, in the present invention, the wavelength selective retardation layer is a layer which converts circularly polarized light in a specific wavelength range into circularly polarized light having an opposite turning direction. Therefore, it is preferable that λ/4 plate is provided on both surfaces of the wavelength selective retardation layer described in JP2000-510961A, SID 99 DIGEST, pp. 1072 to 1075, or the like for use.

As the λ/4 plate, various phase difference plates, for example, a cured layer, a structural birefringence layer, or the like of a polymer or a liquid crystal compound can be used.

It is preferable that the λ/4 plate has reverse dispersibility. In a case where the λ/4 plate has reverse dispersibility, incidence light in a wide wavelength range can be handled.

As the λ/4 plate, a retardation layer in which a plurality of phase difference plates are laminated to actually function as a λ/4 plate are preferably used. For example, a broadband λ/4 plate described in WO2013/137464A, in which a λ/2 plate and a λ/4 plate are used in combination, can handle with incidence light in a wide wavelength range and can be preferably used.

Examples of another configuration in which the polarization diffraction element includes a plurality of liquid crystal layers include a configuration in which a plurality of liquid crystal layers are used to diffract polarized light in a specific wavelength range and not diffract polarized light in a wavelength range different from the specific wavelength range.

For example, a red liquid crystal layer which diffracts only red light and does not diffract light in other wavelength ranges, a green liquid crystal layer which diffracts only green light and does not diffract light in other wavelength ranges, and a blue liquid crystal layer which diffracts only blue light and does not diffract light in other wavelength ranges are used, and refractive indices (refraction angles) of corresponding light components are made to match with each other in the red liquid crystal layer, the green liquid crystal layer, and the blue liquid crystal layer.

As a result, the refractive indices of the red light, the green light, and the blue light, which are incident into and refracted by the polarization diffraction element, can be made to match each other, and thus the three colors of light can be focused in the same manner.

The liquid crystal layer which diffracts polarized light in a specific wavelength range and does not diffract polarized light in a wavelength range different from the specific wavelength range can be produced, for example, by laminating a plurality of liquid crystal layers having different twisted angles and/or film thicknesses.

As an example, a configuration using a plurality of liquid crystal layers, described in Proc. SPIE 11472, Liquid Crystals XXIV, 1147219, and the like, can be used.

The polarization diffraction element diffracts polarized light in a specific wavelength range and does not diffract polarized light in a wavelength range different from the specific wavelength range, by laminating a plurality of liquid crystal layers having different twisted angles and/or film thicknesses. For example, in Proc. SPIE 11472, Liquid Crystals XXIV, 1147219, the polarization diffraction element which diffracts polarized light in a specific wavelength range can be achieved by alternately laminating a liquid crystal layer without twist and a liquid crystal layer with twist, and appropriately setting a film thickness of each liquid crystal layer.

### [Second Transmissive Type Polarization Diffraction Element (Optical Element)]

Hereinafter, the second transmissive type polarization diffraction element (optical element) will be described.

It is preferable that the second transmissive type polarization diffraction element includes a liquid crystal layer formed of a liquid crystal composition containing a liquid crystal compound, the liquid crystal layer has a liquid crystal alignment pattern in which an orientation of an optical axis derived from the liquid crystal compound changes while continuously rotating in at least one in-plane direction, and in a case where a length over which the orientation of the optical axis derived from the liquid crystal compound rotates by 180° in a plane is set as a single period, the liquid crystal layer has, in the plane, regions having different lengths of the single periods in the liquid crystal alignment pattern.

The second transmissive type polarization diffraction element is a transmissive liquid crystal diffraction lens which selectively diffuses or focuses dextrorotatory circularly polarized light or levorotatory circularly polarized light. As described above, the polarization diffraction element transmits incidence light by diverging or focusing the incidence light depending on the rotation direction of the optical axis of the liquid crystal compound and the turning direction of the incident circularly polarized light. Accordingly, in a case where the second transmissive type polarization diffraction element is appropriately set to diffuse or focus the incidence light depending on the turning direction of the target circularly polarized light, a polarization diffraction element having the same configuration as that of the first transmissive type polarization diffraction element can be used.

In addition, as the second transmissive type polarization diffraction element, a polarization diffraction element in which the liquid crystal layer does not have the regions having different total magnitudes of the twisted angles in the thickness direction in the plane can also be used. Furthermore, as the second transmissive type polarization diffraction element, a polarization diffraction element which does not have the region where the optical axis is twisted and rotates in the thickness direction of the liquid crystal layer can also be used.

The optical unit and image display system according to the embodiment of the present invention have been described in detail above, but the present invention is not limited to the above-described examples, and various improvements and changes may be made without departing from the spirit of the present invention.

### EXAMPLES

Hereinafter, the characteristics of the present invention will be described in detail by Examples. Materials, chemicals, used amounts, material amounts, ratios, treatment details, treatment procedures, and the like shown in the following examples can be appropriately changed within a range not departing from the scope of the present invention. Therefore, the scope of the present invention should not be construed as being limited to the following specific examples.

### Comparative Example 1

### <Production of Reflective Type Liquid Crystal Diffraction Element>

### (Support)

A glass substrate was used as a support.

### (Formation of Alignment Film)

The following coating liquid for forming an alignment film was applied onto the support by spin coating. The support on which the coating film of the alignment film-forming coating liquid was formed was dried using a hot plate at 60° C. for 60 seconds. As a result, an alignment film was formed.

Alignment film-forming coating liquid

| | |
|---|---|
| Material A for photo-alignment | 1.00 part by mass |
| Water | 16.00 parts by mass |
| Butoxyethanol | 42.00 parts by mass |
| Propylene glycol monomethyl ether | 42.00 parts by mass |

Material A for photo-alignment

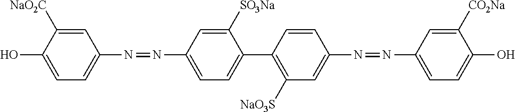

### (Exposure of Alignment Film)

The alignment film was exposed using the exposure device shown in FIG. 20 to form an alignment film P-G1 having a concentric circular alignment pattern.

In the exposure device, a laser which emits laser beam having a wavelength (355 nm) was used as the laser. An exposure amount of the interference light was set to 1,000 mJ/cm².

### (Formation of Cholesteric Liquid Crystal Layer)

As a liquid crystal composition forming a cholesteric liquid crystal layer G1, the following composition G-1 was prepared.

### Composition G-1

| | |
|---|---|
| Liquid crystal compound L-1 | 100.00 parts by mass |
| Chiral agent C1 | 5.4 parts by mass |
| Polymerization initiator I-1 | 3.00 parts by mass |
| Surfactant F1 | 0.02 parts by mass |
| Surfactant F2 | 0.20 parts by mass |
| Methyl ethyl ketone | 120.58 parts by mass |
| Cyclopentanone | 80.38 parts by mass |

Liquid crystal compound L-1 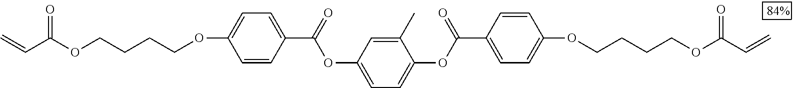 [SMILES: C=CC(=O)OCCCCOc1ccc(C(=O)Oc2ccc(OC(=O)c3ccc(OCCCCOC(=O)C=C)cc3)c(C)c2)cc1] 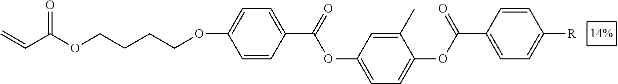 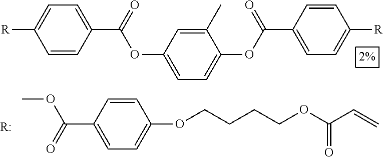
Chiral agent C1 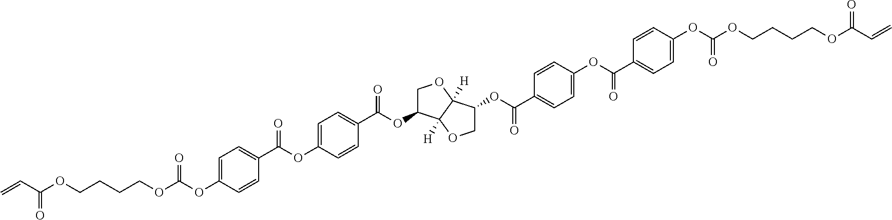 [SMILES: C=CC(=O)OCCCCOC(=O)Oc1ccc(C(=O)Oc2ccc(C(=O)O[C@H]3CO[C@@H]4[C@H]3OC[C@H]4OC(=O)c3ccc(OC(=O)c4ccc(OC(=O)OCCCCOC(=O)C=C)cc4)cc3)cc2)cc1]
Polymerization initiator I-1 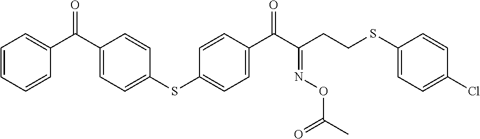 [SMILES: CC(=O)O/N=C(\CCSc1ccc(Cl)cc1)C(=O)c1ccc(Sc2ccc(C(=O)c3ccccc3)cc2)cc1]
Surfactant F1 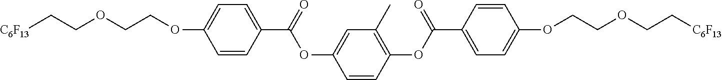
Surfactant F2

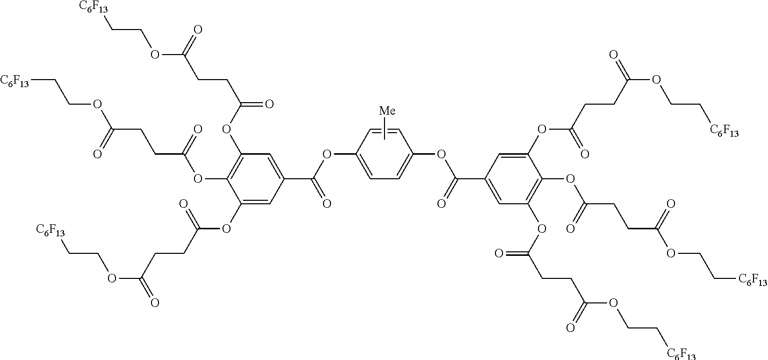

The cholesteric liquid crystal layer G1 was formed by applying the composition G-1 onto a photo-alignment film. Specifically, the composition G-1 was applied onto the photo-alignment film by spin coating, and the coating film was heated on a hot plate at 120° C. for 120 seconds. Thereafter, the coating film was irradiated with ultraviolet rays having a wavelength of 365 nm at an irradiation amount of 500 mJ/cm² using a high-pressure mercury lamp in a nitrogen atmosphere, whereby the alignment of the liquid crystal compound was fixed to form a cholesteric liquid crystal layer G1 (reflective type liquid crystal diffraction element G1).

It was confirmed using a polarization microscope that the cholesteric liquid crystal layer G1 had a periodic alignment pattern as shown in FIG. 9. In a case where a cross section of the coating layer was observed with a SEM, in the liquid crystal alignment pattern of the cholesteric liquid crystal layer G1, regarding the single period Λ over which the optical axis of the liquid crystal compound rotated by 180°, a single period of a portion at a distance of 4 mm from the center was 1.74 μm; a single period of a portion at a distance of 15 mm from the center was 0.64 μm; a single period of a portion at a distance of 18 mm from the center was 0.59 μm; and the single period decreased toward the outer direction. In addition, a length of one helical pitch (helical pitch P) in the cholesteric liquid crystal layer was 328 nm at any position in a plane.

### <Production of Optical Unit>

### <<Formation of Half Mirror 1

Aluminum was vapor-deposited on a surface side of the glass substrate having the antireflection layer opposite to the antireflection layer to form a half mirror 1 having a reflectivity of 40%.

The cholesteric liquid crystal layer produced as described above was disposed to face the half mirror 1. The aluminum vapor-deposited surface of the half mirror 1 was disposed on a side facing the cholesteric liquid crystal layer G1. In addition, an optical unit 1 was produced such that the cholesteric liquid crystal layer G1 and the half mirror 1 were arranged in this order, and a distance between the cholesteric liquid crystal layer G1 and the aluminum vapor-deposited surface was 3 mm. An antireflection film was bonded to a surface of the support opposite to the surface on which the cholesteric liquid crystal layer G1 was formed.

### Example 1

### <Production of Reflective Type Liquid Crystal Diffraction Element>

### (Formation of Alignment Film)

An alignment film P-G1 was formed in the same manner as in Comparative Example 1.

### (Formation of Cholesteric Liquid Crystal Layer)

As a liquid crystal composition forming a cholesteric liquid crystal layer G2, the following composition G-2 was prepared.

### Composition G-2

| | |
|---|---|
| Liquid crystal compound L-1 | 100.00 parts by mass |
| Chiral agent C1 | 6.0 parts by mass |
| Chiral agent C3 | 1.0 part by mass |
| Polymerization initiator I-1 | 3.00 parts by mass |
| Surfactant F1 | 0.02 parts by mass |
| Surfactant F2 | 0.20 parts by mass |
| Methyl ethyl ketone | 120.58 parts by mass |
| Cyclopentanone | 80.38 parts by mass |

Chiral agent C3

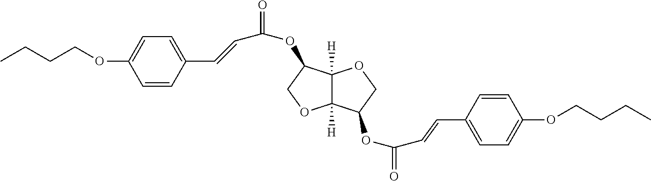 [SMILES: CCCCOc1ccc(/C=C/C(=O)O[C@@H]2CO[C@H]3[C@@H]2OC[C@H]3OC(=O)/C=C/c2ccc(OCCCC)cc2)cc1]

The cholesteric liquid crystal layer G2 was formed by applying the composition G-2 onto a photo-alignment film. Specifically, the composition G-2 was applied onto the photo-alignment film by spin coating, and the coating film was heated on a hot plate at 120° C. for 120 seconds, and then irradiated with ultraviolet rays having a wavelength of 365 nm using an LED-UV exposure machine. At this time, the coating film was irradiated while changing the irradiation amount of ultraviolet rays in a plane. Specifically, the coating film was irradiated by changing the irradiation amount in the plane such that the irradiation amount decreased from the center portion toward the end part. Thereafter, the coating film heated on a hot plate at 120° C., and then irradiated with ultraviolet rays having a wavelength of 365 nm at an irradiation amount of 500 mJ/cm² using a high-pressure mercury lamp in a nitrogen atmosphere, whereby the alignment of the liquid crystal compound was fixed to form a cholesteric liquid crystal layer G2 (reflective type liquid crystal diffraction element G2).

It was confirmed using a polarization microscope that the cholesteric liquid crystal layer G2 had a periodic alignment pattern as shown in FIG. 9. In a case where a cross section of the coating layer was observed with a SEM, in the liquid crystal alignment pattern of the cholesteric liquid crystal layer G2, regarding the single period Λ over which the optical axis of the liquid crystal compound rotated by 180°, a single period of a portion at a distance of 4 mm from the center was 1.74 μm; a single period of a portion at a distance of 15 mm from the center was 0.64 μm; a single period of a portion at a distance of 18 mm from the center was 0.59 μm; and the single period decreased toward the outer direction. In addition, regarding a length of one helical pitch (helical pitch P) in the cholesteric liquid crystal layer, a helical pitch at the distance of 4 mm from the center was 328 nm, a helical pitch at the distance of 15 mm from the center was 339 nm, and a helical pitch at the distance of 18 mm from the center was 341 nm.

### <Production of Optical Unit>

An optical unit 2 was produced in the same manner as in the production of the optical unit 1 in Comparative Example 1, except that the cholesteric liquid crystal layer G2 was used instead of the cholesteric liquid crystal layer G1.

### <Production of Circularly Polarizing Plate>

### <<Production of λ/4 Plate 1>>

### (Production of Positive A-Plate 1)

A cellulose acylate film “Z-TAC”, including an alignment film and an optically anisotropic layer (positive A-plate 1), was obtained using the same method as a positive A-plate described in paragraphs [0102] to [0126] of JP2019-215416A.

The optically anisotropic layer was a positive A-plate (phase difference plate) having reverse wavelength dispersibility, and a thickness of the positive A-plate was controlled such that Re(550) was set to 138 nm.

### (Production of Positive C-Plate 1)

A coating film was formed by applying the following composition QC-1 onto the positive A-plate produced as described above. The coating film was heated using a hot plate at 70° C., cooled to 65° C., and then irradiated with ultraviolet rays having a wavelength of 365 nm at an irradiation amount of 500 mJ/cm² using a high-pressure mercury lamp in a nitrogen atmosphere, whereby the alignment of the liquid crystal compound was fixed to form a positive C-plate 1. In this manner, a λ/4 plate 1 having the positive A-plate 1 and the positive C-plate 1 was obtained.

The obtained positive C-plate 1 had a thickness direction retardation Rth (550) of −69 nm.

### Composition QC-1

| | |
|---|---|
| Liquid crystal compound L-1 | 34.00 parts by mass |
| Liquid crystal compound L-3 | 44.00 parts by mass |
| Liquid crystal compound L-4 | 22.00 parts by mass |
| Polymerization initiator PI-1 | 1.50 parts by mass |
| Surfactant T-2 | 0.40 parts by mass |
| Surfactant T-3 | 0.20 parts by mass |
| Compound S-1 | 0.50 parts by mass |
| Compound M-1 | 14.00 parts by mass |
| Methyl ethyl ketone | 248.00 parts by mass |

Liquid crystal compound L-3 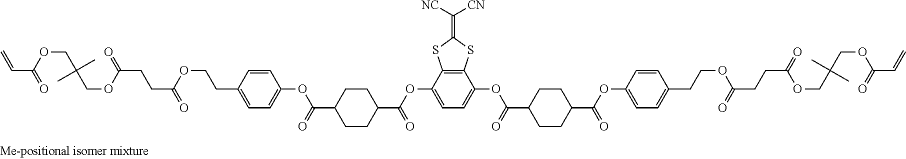 [SMILES: C=CC(=O)OCC(C)(C)COC(=O)CCC(=O)OCCc1ccc(OC(=O)C2CCC(C(=O)Oc3ccc(OC(=O)C4CCC(C(=O)Oc5ccc(CCOC(=O)CCC(=O)OCC(C)(C)COC(=O)C=C)cc5)CC4)c4c3SC(=C(C#N)C#N)S4)CC2)cc1]
Liquid crystal compound L-4 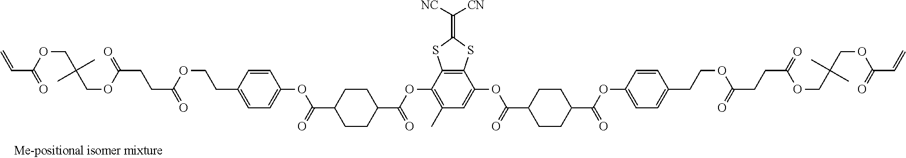 [SMILES: C=CC(=O)OCC(C)(C)COC(=O)CCC(=O)OCCc1ccc(OC(=O)C2CCC(C(=O)Oc3cc(C)c(OC(=O)C4CCC(C(=O)Oc5ccc(CCOC(=O)CCC(=O)OCC(C)(C)COC(=O)C=C)cc5)CC4)c4c3SC(=C(C#N)C#N)S4)CC2)cc1]
Surfactant T-2 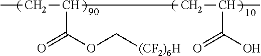
Surfactant T-3 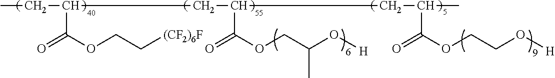
Compound S-1 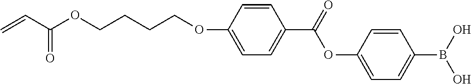 [SMILES: C=CC(=O)OCCCCOc1ccc(C(=O)Oc2ccc(B(O)O)cc2)cc1]
Compound M-1

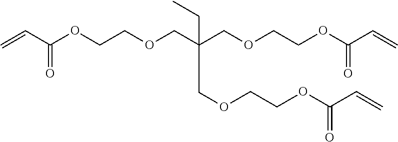 [SMILES: C=CC(=O)OCCOCC(CC)(COCCOC(=O)C=C)COCCOC(=O)C=C]

### <<Production of Linear Polarizer>>

### (Production of Cellulose Acylate Film 1)

### (Production of Core Layer Cellulose Acylate Dope)

The following composition was put into a mixing tank and stirred to dissolve each component, thereby preparing a cellulose acetate solution used as a core layer cellulose acylate dope.

### Core Layer Cellulose Acylate Dope

| | |
|---|---|
| Cellulose acetate having acetyl substitution degree of 2.88 | 100 parts by mass |
| Polyester compound B described in Examples of JP2015-227955A | 12 parts by mass |
| Compound F shown below | 2 parts by mass |
| Methylene chloride (first solvent) | 430 parts by mass |
| Methanol (second solvent) | 64 parts by mass |

Compound F

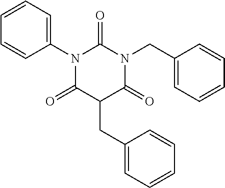 [SMILES: O=C1C(Cc2ccccc2)C(=O)N(c2ccccc2)C(=O)N1Cc1ccccc1]

### (Production of Outer Layer Cellulose Acylate Dope)

10 parts by mass of the following matting agent solution was added to 90 parts by mass of the above-described core layer cellulose acylate dope to prepare a cellulose acetate solution used as an outer layer cellulose acylate dope.

### Matting Agent Solution

| | | |
|---|---|---|
| Silica particles having an average particle | 2 | parts by mass |
| diameter of 20 nm (AEROSIL R972, manufactured | | |
| by Nippon Aerosil Co., Ltd.) | | |
| Methylene chloride (first solvent) | 76 | parts by mass |
| Methanol (second solvent) | 11 | parts by mass |
| Core layer cellulose acylate dope described above | 1 | part by mass |

### (Production of Cellulose Acylate Film 1)

The core layer cellulose acylate dope and the outer layer cellulose acylate dope were filtered through filter paper having an average hole diameter of 34 μm and a sintered metal filter having an average pore size of 10 μm, and three layers which were the core layer cellulose acylate dope and the outer layer cellulose acylate dopes provided on both sides of the core layer cellulose acylate dope were simultaneously cast from a casting port onto a drum at 20° C. (band casting machine).

Next, the film was peeled off in a state where the solvent content was approximately 20% by mass, both ends of the film in the width direction were fixed by tenter clips, and the film was dried while being stretched at a stretching ratio of 1.1 times in the lateral direction.

Thereafter, the film was further dried by being transported between the rolls of the heat treatment device to produce an optical film having a thickness of 40 μm, and the optical film was used as a cellulose acylate film 1. The in-plane retardation of the obtained cellulose acylate film 1 was 0 nm.

### (Formation of Photo-Alignment Layer PA1)

The cellulose acylate film 1 was continuously coated with the following coating liquid S-PA-1 for forming an alignment layer with a wire bar. The support on which the coating film was formed was dried with hot air at 140° C. for 120 seconds, and the coating film was irradiated with polarized ultraviolet rays (10 mJ/cm², using an ultra-high pressure mercury lamp) to form a photo-alignment layer PAL. A film thickness thereof was 0.3 μm.

### Coating Liquid S-PA-1 for Forming Alignment Layer

| | |
|---|---|
| Polymer M-PA-1 shown below | 100.00 parts by mass |
| Acid generator PAG-1 shown below | 5.00 parts by mass |
| Acid generator CPI-110TF shown below | 0.005 parts by mass |
| Xylene | 1220.00 parts by mass |
| Methyl isobutyl ketone | 122.00 parts by mass |

Polymer M-PA-1 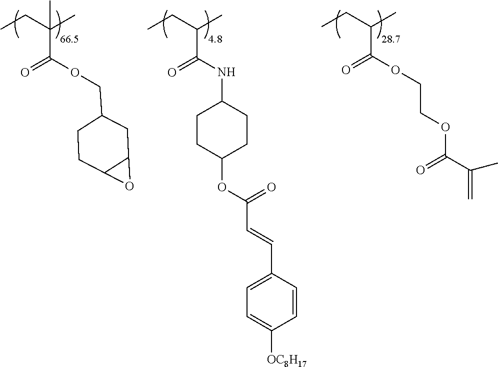
Acid generator PAG-1 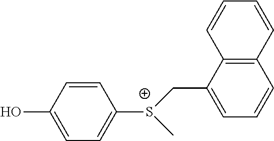 [SMILES: C[S+](Cc1cccc2ccccc12)c1ccc(O)cc1] 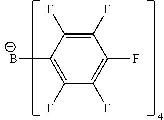
Acid generator CPI-110TF

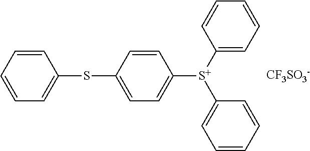

### (Formation of Light Absorption Anisotropic Layer P1)

The obtained alignment layer PA1 was continuously coated with the following coating liquid S-P-1 for forming a light absorption anisotropic layer with a wire bar. Next, the coating layer P1 was heated at 140° C. for 30 seconds and cooled to room temperature (23° C.). Next, the coating layer P1 was heated at 90° C. for 60 seconds and cooled to room temperature again. Thereafter, the coating layer P1 was irradiated with an LED lamp (central wavelength of 365 nm) for 2 seconds under an irradiation condition of an illuminance of 200 mW/cm², thereby forming a light absorption anisotropic layer P1 on the alignment layer PA1. A film thickness thereof was 1.6 μm.

### Composition of Coating Liquid S-P-1 for Forming Light Absorption Anisotropic Layer

| | |
|---|---|
| Dichroic substance D-1 shown below | 0.25 parts by mass |
| Dichroic substance D-2 shown below | 0.36 parts by mass |
| Dichroic substance D-3 shown below | 0.59 parts by mass |
| High-molecular-weight liquid crystal compound M-P-1 shown below | 2.21 parts by mass |
| Low-molecular-weight liquid crystal compound M-1 shown below | 1.36 parts by mass |
| Polymerization initiator: IRGACURE OXE-02 (manufactured by BASF) | 0.200 parts by mass |
| Surfactant FP-1 shown below | 0.026 parts by mass |
| Cyclopentanone | 46.00 parts by mass |
| Tetrahydrofuran | 46.00 parts by mass |
| Benzyl alcohol | 3.00 parts by mass |

Dichroic substance D-1 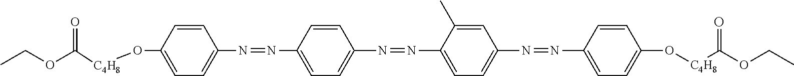
Dichroic substance D-2 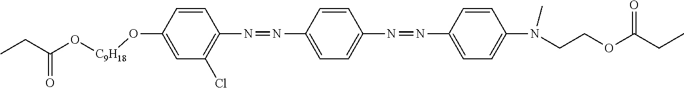
Dichroic substance D-3 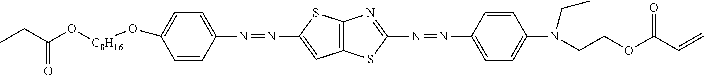
High-molecular-weight liquid crystal compound M-P-1 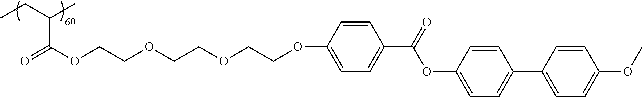 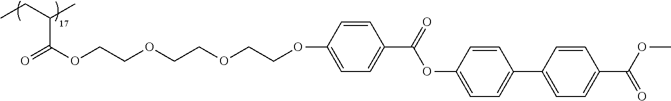 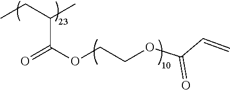
Low-molecular-weight liquid crystal compound M-1 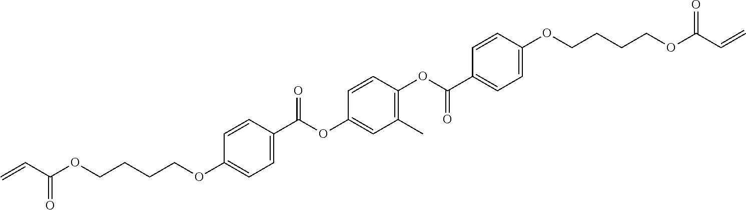 [SMILES: C=CC(=O)OCCCCOc1ccc(C(=O)Oc2ccc(OC(=O)c3ccc(OCCCCOC(=O)C=C)cc3)c(C)c2)cc1]
Surfactant FP-1

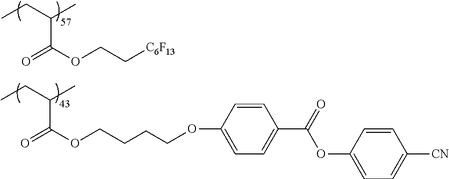

The produced λ/4 plate 1 and the linear polarizer were laminated to obtain a circularly polarizing plate 1. In this case, the λ/4 plate 1 and the light absorption anisotropic layer P1 were laminated such that the slow axis of the λ/4 plate 1 and the absorption axis of the light absorption anisotropic layer P1 formed an angle of 45°.

### [Evaluation]

The circularly polarizing plate 1 and the optical unit produced as described above were arranged to face each other, and evaluation was performed. The circularly polarizing plate 1 and the optical unit were arranged in the order of the linear polarizer and the λ/4 plate 1 of the circularly polarizing plate 1, and the reflective type liquid crystal diffraction element and the half mirror of the optical unit. In addition, the evaluation was performed by disposing the linear polarizer of the circularly polarizing plate 1 and the half mirror of the optical unit such that the distance therebetween was 12 mm and allowing light to be incident from the side of the linear polarizer.

In a case where light was incident into the circularly polarizing plate, intensity of light emitted from the optical unit was evaluated. The in-plane position of each element was set to 0 mm in the plane of each element at the intersection of the normal direction and each element (the linear polarizer, the λ/4 plate, the half mirror, and the like) from the center of the concentric circle of the liquid crystal diffraction element, and was represented as a radial distance. In addition, the incidence angle was represented as an angle with respect to a perpendicular line, in which a direction perpendicular to the main surface of the circularly polarizing plate 1 was set to 0°.

At a position of 3 mm in the circularly polarizing plate 1, a laser (wavelength: 532 nm) was incident at an incidence angle of −2.7°, a photodetector was disposed at a position 12 mm away from the optical unit in the laminating direction, and the intensity of light emitted from the optical unit was measured. Similarly, at a position of 13 mm in the circularly polarizing plate 1 and at a position of 16 mm in the circularly polarizing plate 1, the intensity of light emitted from the optical unit was measured in a case where a laser (wavelength: 532 nm) was incident at an incidence angle of −7.4° and an incidence angle of −8°, respectively. At a position of 3 mm in the circularly polarizing plate 1, light in which a laser (wavelength: 532 nm) was incident at an incidence angle of −2.7° was emitted from the optical unit at a position of 4 mm and an emission angle of 15°. In addition, at a position of 13 mm in the circularly polarizing plate 1, light in which a laser (wavelength: 532 nm) was incident at an incidence angle of −7.4° was emitted from the optical unit at a position of 15 mm and an emission angle of 45°, and light incident at an incidence angle of −8° at a position of 16 mm was emitted from the optical unit at a position of 18 mm and an emission angle of 50°.

In a case where light was incident on the circularly polarizing plate from the position of 3 mm, the amounts of light emitted from the optical unit 1 produced in Comparative Example 1 and the optical unit 2 produced in Example 1 were substantially the same. On the other hand, in a case where light was incident on the circularly polarizing plate from the position of 13 mm and the position of 16 mm, the amount of light emitted from the optical unit 2 of Example 1 was increased with respect to the optical unit 1 of Comparative Example 1.

### <Production of Virtual Reality Display Device>

A virtual reality display device “Huawei VR Glass” manufactured by Huawei Technologies Co., Ltd., which was a virtual reality display device for which a reciprocating optical system was employed, was disassembled, and all composite lenses were taken out. The circularly polarizing plate 1 produced as described above was bonded to a display of “Huawei VR Glass” (laminated in the order of display and circularly polarizing plate 1 (linear polarizer and λ/4 plate 1)). Next, a virtual reality display device of Comparative Example 1 was produced by installing the optical unit 1 on the front surface (liquid crystal diffraction element was disposed on the circularly polarizing plate side). In this case, the linear polarizer of the circularly polarizing plate 1 and the half mirror of the optical unit were arranged such that the distance therebetween was 12 mm.

In addition, a virtual reality display device of Example 1 was produced in the same manner as in the production of the virtual reality display device of Comparative Example 1, except that the optical unit 1 was changed to the optical unit 2 produced in Example 1.

In the produced virtual reality display device, a green and black checker pattern was displayed on the image display panel, and distribution of the brightness of the display was visually evaluated. In the virtual reality display device of Comparative Example 1, green display of the peripheral portion was dark with respect to the center of the display image. On the other hand, in the virtual reality display device of Example 1, the brightness of green display in the peripheral portion was improved as compared with Comparative Example 1, and the distribution of the brightness of the display image (dependence on field of view) was improved.

### Comparative Example 2

### <Production of Optical Unit>

The cholesteric liquid crystal layer produced in Comparative Example 1 was disposed to face the half mirror 1. The aluminum vapor-deposited surface of the half mirror 1 was disposed on a side facing the cholesteric liquid crystal layer G1. In addition, an optical unit 3 was produced such that the half mirror 1 and the cholesteric liquid crystal layer G1 were arranged in this order, and a distance between the cholesteric liquid crystal layer G1 and the aluminum vapor-deposited surface was 2 mm. An antireflection film was bonded to a surface of the support opposite to the surface on which the cholesteric liquid crystal layer G1 was formed.

### Example 2

An optical unit 4 was produced in the same manner as in the production of the optical unit 3 in Comparative Example 2, except that the cholesteric liquid crystal layer G2 was used instead of the cholesteric liquid crystal layer G1.

### [Evaluation]

The circularly polarizing plate 1 and the optical unit produced as described above were arranged to face each other, and evaluation was performed. The circularly polarizing plate 1 and the optical unit were arranged in the order of the linear polarizer and the λ/4 plate 1 of the circularly polarizing plate 1, and the half mirror and the reflective type liquid crystal diffraction element of the optical unit. In addition, the evaluation was performed by disposing the linear polarizer of the circularly polarizing plate 1 and the reflective type liquid crystal diffraction element of the optical unit such that the distance therebetween was 15 mm and allowing light to be incident from the side of the linear polarizer.

In a case where light was incident into the circularly polarizing plate, intensity of light emitted from the optical unit was evaluated. The in-plane position of each element was set to 0 mm in the plane of each element at the intersection of the normal direction and each element (the linear polarizer, the λ/4 plate, the half mirror, and the like) from the center of the concentric circle of the liquid crystal diffraction element, and was represented as a radial distance. In addition, the incidence angle was represented as an angle with respect to a perpendicular line, in which a direction perpendicular to the main surface of the circularly polarizing plate 1 was set to 0°.

At a position of 3 mm in the circularly polarizing plate 1, a laser (wavelength: 532 nm) was incident at an incidence angle of −2.7°, a photodetector was disposed at a position 11 mm away from the optical unit in the laminating direction, and the intensity of light emitted from the optical unit was measured. Similarly, at a position of 13 mm in the circularly polarizing plate 1 and at a position of 16 mm in the circularly polarizing plate 1, the intensity of light emitted from the optical unit was measured in a case where a laser (wavelength: 532 nm) was incident at an incidence angle of −7.4° and an incidence angle of −8°, respectively. At a position of 3 mm in the circularly polarizing plate 1, light in which a laser (wavelength: 532 nm) was incident at an incidence angle of −2.7° was emitted from the optical unit at a position of 4 mm and an emission angle of 15°. In addition, at a position of 13 mm in the circularly polarizing plate 1, light in which a laser (wavelength: 532 nm) was incident at an incidence angle of −7.4° was emitted from the optical unit at a position of 15 mm and an emission angle of 45°, and light incident at an incidence angle of −8° at a position of 16 mm was emitted from the optical unit at a position of 18 mm and an emission angle of 50°.

In a case where light was incident on the circularly polarizing plate from the position of 3 mm, the amounts of light emitted from the optical unit 3 produced in Comparative Example 2 and the optical unit 4 produced in Example 2 were substantially the same. On the other hand, in a case where light was incident on the circularly polarizing plate from the position of 13 mm and the position of 16 mm, the amount of light emitted from the optical unit 4 of Example 2 was increased with respect to the optical unit 3 of Comparative Example 2.

### <Production of Virtual Reality Display Device>

A virtual reality display device of Comparative Example 2 was produced in the same manner as in the production of the virtual reality display device of Comparative Example 1, except that the optical unit 1 was changed to the optical unit 3 produced in Comparative Example 2. The half mirror was disposed on the circularly polarizing plate side such that the distance between the linear polarizer and the liquid crystal diffraction element of the optical unit was 15 mm.

A virtual reality display device of Example 2 was produced using the optical unit 4 in the same manner.

In the produced virtual reality display device, a green and black checker pattern was displayed on the image display panel, and distribution of the brightness of the display was visually evaluated. In the virtual reality display device of Comparative Example 2, green display of the peripheral portion was dark with respect to the center of the display image. On the other hand, in the virtual reality display device of Example 2, the brightness of green display in the peripheral portion was improved as compared with Comparative Example 2, and the distribution of the brightness of the display image (dependence on field of view) was improved.

### Comparative Example 3

### <Production of Reflective Type Liquid Crystal Diffraction Element>

A cholesteric liquid crystal layer G1 (reflective type liquid crystal diffraction element G1) was produced in the same manner as in Comparative Example 1.

### <Production of Reflective Type Volume Hologram>

### (Hologram Photosensitive Material)

A hologram photosensitive material “Litiholo C-RT20 (trade name)” available from Liti Holographic Co., Ltd. was used. The present material was a laminate consisting of base material (glass, thickness of 2 mm)/hologram material layer (thickness of 16 μm)/cover film (optically isotropic triacetyl cellulose film, thickness of 60 μm), and the hologram was recorded on the hologram material layer.

### (Recording of Hologram)

A red laser (trade name: Flamenco 05, wavelength: 660 nm, output: 500 mW) manufactured by Cobolt, a green laser (trade name: Samba 05, wavelength: 532 nm, output: 1500 mW) manufactured by Cobolt, and a blue laser (trade name: Genesis CX, wavelength: 460 nm, output: 2000 mW) manufactured by Coherent were installed on a flat plate to manufacture an exposure device conceptually shown in FIG. 21. In FIG. 21, reference numerals 101a, 101b, and 101c denote laser light sources; reference numerals 102a, 102b, and 102c denote dichroic mirrors; reference numeral 103 denotes a polarization beam splitter; reference numeral 104 denotes a plane mirror; reference numeral 105 denotes a beam expander; reference numeral 106 denotes a first aspherical lens; reference numeral 107 denotes a second aspherical lens; reference numeral 108 denotes a hologram photosensitive material; reference numeral 109 denotes a focal point of the first aspherical lens; reference numeral 110 denotes a hologram lens; reference numeral 111 denotes a first luminous flux; and reference numeral 112 denotes a second luminous flux. In addition, polarization states of the first luminous flux 111 and the second luminous flux 112 were adjusted using a wave plate and a polarizing plate (not shown) such that the first luminous flux 111 and the second luminous flux 112 were in the same polarization state.

Before the actual recording, interference exposure at each wavelength was performed using the exposure device, and a profile of the diffraction efficiency of the hologram material with respect to the irradiation energy for each exposure wavelength was measured. Thereafter, the illuminance of the luminous flux from each light source was adjusted in advance using a filter (not shown) on the optical path from each light source such that the amount of expression of the diffraction efficiency of the hologram with respect to each wavelength was substantially the same.

In the exposure device in which the illuminance of light from each light source was adjusted, the above-described hologram photosensitive material 108 was set at a predetermined position, the position of the first aspherical lens was adjusted so that the distance from the hologram material layer to the focal point 109 of the first luminous flux was 100 mm, and then interference exposure with the first luminous flux 111 and the second luminous flux 112 was performed. The exposure amount and the exposure time were determined using a profile of the diffraction efficiency exhibited by the hologram material with respect to the exposure energy obtained in advance.

### (Post-Treatment)

The exposed hologram photosensitive material was exposed with an exposure amount of 1,000 mJ/cm² using a UV-LED plane light source through a diffusion film. In this way, a reflective type volume hologram lens 1 was produced.

### <Production of Optical Unit>

The cholesteric liquid crystal layer G1 was disposed to face the volume hologram lens 1. A surface on which the volume hologram lens 1 was formed and the cholesteric liquid crystal layer G1 were disposed to face each other. In addition, an optical unit 5 was produced such that the cholesteric liquid crystal layer G1 and the volume hologram lens 1 were arranged in this order, and a distance between the cholesteric liquid crystal layer G1 and the volume hologram lens 1 was 3 mm. An antireflection film was bonded to a surface of the support opposite to the surface on which the cholesteric liquid crystal layer G1 was formed. In the same manner, an antireflection film was bonded to a surface of the base material opposite to the volume hologram lens 1.

### Example 3

An optical unit 6 was produced in the same manner as in Comparative Example 3, except that the cholesteric liquid crystal layer G1 was changed to the cholesteric liquid crystal layer G2 produced in Example 1.

### [Evaluation]

The circularly polarizing plate 1 and the optical unit produced as described above were arranged to face each other, and evaluation was performed. The circularly polarizing plate 1 and the optical unit were arranged in the order of the linear polarizer and the λ/4 plate 1 of the circularly polarizing plate 1, and the reflective type liquid crystal diffraction element and the volume hologram of the optical unit. In addition, the evaluation was performed by disposing the linear polarizer of the circularly polarizing plate 1 and the volume hologram of the optical unit such that the distance therebetween was 12 mm and allowing light to be incident from the side of the linear polarizer.

In a case where light was incident into the circularly polarizing plate, intensity of light emitted from the optical unit was evaluated. The in-plane position of each element was set to 0 mm in the plane of each element at the intersection of the normal direction and each element (the linear polarizer, the λ/4 plate, the volume hologram, and the like) from the center of the concentric circle of the liquid crystal diffraction element, and was represented as a radial distance. In addition, the incidence angle was represented as an angle with respect to a perpendicular line, in which a direction perpendicular to the main surface of the circularly polarizing plate 1 was set to 0°.

At a position of 3 mm in the circularly polarizing plate 1, a laser (wavelength: 532 nm) was incident at an incidence angle of −2.7°, a photodetector was disposed at a position 12 mm away from the optical unit in the laminating direction, and the intensity of light emitted from the optical unit was measured. Similarly, at a position of 13 mm in the circularly polarizing plate 1 and at a position of 16 mm in the circularly polarizing plate 1, the intensity of light emitted from the optical unit was measured in a case where a laser (wavelength: 532 nm) was incident at an incidence angle of −7.4° and an incidence angle of −8°, respectively. At a position of 3 mm in the circularly polarizing plate 1, light in which a laser (wavelength: 532 nm) was incident at an incidence angle of −2.7° was emitted from the optical unit at a position of 4 mm and an emission angle of 17°. In addition, at a position of 13 mm in the circularly polarizing plate 1, light in which a laser (wavelength: 532 nm) was incident at an incidence angle of −7.4° was emitted from the optical unit at a position of 15 mm and an emission angle of 50°, and light incident at an incidence angle of −8° at a position of 16 mm was emitted from the optical unit at a position of 18 mm and an emission angle of 55°.

In a case where light was incident on the circularly polarizing plate from the position of 3 mm, the amounts of light emitted from the optical unit 5 produced in Comparative Example 3 and the optical unit 6 produced in Example 3 were substantially the same. On the other hand, in a case where light was incident on the circularly polarizing plate from the position of 13 mm and the position of 16 mm, the amount of light emitted from the optical unit 6 of Example 3 was increased with respect to the optical unit 5 of Comparative Example 3.

### <Production of Virtual Reality Display Device>

A virtual reality display device of Comparative Example 3 was produced in the same manner as in the production of the virtual reality display device of Comparative Example 1, except that the optical unit 1 was changed to the optical unit 5 produced in Comparative Example 3. The liquid crystal diffraction element was disposed on the circularly polarizing plate side such that the distance between the linear polarizer and the volume hologram of the optical unit was 12 mm.

A virtual reality display device of Example 3 was produced using the optical unit 6 in the same manner.

In the produced virtual reality display device, a green and black checker pattern was displayed on the image display panel, and distribution of the brightness of the display was visually evaluated. In the virtual reality display device of Comparative Example 3, green display of the peripheral portion was dark with respect to the center of the display image. On the other hand, in the virtual reality display device of Example 3, the brightness of green display in the peripheral portion was improved as compared with Comparative Example 3, and the distribution of the brightness of the display image (dependence on field of view) was improved.

### Comparative Example 4

### <Production of Optical Unit>

An optical unit 7 was produced in the same manner as in Comparative Example 3, except that the cholesteric liquid crystal layer G1 and the volume hologram lens 1 were arranged in the order of the volume hologram lens 1 and the cholesteric liquid crystal layer G1.

### Example 4

### <Production of Optical Unit>

An optical unit 8 was produced in the same manner as in Example 3, except that the cholesteric liquid crystal layer G2 and the volume hologram lens 1 were arranged in the order of the volume hologram lens 1 and the cholesteric liquid crystal layer G2.

### [Evaluation]

The circularly polarizing plate 1 and the optical unit produced as described above were arranged to face each other, and evaluation was performed. The circularly polarizing plate 1 and the optical unit were arranged in the order of the linear polarizer and the λ/4 plate 1 of the circularly polarizing plate 1, and the volume hologram and the reflective type liquid crystal diffraction element of the optical unit. In addition, the evaluation was performed by disposing the linear polarizer of the circularly polarizing plate 1 and the reflective type liquid crystal diffraction element of the optical unit such that the distance therebetween was 15 mm and allowing light to be incident from the side of the linear polarizer.

In a case where light was incident into the circularly polarizing plate, intensity of light emitted from the optical unit was evaluated. The in-plane position of each element was set to 0 mm in the plane of each element at the intersection of the normal direction and each element (the linear polarizer, the λ/4 plate, the volume hologram, and the like) from the center of the concentric circle of the liquid crystal diffraction element, and was represented as a radial distance. In addition, the incidence angle was represented as an angle with respect to a perpendicular line, in which a direction perpendicular to the main surface of the circularly polarizing plate 1 was set to 0°.

At a position of 3 mm in the circularly polarizing plate 1, a laser (wavelength: 532 nm) was incident at an incidence angle of −2.7°, a photodetector was disposed at a position 11 mm away from the optical unit in the laminating direction, and the intensity of light emitted from the optical unit was measured. Similarly, at a position of 13 mm in the circularly polarizing plate 1 and at a position of 16 mm in the circularly polarizing plate 1, the intensity of light emitted from the optical unit was measured in a case where a laser (wavelength: 532 nm) was incident at an incidence angle of −7.4° and an incidence angle of −8°, respectively. At a position of 3 mm in the circularly polarizing plate 1, light in which a laser (wavelength: 532 nm) was incident at an incidence angle of −2.7° was emitted from the optical unit at a position of 4 mm and an emission angle of 17°. In addition, at a position of 13 mm in the circularly polarizing plate 1, light in which a laser (wavelength: 532 nm) was incident at an incidence angle of −7.4° was emitted from the optical unit at a position of 15 mm and an emission angle of 50°, and light incident at an incidence angle of −8° at a position of 16 mm was emitted from the optical unit at a position of 18 mm and an emission angle of 55°.

In a case where light was incident on the circularly polarizing plate from the position of 3 mm, the amounts of light emitted from the optical unit 7 produced in Comparative Example 4 and the optical unit 8 produced in Example 4 were substantially the same. On the other hand, in a case where light was incident on the circularly polarizing plate from the position of 13 mm and the position of 16 mm, the amount of light emitted from the optical unit 8 of Example 4 was increased with respect to the optical unit 7 of Comparative Example 4.

### <Production of Virtual Reality Display Device>

A virtual reality display device of Comparative Example 4 was produced in the same manner as in the production of the virtual reality display device of Comparative Example 1, except that the optical unit 1 was changed to the optical unit 7 produced in Comparative Example 4. The volume hologram was disposed on the circularly polarizing plate side such that the distance between the linear polarizer and the liquid crystal diffraction element of the optical unit was 15 mm.

A virtual reality display device of Example 4 was produced using the optical unit 8 in the same manner.

In the produced virtual reality display device, a green and black checker pattern was displayed on the image display panel, and distribution of the brightness of the display was visually evaluated. In the virtual reality display device of Comparative Example 4, green display of the peripheral portion was dark with respect to the center of the display image. On the other hand, in the virtual reality display device of Example 4, the brightness of green display in the peripheral portion was improved as compared with Comparative Example 4, and the distribution of the brightness of the display image (dependence on field of view) was improved.

### Example 5

### <Formation of Half Mirror>

The glass substrate was subjected to aluminum vapor deposition so that the reflectivity was 40%, thereby forming a half mirror 2.

### <Production of Half Mirror Laminate 1>

The circularly polarizing plate 1 and an antireflection film were bonded in this order to a surface of the half mirror 2 opposite to the aluminum vapor-deposited surface. In the circularly polarizing plate 1, the half mirror 2, the λ/4 plate 1, and the linear polarizer were laminated in this order, and an antireflection film was bonded to a surface of the linear polarizer to produce a half mirror laminate 1.

### <Production of Optical Unit>

In the production of the optical unit 2 of Example 1, the half mirror laminate 1 was used instead of the half mirror 1, and the reflective type liquid crystal diffraction element G2 and the half mirror laminate 1 (half mirror 2, λ/4 plate 1, and linear polarizer) were arranged in this order. An optical unit 9 was produced such that the distance between the reflective type liquid crystal diffraction element and the aluminum vapor-deposited surface was 3 mm. An antireflection film was bonded to a surface opposite to the surface on which the cholesteric liquid crystal layer G2 was formed.

### [Evaluation]

The circularly polarizing plate 1 and the optical unit 9 produced as described above were arranged to face each other, and evaluation was performed. The circularly polarizing plate 1 and the optical unit were arranged in the order of the linear polarizer and the λ/4 plate 1 of the circularly polarizing plate 1, and the reflective type liquid crystal diffraction element 2, the half mirror 2, the λ/4 plate 1, and the linear polarizer of the optical unit. In addition, the evaluation was performed by disposing the linear polarizer of the circularly polarizing plate 1 and the half mirror of the optical unit such that the distance therebetween was 12 mm and allowing light to be incident from the linear polarizer side of the circularly polarizing plate 1.

In a case where light was incident into the circularly polarizing plate, intensity of light emitted from the optical unit was evaluated. The in-plane position of each element was set to 0 mm in the plane of each element at the intersection of the normal direction and each element (the linear polarizer, the λ/4 plate, the half mirror, and the like) from the center of the concentric circle of the liquid crystal diffraction element, and was represented as a radial distance. In addition, the incidence angle was represented as an angle with respect to a perpendicular line, in which a direction perpendicular to the main surface of the circularly polarizing plate 1 was set to 0°.

At a position of 3 mm in the circularly polarizing plate 1, a laser (wavelength: 532 nm) was incident at an incidence angle of −2.7°, a photodetector was disposed at a position 12 mm away from the optical unit in the laminating direction, and the intensity of light emitted from the optical unit was measured. Similarly, at a position of 13 mm in the circularly polarizing plate 1 and at a position of 16 mm in the circularly polarizing plate 1, the intensity of light emitted from the optical unit was measured in a case where a laser (wavelength: 532 nm) was incident at an incidence angle of −7.4° and an incidence angle of −8°, respectively. At a position of 3 mm in the circularly polarizing plate 1, light in which a laser (wavelength: 532 nm) was incident at an incidence angle of −2.7° was emitted from the optical unit at a position of 4 mm and an emission angle of 15°. In addition, at a position of 13 mm in the circularly polarizing plate 1, light in which a laser (wavelength: 532 nm) was incident at an incidence angle of −7.4° was emitted from the optical unit at a position of 15 mm and an emission angle of 45°, and light incident at an incidence angle of −8° at a position of 16 mm was emitted from the optical unit at a position of 18 mm and an emission angle of 50°.

In a case where light was incident on the circularly polarizing plate from the position of 3 mm, the amounts of light emitted from the optical unit 1 produced in Comparative Example 1 and the optical unit 9 produced in Example 5 were substantially the same. On the other hand, in a case where light was incident on the circularly polarizing plate from the position of 13 mm and the position of 16 mm, the amount of light emitted from the optical unit 9 of Example 5 was increased with respect to the optical unit 1 of Comparative Example 1.

### <Production of Virtual Reality Display Device>

A virtual reality display device of Example 5 was produced in the same manner as in the production of the virtual reality display device of Comparative Example 1, except that the optical unit 1 was changed to the optical unit 9 produced in Example 5.

In the produced virtual reality display device, a green and black checker pattern was displayed on the image display panel, and distribution of the brightness of the display was visually evaluated. In the virtual reality display device of Comparative Example 1, green display of the peripheral portion was dark with respect to the center of the display image. On the other hand, in the virtual reality display device of Example 5, the brightness of green display in the peripheral portion was improved as compared with Comparative Example 1, and the distribution of the brightness of the display image (dependence on field of view) was improved.

In addition, in the produced virtual reality display device, a green and black checker pattern was displayed on the image display panel, and visibility of ghost was visually evaluated. In the virtual reality display device of Example 1, a slight ghost image was visually recognized, but in the virtual reality display device of Example 5, the ghost image was reduced and the visibility of ghost was improved.

### Example 6

### <Production of Laminate 1 of Reflective Type Liquid Crystal Diffraction Element>

The circularly polarizing plate 1 and an antireflection film were bonded in this order to a surface of the reflective type liquid crystal diffraction element G2 produced in Example 2, which was opposite to a surface on which the cholesteric liquid crystal layer was formed. In the circularly polarizing plate 1, the reflective type liquid crystal diffraction element, the λ/4 plate 1, and the linear polarizer were laminated in this order, and an antireflection film was bonded to a surface of the linear polarizer to produce a laminate 1 of the reflective type liquid crystal diffraction element.

### <Production of Optical Unit>

In the production of the optical unit 4 of Example 2, the laminate 1 of the reflective type liquid crystal diffraction element was used instead of the reflective type liquid crystal diffraction element G2, and the half mirror and the laminate 1 of the reflective type liquid crystal diffraction element (reflective type liquid crystal diffraction element G2, circularly polarizing plate 1, and antireflection film) were arranged in this order. An optical unit 10 was produced such that the distance between the reflective type liquid crystal diffraction element and the aluminum vapor-deposited surface was 2 mm.

### [Evaluation]

The circularly polarizing plate 1 and the optical unit 10 produced as described above were arranged to face each other, and evaluation was performed. The circularly polarizing plate 1 and the optical unit were arranged in the order of the linear polarizer and the λ/4 plate 1 of the circularly polarizing plate 1, and the half mirror, the reflective type liquid crystal diffraction element, the λ/4 plate 1, and the linear polarizer of the optical unit. In addition, the evaluation was performed by disposing the linear polarizer of the circularly polarizing plate 1 and the reflective type liquid crystal diffraction element of the optical unit such that the distance therebetween was 15 mm and allowing light to be incident from the side of the linear polarizer.

In a case where light was incident into the circularly polarizing plate, intensity of light emitted from the optical unit was evaluated. The in-plane position of each element was set to 0 mm in the plane of each element at the intersection of the normal direction and each element (the linear polarizer, the λ/4 plate, the half mirror, and the like) from the center of the concentric circle of the liquid crystal diffraction element, and was represented as a radial distance. In addition, the incidence angle was represented as an angle with respect to a perpendicular line, in which a direction perpendicular to the main surface of the circularly polarizing plate 1 was set to 0°.

At a position of 3 mm in the circularly polarizing plate 1, a laser (wavelength: 532 nm) was incident at an incidence angle of −2.7°, a photodetector was disposed at a position 11 mm away from the optical unit in the laminating direction, and the intensity of light emitted from the optical unit was measured. Similarly, at a position of 13 mm in the circularly polarizing plate 1 and at a position of 16 mm in the circularly polarizing plate 1, the intensity of light emitted from the optical unit was measured in a case where a laser (wavelength: 532 nm) was incident at an incidence angle of −7.4° and an incidence angle of −8°, respectively. At a position of 3 mm in the circularly polarizing plate 1, light in which a laser (wavelength: 532 nm) was incident at an incidence angle of −2.7° was emitted from the optical unit at a position of 4 mm and an emission angle of 15°. In addition, at a position of 13 mm in the circularly polarizing plate 1, light in which a laser (wavelength: 532 nm) was incident at an incidence angle of −7.4° was emitted from the optical unit at a position of 15 mm and an emission angle of 45°, and light incident at an incidence angle of −8° at a position of 16 mm was emitted from the optical unit at a position of 18 mm and an emission angle of 50°.

In a case where light was incident on the circularly polarizing plate from the position of 3 mm, the amounts of light emitted from the optical unit 3 produced in Comparative Example 2 and the optical unit 10 produced in Example 6 were substantially the same. On the other hand, in a case where light was incident on the circularly polarizing plate from the position of 13 mm and the position of 16 mm, the amount of light emitted from the optical unit 10 of Example 6 was increased with respect to the optical unit 3 of Comparative Example 2.

### <Production of Virtual Reality Display Device>

A virtual reality display device of Example 6 was produced in the same manner as in the production of the virtual reality display device of Comparative Example 2, except that the optical unit 3 was changed to the optical unit 10 produced in Example 6.

In the produced virtual reality display device, a green and black checker pattern was displayed on the image display panel, and distribution of the brightness of the display was visually evaluated. In the virtual reality display device of Comparative Example 2, green display of the peripheral portion was dark with respect to the center of the display image. On the other hand, in the virtual reality display device of Example 6, the brightness of green display in the peripheral portion was improved as compared with Comparative Example 2, and the distribution of the brightness of the display image (dependence on field of view) was improved.

In addition, in the produced virtual reality display device, a green and black checker pattern was displayed on the image display panel, and visibility of ghost was visually evaluated. In the virtual reality display device of Example 2, a slight ghost image was visually recognized, but in the virtual reality display device of Example 6, the ghost image was reduced and the visibility of ghost was improved.

### Example 7

### <Production of Optical Unit>

An optical unit 11 was produced in the same manner as in the production of the optical unit 6 of Example 3, except that the λ/4 plate 1, the linear polarizer, and the antireflection film were bonded in this order to the surface of the volume hologram.

### [Evaluation]

The circularly polarizing plate 1 and the optical unit produced as described above were arranged to face each other, and evaluation was performed. The circularly polarizing plate 1 and the optical unit were arranged in the order of the linear polarizer and the λ/4 plate 1 of the circularly polarizing plate 1, and the reflective type liquid crystal diffraction element, the volume hologram, the λ/4 plate 1, and the linear polarizer of the optical unit. In addition, the evaluation was performed by disposing the linear polarizer of the circularly polarizing plate 1 and the volume hologram of the optical unit such that the distance therebetween was 12 mm and allowing light to be incident from the linear polarizer side of the circularly polarizing plate 1.

In a case where light was incident into the circularly polarizing plate, intensity of light emitted from the optical unit was evaluated. The in-plane position of each element was set to 0 mm in the plane of each element at the intersection of the normal direction and each element (the linear polarizer, the λ/4 plate, the half mirror, and the like) from the center of the concentric circle of the liquid crystal diffraction element, and was represented as a radial distance. In addition, the incidence angle was represented as an angle with respect to a perpendicular line, in which a direction perpendicular to the main surface of the circularly polarizing plate 1 was set to 0°.

At a position of 3 mm in the circularly polarizing plate 1, a laser (wavelength: 532 nm) was incident at an incidence angle of −2.7°, a photodetector was disposed at a position 12 mm away from the optical unit in the laminating direction, and the intensity of light emitted from the optical unit was measured. Similarly, at a position of 13 mm in the circularly polarizing plate 1 and at a position of 16 mm in the circularly polarizing plate 1, the intensity of light emitted from the optical unit was measured in a case where a laser (wavelength: 532 nm) was incident at an incidence angle of −7.4° and an incidence angle of −8°, respectively. At a position of 3 mm in the circularly polarizing plate 1, light in which a laser (wavelength: 532 nm) was incident at an incidence angle of −2.7° was emitted from the optical unit at a position of 4 mm and an emission angle of 17°. In addition, at a position of 13 mm in the circularly polarizing plate 1, light in which a laser (wavelength: 532 nm) was incident at an incidence angle of −7.4° was emitted from the optical unit at a position of 15 mm and an emission angle of 50°, and light incident at an incidence angle of −8° at a position of 16 mm was emitted from the optical unit at a position of 18 mm and an emission angle of 55°.

In a case where light was incident on the circularly polarizing plate from the position of 3 mm, the amounts of light emitted from the optical unit 5 produced in Comparative Example 3 and the optical unit 11 produced in Example 7 were substantially the same. On the other hand, in a case where light was incident on the circularly polarizing plate from the position of 13 mm and the position of 16 mm, the amount of light emitted from the optical unit 11 of Example 7 was increased with respect to the optical unit 5 of Comparative Example 3.

### <Production of Virtual Reality Display Device>

A virtual reality display device of Example 7 was produced in the same manner as in the production of the virtual reality display device of Comparative Example 1, except that the optical unit 1 was changed to the optical unit 11 produced in Example 7. The reflective type liquid crystal diffraction element was disposed on the circularly polarizing plate side such that the distance between the linear polarizer and the volume hologram of the optical unit was 12 mm.

In the produced virtual reality display device, a green and black checker pattern was displayed on the image display panel, and distribution of the brightness of the display was visually evaluated. In the virtual reality display device of Comparative Example 3, green display of the peripheral portion was dark with respect to the center of the display image. On the other hand, in the virtual reality display device of Example 7, the brightness of green display in the peripheral portion was improved as compared with Comparative Example 3, and the distribution of the brightness of the display image (dependence on field of view) was improved.

In addition, in the produced virtual reality display device, a green and black checker pattern was displayed on the image display panel, and visibility of ghost was visually evaluated. In the virtual reality display device of Example 3, a slight ghost image was visually recognized, but in the virtual reality display device of Example 7, the ghost image was reduced and the visibility of ghost was improved.

### Example 8

### <Production of Optical Unit>

An optical unit 12 was produced in the same manner as in the production of the optical unit 8 in Example 4, except that the λ/4 plate 1, the linear polarizer, and the antireflection film were bonded in this order to the surface of the support, opposite to the cholesteric liquid crystal layer G2 of the reflective type liquid crystal diffraction element.

### [Evaluation]

The circularly polarizing plate 1 and the optical unit produced as described above were arranged to face each other, and evaluation was performed. The circularly polarizing plate 1 and the optical unit were arranged in the order of the linear polarizer and the λ/4 plate 1 of the circularly polarizing plate 1, and the volume hologram, the reflective type liquid crystal diffraction element, the λ/4 plate 1, and the linear polarizer of the optical unit. In addition, the evaluation was performed by disposing the linear polarizer of the circularly polarizing plate 1 and the reflective type liquid crystal diffraction element of the optical unit such that the distance therebetween was 15 mm and allowing light to be incident from the linear polarizer side of the circularly polarizing plate 1.

In a case where light was incident into the circularly polarizing plate, intensity of light emitted from the optical unit was evaluated. The in-plane position of each element was set to 0 mm in the plane of each element at the intersection of the normal direction and each element (the linear polarizer, the λ/4 plate, the half mirror, and the like) from the center of the concentric circle of the liquid crystal diffraction element, and was represented as a radial distance. In addition, the incidence angle was represented as an angle with respect to a perpendicular line, in which a direction perpendicular to the main surface of the circularly polarizing plate 1 was set to 0°.

At a position of 3 mm in the circularly polarizing plate 1, a laser (wavelength: 532 nm) was incident at an incidence angle of −2.7°, a photodetector was disposed at a position 11 mm away from the optical unit in the laminating direction, and the intensity of light emitted from the optical unit was measured. Similarly, at a position of 13 mm in the circularly polarizing plate 1 and at a position of 16 mm in the circularly polarizing plate 1, the intensity of light emitted from the optical unit was measured in a case where a laser (wavelength: 532 nm) was incident at an incidence angle of −7.4° and an incidence angle of −8°, respectively. At a position of 3 mm in the circularly polarizing plate 1, light in which a laser (wavelength: 532 nm) was incident at an incidence angle of −2.7° was emitted from the optical unit at a position of 4 mm and an emission angle of 17°. In addition, at a position of 13 mm in the circularly polarizing plate 1, light in which a laser (wavelength: 532 nm) was incident at an incidence angle of −7.4° was emitted from the optical unit at a position of 15 mm and an emission angle of 50°, and light incident at an incidence angle of −8° at a position of 16 mm was emitted from the optical unit at a position of 18 mm and an emission angle of 55°.

In a case where light was incident on the circularly polarizing plate from the position of 3 mm, the amounts of light emitted from the optical unit 7 produced in Comparative Example 4 and the optical unit 12 produced in Example 8 were substantially the same. On the other hand, in a case where light was incident on the circularly polarizing plate from the position of 13 mm and the position of 16 mm, the amount of light emitted from the optical unit 12 of Example 8 was increased with respect to the optical unit 7 of Comparative Example 4.

### <Production of Virtual Reality Display Device>

A virtual reality display device of Example 8 was produced in the same manner as in the production of the virtual reality display device of Comparative Example 1, except that the optical unit 1 was changed to the optical unit 12 produced in Example 8. The volume hologram was disposed on the circularly polarizing plate side, and the distance between the linear polarizer of the circularly polarizing plate 1 and the reflective type liquid crystal diffraction element of the optical unit was set to 15 mm.

In the produced virtual reality display device, a green and black checker pattern was displayed on the image display panel, and distribution of the brightness of the display was visually evaluated. In the virtual reality display device of Comparative Example 4, green display of the peripheral portion was dark with respect to the center of the display image. On the other hand, in the virtual reality display device of Example 8, the brightness of green display in the peripheral portion was improved as compared with Comparative Example 4, and the distribution of the brightness of the display image (dependence on field of view) was improved.

In addition, in the produced virtual reality display device, a green and black checker pattern was displayed on the image display panel, and visibility of ghost was visually evaluated. In the virtual reality display device of Example 4, a slight ghost image was visually recognized, but in the virtual reality display device of Example 8, the ghost image was reduced and the visibility of ghost was improved.

### Example 9

### <Production of Transmissive Type Liquid Crystal Diffraction Element>

### (Exposure of Alignment Film)

An alignment film PA-1 having a radial alignment pattern was formed in the same manner as in the exposure of the alignment film using the exposure device shown in FIG. 20 in the production of the reflective type liquid crystal diffraction element of Comparative Example 1, except that the single period of the in-plane alignment pattern was changed.

### (Formation of Optically Anisotropic Layer)

As a liquid crystal composition forming a first optically anisotropic layer, the following composition A-1 was prepared.

### Composition A-1

| | |
|---|---|
| Liquid crystal compound L-1 | 10.00 parts by mass |
| Liquid crystal compound L-2 | 90.00 parts by mass |
| Chiral agent C2 | 0.66 parts by mass |
| Polymerization initiator (manufactured by BASF, Irgacure OXE01) | 1.00 part by mass |
| Surfactant F1 | 0.30 parts by mass |
| Methyl ethyl ketone | 550.00 parts by mass |
| Cyclopentanone | 550.00 parts by mass |

Liquid crystal compound L-2 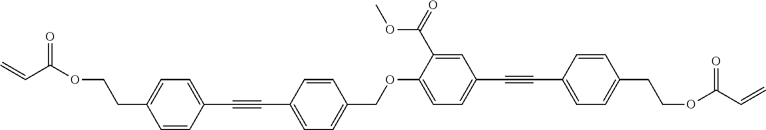 [SMILES: C=CC(=O)OCCc1ccc(C#Cc2ccc(COc3ccc(C#Cc4ccc(CCOC(=O)C=C)cc4)cc3C(=O)OC)cc2)cc1]
Chiral agent C2

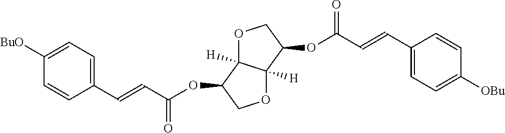

An optically anisotropic layer was formed by applying the composition A-1 onto the alignment film PA-1 in multiple layers. The application in multiple layers refers to repetition of processes including producing a first liquid crystal immobilized layer by applying the first layer-forming composition A-1 onto the alignment film, heating the composition A-1, and irradiating the composition A-1 with ultraviolet light for curing; and producing a second or subsequent liquid crystal immobilized layer by applying the second or subsequent layer-forming composition A-1 onto the formed liquid crystal immobilized layer, heating the composition A-1, and irradiating the composition A-1 with ultraviolet light for curing as described above. Even in a case where the optically anisotropic layer was formed by the application of the multiple layers such that the total thickness of the optically anisotropic layer was large, the alignment direction of the alignment film was reflected from a lower surface of the optically anisotropic layer to an upper surface thereof.

Regarding a first layer, the above-described composition A-1 was applied onto the alignment film PA-1 to form a coating film, the coating film was heated to 80° C. on a hot plate, the coating film was irradiated with ultraviolet rays having a wavelength of 365 nm at an irradiation amount of 300 mJ/cm² using a high-pressure mercury lamp in a nitrogen atmosphere, thereby fixing the alignment of the liquid crystal compound.

Regarding the second or subsequent layer, the composition was applied onto the liquid crystal immobilized layer, and heated, and cured with ultraviolet rays under the same conditions as described above to produce a liquid crystal immobilized layer. In this way, by repeating the application multiple times until the total thickness reached a desired film thickness, an optically anisotropic layer was formed, and a liquid crystal diffraction element was produced.

A birefringence index Δn of the cured layer of the liquid crystal composition A-1 was obtained by applying the liquid crystal composition A-1 onto a support with an alignment film for retardation measurement, which was prepared separately, aligning a director of the liquid crystal compound to be parallel to the base material, irradiating the liquid crystal composition A-1 with ultraviolet rays for immobilization to obtain a liquid crystal immobilized layer (cured layer), and measuring a retardation value and a film thickness of the liquid crystal immobilized layer. An could be calculated by dividing the retardation value by the film thickness. The retardation value was measured by measuring a desired wavelength using Axoscan (manufactured by Axometrix, inc.) and measuring the film thickness using a SEM.

In the produced first optically anisotropic layer, Δn₅₅₀×thickness (Re(550)) of the liquid crystals was 160 nm, and it was confirmed using a polarization microscope that periodic alignment occurred on the surface. In addition, in the optically anisotropic layer, a twisted angle of the liquid crystal compound in the thickness direction was −80°. In the liquid crystal alignment pattern of the optically anisotropic layer, regarding a single period over which the optical axis of the liquid crystal compound rotated by 180°, a single period of a portion at a distance of 3 mm from the center was 17.8 μm; a single period of a portion at a distance of 13 mm from the center was 4.1 μm; a single period of a portion at a distance of 16 mm from the center was 3.4 μm; and the single period decreased toward the outer direction.

As a liquid crystal composition forming a second optically anisotropic layer, the following composition A-2 was prepared.

### Composition A-2

| | | |
|---|---|---|
| Liquid crystal compound L-1 | 10.00 | parts by mass |
| Liquid crystal compound L-2 | 90.00 | parts by mass |
| Polymerization initiator (manufactured by | 1.00 | part by mass |
| BASF, Irgacure OXE01) | | |
| Surfactant F1 | 0.30 | parts by mass |
| Methyl ethyl ketone | 550.00 | parts by mass |
| Cyclopentanone | 550.00 | parts by mass |

A second optically anisotropic layer was formed of the composition A-2 by the same method for the first optically anisotropic layer, except that the film thickness of the optically anisotropic layer was adjusted.

In the produced second optically anisotropic layer, Δn₅₅₀×thickness (Re(550)) of the liquid crystals was 330 nm, and it was confirmed using a polarization microscope that periodic alignment occurred on the surface. In addition, in the optically anisotropic layer, a twisted angle of the liquid crystal compound in the thickness direction was 0°. In the liquid crystal alignment pattern of the optically anisotropic layer, regarding a single period over which the optical axis of the liquid crystal compound rotated by 180°, a single period of a portion at a distance of 3 mm from the center was 17.8 μm; a single period of a portion at a distance of 13 mm from the center was 4.1 μm; a single period of a portion at a distance of 16 mm from the center was 3.4 μm; and the single period decreased toward the outer direction.

As a liquid crystal composition forming a third optically anisotropic layer, the following composition A-3 was prepared.

### Composition A-3

| | |
|---|---|
| Liquid crystal compound L-1 | 10.00 parts by mass |
| Liquid crystal compound L-2 | 90.00 parts by mass |
| Chiral agent C4 | 0.62 parts by mass |
| Polymerization initiator (manufactured by BASF, Irgacure OXE01) | 1.00 part by mass |
| Surfactant F1 | 0.30 parts by mass |
| Methyl ethyl ketone | 550.00 parts by mass |
| Cyclopentanone | 550.00 parts by mass |

Chiral agent C4

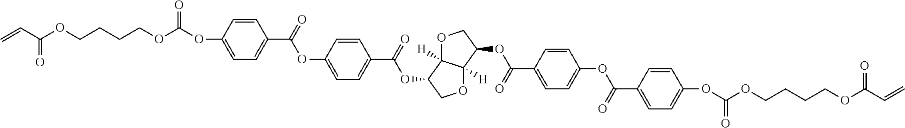 [SMILES: C=CC(=O)OCCCCOC(=O)Oc1ccc(C(=O)Oc2ccc(C(=O)O[C@H]3CO[C@H]4[C@@H]3OC[C@H]4OC(=O)c3ccc(OC(=O)c4ccc(OC(=O)OCCCCOC(=O)C=C)cc4)cc3)cc2)cc1]

A third optically anisotropic layer was formed of the composition A-3 by the same method for the first optically anisotropic layer, except that the film thickness of the optically anisotropic layer was adjusted, thereby laminating the first to third optically anisotropic layers to obtain a transmissive type liquid crystal diffraction element T1.

In the produced third optically anisotropic layer, Δn₅₅₀×thickness (Re(550)) of the liquid crystals was 160 nm, and it was confirmed using a polarization microscope that periodic alignment occurred on the surface. In addition, in the optically anisotropic layer, a twisted angle of the liquid crystal compound in the thickness direction was 80°. In the liquid crystal alignment pattern of the optically anisotropic layer, regarding a single period over which the optical axis of the liquid crystal compound rotated by 180°, a single period of a portion at a distance of 3 mm from the center was 17.8 μm; a single period of a portion at a distance of 13 mm from the center was 4.1 μm; a single period of a portion at a distance of 16 mm from the center was 3.4 μm; and the single period decreased toward the outer direction.

In the production of the circularly polarizing plate 1, a circularly polarizing plate was produced by bonding the linear polarizer and the λ/4 plate 1 with a slow axis rotated by 90°, and the transmissive type liquid crystal diffraction element T1 was bonded thereto to obtain a laminated optical body CG1. In the laminated optical body CG1, the transmissive type liquid crystal diffraction element T1 functions as a divergent lens with respect to the incidence light from the λ/4 plate.

### [Evaluation]

In Example 9, the laminated optical body CG1 produced as described above and the optical unit 4 produced in Example 2 were arranged to face each other, and evaluation was performed. The laminated optical body CG1 and the optical unit were disposed in the order of the laminated optical body CG1 (linear polarizer, λ/4 plate 1, transmissive type liquid crystal diffraction element T1) and the optical unit (half mirror and reflective type liquid crystal diffraction element G2). In addition, the evaluation was performed by disposing the linear polarizer of the laminated optical body CG1 and the reflective type liquid crystal diffraction element of the optical unit such that the distance therebetween was 15 mm and allowing light to be incident from the side of the linear polarizer.

In a case where light was incident into the circularly polarizing plate, intensity of light emitted from the optical unit was evaluated. The in-plane position of each element was set to 0 mm in the plane of each element at the intersection of the normal direction and each element (the linear polarizer, the λ/4 plate, the half mirror, and the like) from the center of the concentric circle of the liquid crystal diffraction element, and was represented as a radial distance. In addition, the incidence angle was represented as an angle with respect to a perpendicular line, in which a direction perpendicular to the main surface of the circularly polarizing plate 1 was set to 0°.

At a position of 3 mm in the circularly polarizing plate 1, a laser (wavelength: 532 nm) was incident at an incidence angle of −2.7°, a photodetector was disposed at a position 11 mm away from the optical unit in the laminating direction, and the intensity of light emitted from the optical unit was measured. Similarly, at a position of 13 mm in the circularly polarizing plate 1 and at a position of 16 mm in the circularly polarizing plate 1, the intensity of light emitted from the optical unit was measured in a case where a laser (wavelength: 532 nm) was incident at an incidence angle of −7.4° and an incidence angle of −8°, respectively. At a position of 3 mm in the circularly polarizing plate 1, light in which a laser (wavelength: 532 nm) was incident at an incidence angle of −2.7° was emitted from the optical unit at a position of 4 mm and an emission angle of 15°. In addition, at a position of 13 mm in the circularly polarizing plate 1, light in which a laser (wavelength: 532 nm) was incident at an incidence angle of −7.4° was emitted from the optical unit at a position of 15 mm and an emission angle of 45°, and light incident at an incidence angle of −8° at a position of 16 mm was emitted from the optical unit at a position of 18 mm and an emission angle of 50°.

In a case where light was incident on the circularly polarizing plate from the position of 3 mm, the amounts of light emitted from the optical unit 4 produced in Example 2 and the combined configuration of the laminated optical body CG1 produced in Example 9 and the optical unit 4 were substantially the same. On the other hand, in a case where light was incident on the circularly polarizing plate from the position of 13 mm and from the position of 16 mm, the amount of light emitted from the combined configuration of the laminated optical body CG1 produced in Example 9 and the optical unit 4 was further increased with respect to that from the optical unit 4 produced in Example 2.

### <Production of Virtual Reality Display Device>

A virtual reality display device “Huawei VR Glass” manufactured by Huawei Technologies Co., Ltd., which was a virtual reality display device for which a reciprocating optical system was employed, was disassembled, and all composite lenses were taken out. The produced laminated optical body CG1 described above was bonded to a display of “Huawei VR Glass” (laminated in the order of display, linear polarizer, λ/4 plate 1, and transmissive type liquid crystal diffraction element T1). Next, a virtual reality display device of Example 9 was produced by installing the optical unit 4 produced in Example 2 on the front surface (half mirror was disposed on the transmissive type liquid crystal diffraction element T1 side). In this case, the linear polarizer of the laminated optical body CG1 and the reflective type liquid crystal diffraction element of the optical unit 4 were arranged such that the distance therebetween was 15 mm.

In the produced virtual reality display device, a green and black checker pattern was displayed on the image display panel, and distribution of the brightness of the display was visually evaluated. In the virtual reality display device of Comparative Example 1, green display of the peripheral portion was dark with respect to the center of the display image. On the other hand, in the virtual reality display device of Example 9, the brightness of green display in the peripheral portion was improved as compared with Comparative Example 1, and the distribution of the brightness of the display image (dependence on field of view) was improved. In addition, in the virtual reality display device of Example 9, the brightness of green display in the peripheral portion was further improved as compared with the virtual reality display device of Example 2, and the distribution of the brightness of the display image (dependence on field of view) was further improved.

### Example 10

The transmissive liquid crystal diffraction element T1 produced in Example 9 was laminated on the reflective type liquid crystal diffraction element of the optical unit 4 produced in Example 2 to produce an optical unit 13.

### [Evaluation]

The circularly polarizing plate 1 and the optical unit produced as described above were arranged to face each other, and evaluation was performed. The circularly polarizing plate 1 and the optical unit were disposed in the order of the circularly polarizing plate 1 (linear polarizer and λ/4 plate 1) and the optical unit (half mirror, reflective type liquid crystal diffraction element, and transmissive type liquid crystal diffraction element T1). In addition, the evaluation was performed by disposing the linear polarizer of the circularly polarizing plate 1 and the reflective type liquid crystal diffraction element of the optical unit such that the distance therebetween was 15 mm and allowing light to be incident from the side of the linear polarizer.

In a case where light was incident into the circularly polarizing plate, intensity of light emitted from the optical unit was evaluated. The in-plane position of each element was set to 0 mm in the plane of each element at the intersection of the normal direction and each element (the linear polarizer, the λ/4 plate, the half mirror, and the like) from the center of the concentric circle of the liquid crystal diffraction element, and was represented as a radial distance. In addition, the incidence angle was represented as an angle with respect to a perpendicular line, in which a direction perpendicular to the main surface of the circularly polarizing plate 1 was set to 0°.

At a position of 3 mm in the circularly polarizing plate 1, a laser (wavelength: 532 nm) was incident at an incidence angle of −2.7°, a photodetector was disposed at a position 11 mm away from the optical unit in the laminating direction, and the intensity of light emitted from the optical unit was measured. Similarly, at a position of 13 mm in the circularly polarizing plate 1 and at a position of 16 mm in the circularly polarizing plate 1, the angle of emitted light emitted from the optical unit was measured in a case where a laser (wavelength: 532 nm) was incident at an incidence angle of −7.4° and an incidence angle of −8°, respectively.

In a case where light was incident on the circularly polarizing plate from the position of 13 mm and the position of 16 mm, the angle of light emitted from the optical unit 13 produced in Example 10 was increased with respect to the optical unit 4 produced in Example 2.

### <Production of Virtual Reality Display Device>

A virtual reality display device of Example 10 was produced in the same manner as in the production of the virtual reality display device of Example 2, except that the optical unit 4 was changed to the optical unit 13. The half mirror was disposed on the circularly polarizing plate side such that the distance between the linear polarizer and the liquid crystal diffraction element of the optical unit was 15 mm. In the produced virtual reality display device, a green and black checker pattern was displayed on the image display panel, and distribution of the brightness of the display was visually evaluated. In the virtual reality display device of Example 10, the field of view at which the virtual image was visible was enlarged as compared with Example 2.

### Example 11

An optical unit 14 was produced by laminating the λ/4 plate 1 and the linear polarizer on the surface of the transmissive type liquid crystal diffraction element T1 of the optical unit 13 produced in Example 10.

### [Evaluation]

The circularly polarizing plate 1 and the optical unit produced as described above were arranged to face each other, and evaluation was performed. The circularly polarizing plate 1 and the optical unit were disposed in the order of the circularly polarizing plate 1 (linear polarizer and λ/4 plate 1) and the optical unit (half mirror, reflective type liquid crystal diffraction element, and transmissive type liquid crystal diffraction element T1). In addition, the evaluation was performed by disposing the linear polarizer of the circularly polarizing plate 1 and the reflective type liquid crystal diffraction element of the optical unit such that the distance therebetween was 15 mm and allowing light to be incident from the side of the linear polarizer.

At a position of 3 mm in the circularly polarizing plate 1, a laser (wavelength: 532 nm) was incident at an incidence angle of −2.7°, a photodetector was disposed at a position 11 mm away from the optical unit in the laminating direction, and the intensity of light emitted from the optical unit was measured. Similarly, at a position of 13 mm in the circularly polarizing plate 1 and at a position of 16 mm in the circularly polarizing plate 1, the intensity of light emitted from the optical unit was measured in a case where a laser (wavelength: 532 nm) was incident at an incidence angle of −7.4° and an incidence angle of −8°, respectively.

In a case where light was incident on the circularly polarizing plate from the position of 13 mm and the position of 16 mm, the angle of light emitted from the optical unit 14 produced in Example 11 was increased with respect to the optical unit 4 produced in Example 2.

### <Production of Virtual Reality Display Device>

A virtual reality display device of Example 11 was produced in the same manner as in the production of the virtual reality display device of Example 2, except that the optical unit 4 was changed to the optical unit 14. The half mirror was disposed on the circularly polarizing plate side such that the distance between the linear polarizer and the reflective type liquid crystal diffraction element of the optical unit was 15 mm.

In the produced virtual reality display device, a green and black checker pattern was displayed on the image display panel, and distribution of the brightness of the display was visually evaluated. The virtual reality display device of Example 11 had reduced ghost image compared to the virtual reality display device of Example 10, and ghost visibility was improved.

### Comparative Example 12

### <Production of Reflective Type Liquid Crystal Diffraction Element>

### (Formation and Exposure of Photo-Alignment Film for Cholesteric Liquid Crystal Layer B1)

A photo-alignment film was formed on the surface of the glass support in the same manner as in the formation of the photo-alignment film for the cholesteric liquid crystal layer G1.

The photo-alignment film was exposed using the exposure device shown in FIG. 20 in the same manner as described above, except that the photo-alignment film was exposed such that the single period of the alignment pattern was changed in a plane, thereby forming an alignment film P-B1 having a radial alignment pattern.

### (Formation of Cholesteric Liquid Crystal Layer B1)

A composition B-1 was prepared in the same manner as in the composition G-1, except that the addition amount of the chiral agent C1 in the composition G-1 was changed to 6.3 parts by mass and the amount of methyl ethyl ketone was changed.

A cholesteric liquid crystal layer B1 was formed in the same manner as in the formation of the cholesteric liquid crystal layer G1, except that the composition B-1 was used. In addition, in a case where a cross section of the coating layer was observed with a SEM, in the liquid crystal alignment pattern of the cholesteric liquid crystal layer B1, regarding the single period Λ over which the optical axis of the liquid crystal compound rotated by 180°, a single period of a portion at a distance of 4 mm from the center was 1.47 μm; a single period of a portion at a distance of 15 mm from the center was 0.54 μm; a single period of a portion at a distance of 18 mm from the center was 0.50 μm; and the single period decreased toward the outer direction. In addition, regarding a length of one helical pitch (helical pitch P) in the cholesteric liquid crystal layer, a helical pitch at the distance of 4 mm from the center was 277 nm, a helical pitch at the distance of 15 mm from the center was 277 nm, and a helical pitch at the distance of 18 mm from the center was 277 nm.

### (Formation and Exposure of Photo-Alignment Film for Cholesteric Liquid Crystal Layer R1)

A photo-alignment film was formed on the surface of the glass support in the same manner as in the formation of the photo-alignment film for the cholesteric liquid crystal layer G1.

The photo-alignment film was exposed using the exposure device shown in FIG. 20 in the same manner as described above, except that the photo-alignment film was exposed such that the single period of the alignment pattern was changed in a plane, thereby forming an alignment film P-R1 having a radial alignment pattern.

### (Formation of Cholesteric Liquid Crystal Layer R1)

A composition R-1 was prepared in the same manner as in the composition G-1, except that the addition amount of the chiral agent C1 in the composition G-1 was changed to 4.4 parts by mass and the amounts of methyl ethyl ketone and cyclopentanone were changed.

A cholesteric liquid crystal layer R1 was formed in the same manner as in the formation of the cholesteric liquid crystal layer G1, except that the composition R-1 was used. In addition, in a case where a cross section of the coating layer was observed with a SEM, in the liquid crystal alignment pattern of the cholesteric liquid crystal layer R1, regarding the single period Λ over which the optical axis of the liquid crystal compound rotated by 180°, a single period of a portion at a distance of 4 mm from the center was 2.07 μm; a single period of a portion at a distance of 15 mm from the center was 0.76 μm; a single period of a portion at a distance of 18 mm from the center was 0.70 μm; and the single period decreased toward the outer direction. In addition, regarding a length of one helical pitch (helical pitch P) in the cholesteric liquid crystal layer, a helical pitch at the distance of 4 mm from the center was 390 nm, a helical pitch at the distance of 15 mm from the center was 390 nm, and a helical pitch at the distance of 18 mm from the center was 390 nm.

### <Production of Reflective Type Liquid Crystal Diffraction Element>

The produced cholesteric liquid crystal layer R1 was bonded to a surface side of the glass substrate forming an antireflection layer, opposite to the antireflection layer. In the same manner, a reflective type liquid crystal diffraction element, which was a laminate of cholesteric liquid crystal layers, was produced by sequentially bonding the cholesteric liquid crystal layer G1 and the cholesteric liquid crystal layer B1 to the cholesteric liquid crystal layer R1.

### <Production of Optical Unit>

The reflective type liquid crystal diffraction element produced as described above and the half mirror 1 were disposed to face each other. The aluminum vapor-deposited surface of the half mirror 1 was disposed on a side facing the reflective type liquid crystal diffraction element. In addition, an optical unit 15 was produced such that the half mirror 1 and the reflective type liquid crystal diffraction element were disposed in this order, and the distance between the reflective liquid crystal diffraction element and the aluminum vapor-deposited surface was set to 2 mm.

### Example 12

### <Production of Reflective Type Liquid Crystal Diffraction Element>

### (Formation and Exposure of Photo-Alignment Film for Cholesteric Liquid Crystal Layer B2)

A photo-alignment film was formed on the surface of the glass support in the same manner as in the formation of the photo-alignment film for the cholesteric liquid crystal layer G2.

The photo-alignment film was exposed using the exposure device shown in FIG. 20 in the same manner as described above, except that the photo-alignment film was exposed such that the single period of the alignment pattern was changed in a plane, thereby forming an alignment film P-B1 having a radial alignment pattern.

### (Formation of Cholesteric Liquid Crystal Layer B2)

A composition B-2 was prepared in the same manner as in the composition G-2, except that the addition amount of the chiral agent C1 in the composition G-2 was changed to 7.0 parts by mass and the amount of methyl ethyl ketone was changed to 202.99 parts by mass.

A cholesteric liquid crystal layer B2 was formed in the same manner as in the formation of the cholesteric liquid crystal layer G2, except that the composition B-2 was used. In addition, in a case where a cross section of the coating layer was observed with a SEM, in the liquid crystal alignment pattern of the cholesteric liquid crystal layer B2, regarding the single period Λ over which the optical axis of the liquid crystal compound rotated by 180°, a single period of a portion at a distance of 4 mm from the center was 1.47 μm; a single period of a portion at a distance of 15 mm from the center was 0.54 μm; a single period of a portion at a distance of 18 mm from the center was 0.50 μm; and the single period decreased toward the outer direction. In addition, regarding a length of one helical pitch (helical pitch P) in the cholesteric liquid crystal layer, a helical pitch at the distance of 4 mm from the center was 277 nm, a helical pitch at the distance of 15 mm from the center was 287 nm, and a helical pitch at the distance of 18 mm from the center was 289 nm.

### (Formation and Exposure of Photo-Alignment Film for Cholesteric Liquid Crystal Layer R2)

A photo-alignment film was formed on the surface of the glass support in the same manner as in the formation of the photo-alignment film for the cholesteric liquid crystal layer G2.

The photo-alignment film was exposed using the exposure device shown in FIG. 20 in the same manner as described above, except that the photo-alignment film was exposed such that the single period of the alignment pattern was changed in a plane, thereby forming an alignment film P-R1 having a radial alignment pattern.

### (Formation of Cholesteric Liquid Crystal Layer R2)

A composition R-2 was prepared in the same manner as in the composition G-2, except that the addition amount of the chiral agent in the composition G-2 was changed to 5.3 parts by mass, the amount of methyl ethyl ketone was changed to 119.90 parts by mass, and the amount of cyclopentanone was changed to 79.93 parts by mass.

A cholesteric liquid crystal layer R2 was formed in the same manner as in the formation of the cholesteric liquid crystal layer G2, except that the composition R-2 was used. In addition, in a case where a cross section of the coating layer was observed with a SEM, in the liquid crystal alignment pattern of the cholesteric liquid crystal layer R2, regarding the single period Λ over which the optical axis of the liquid crystal compound rotated by 180°, a single period of a portion at a distance of 4 mm from the center was 2.07 μm; a single period of a portion at a distance of 15 mm from the center was 0.76 μm; a single period of a portion at a distance of 18 mm from the center was 0.70 μm; and the single period decreased toward the outer direction. In addition, regarding a length of one helical pitch (helical pitch P) in the cholesteric liquid crystal layer, a helical pitch at the distance of 4 mm from the center was 390 nm, a helical pitch at the distance of 15 mm from the center was 403 nm, and a helical pitch at the distance of 18 mm from the center was 406 nm.

### <Production of Reflective Type Liquid Crystal Diffraction Element>

The produced cholesteric liquid crystal layer R2 was bonded to a surface side of the glass substrate forming an antireflection layer, opposite to the antireflection layer. In the same manner, a reflective type liquid crystal diffraction element, which was a laminate of cholesteric liquid crystal layers, was produced by sequentially bonding the cholesteric liquid crystal layer G2 and the cholesteric liquid crystal layer B2 to the cholesteric liquid crystal layer R2.

### <Production of Optical Unit>

The reflective type liquid crystal diffraction element produced as described above and the half mirror 1 were disposed to face each other. The aluminum vapor-deposited surface of the half mirror 1 was disposed on a side facing the reflective type liquid crystal diffraction element. In addition, an optical unit 16 was produced such that the half mirror 1 and the reflective type liquid crystal diffraction element were disposed in this order, and the distance between the reflective liquid crystal diffraction element and the aluminum vapor-deposited surface was set to 2 mm.

### [Evaluation]

The circularly polarizing plate 1 and the optical unit produced as described above were arranged to face each other, and evaluation was performed. The circularly polarizing plate 1 and the optical unit were disposed in the order of the circularly polarizing plate 1 (linear polarizer and λ/4 plate 1) and the optical unit (half mirror and reflective type liquid crystal diffraction element). In addition, the evaluation was performed by disposing the linear polarizer of the circularly polarizing plate 1 and the reflective type liquid crystal diffraction element of the optical unit such that the distance therebetween was 15 mm and allowing light to be incident from the side of the linear polarizer.

In a case where light was incident into the circularly polarizing plate, intensity of light emitted from the optical unit was evaluated. The in-plane position of each element was set to 0 mm in the plane of each element at the intersection of the normal direction and each element (the linear polarizer, the λ/4 plate, the half mirror, and the like) from the center of the concentric circle of the liquid crystal diffraction element, and was represented as a radial distance. In addition, the incidence angle was represented as an angle with respect to a perpendicular line, in which a direction perpendicular to the main surface of the circularly polarizing plate 1 was set to 0°.

At a position of 3 mm in the circularly polarizing plate 1, a laser (wavelength: 450 nm, 532 nm, and 650 nm) was incident at an incidence angle of −2.7°, a photodetector was disposed at a position 11 mm away from the optical unit in the laminating direction, and the intensity of light emitted from the optical unit was measured. Similarly, at a position of 13 mm in the circularly polarizing plate 1 and at a position of 16 mm in the circularly polarizing plate 1, the intensity of light emitted from the optical unit was measured in a case where a laser (wavelength: 450 nm, 532 nm, and 650 nm) was incident at an incidence angle of −7.4° and an incidence angle of −8°, respectively. At a position of 3 mm in the circularly polarizing plate 1, light in which a laser (wavelength: 450 nm, 532 nm, and 650 nm) was incident at an incidence angle of −2.7° was emitted from the optical unit at a position of 4 mm and an emission angle of 15°. In addition, at a position of 13 mm in the circularly polarizing plate 1, light in which a laser (wavelength: 450 nm, 532 nm, and 650 nm) was incident at an incidence angle of −7.4° was emitted from the optical unit at a position of 15 mm and an emission angle of 45°, and light incident at an incidence angle of −8° at a position of 16 mm was emitted from the optical unit at a position of 18 mm and an emission angle of 50°.

In a case where light was incident on the circularly polarizing plate from the position of 3 mm, the amounts of light (wavelength: 450 nm, 532 nm, and 650 nm) emitted from the optical unit 16 produced in Example 12 and the optical unit 15 produced in Comparative Example 12 were substantially the same. On the other hand, in a case where light was incident on the circularly polarizing plate from the position of 13 mm and the position of 16 mm, the amount of light (wavelength: 450 nm, 532 nm, and 650 nm) emitted from the optical unit 16 of Example 12 was increased with respect to the optical unit 15 of Comparative Example 12.

### <Production of Virtual Reality Display Device>

A virtual reality display device of Comparative Example 12 was produced in the same manner as in the production of the virtual reality display device of Comparative Example 2, except that the optical unit 3 was changed to the optical unit 15 produced in Comparative Example 12. The half mirror was disposed on the circularly polarizing plate side such that the distance between the linear polarizer and the liquid crystal diffraction element of the optical unit was 15 mm.

A virtual reality display device of Example 12 was produced using the optical unit 16 in the same manner.

In the produced virtual reality display device, a white and black checker pattern was displayed on the image display panel, and distribution of the brightness of the display was visually evaluated. In the virtual reality display device of Comparative Example 12, white display of the peripheral portion was dark with respect to the center of the display image. On the other hand, in the virtual reality display device of Example 12, the brightness of white display in the peripheral portion was improved as compared with Comparative Example 12, and the distribution of the brightness of the display image (dependence on field of view) was improved.

From the above results, the effect of the present invention is clear.

### EXPLANATION OF REFERENCES

18: partial reflection element (reflective type liquid crystal diffraction element)
20: support
24: alignment film
26, 34: cholesteric liquid crystal layer
30: liquid crystal compound
30A: optical axis
100: exposure device
101a, 101b, 101c: laser light source
102a, 102b, 102c: dichroic mirror
103: polarization beam splitter
104: plane mirror
105: beam expander
106: first aspherical lens
107: second aspherical lens
108: hologram photosensitive material
109: focal point of first aspherical lens
110: hologram lens
111: first luminous flux
112: second luminous flux
113: diffracted light
200, 200a to 200f: image display system
202: image display element
204: circularly polarizing plate
206: linear polarizer
208: λ/4 retardation plate
210, 210a to 210f: optical unit
211: first partial reflection element
213: second partial reflection element
212: reflective type liquid crystal diffraction element
214: half mirror
215: reflective volume hologram
216: circularly polarizing plate
218: first transmissive type polarization diffraction element
220: optical element (second transmissive type polarization diffraction element)
Λ, Λ_{A0}, Λ_{A1}, Λ_{A2}: single period
PT₀, PT₁, PT₂: helical pitch
A0, A1, A2: region
θ_{A0}, θ_{A1}, θ_{A2}: angle
G_{R0}, G_{R1}, and G_{R2}: dextrorotatory circularly polarized light of green light
D₁, D₂, D₃: alignment axis

What is claimed is:

1. An optical unit comprising:
a first partial reflection element; and
a second partial reflection element,
wherein any one of the first partial reflection element or the second partial reflection element includes a cholesteric liquid crystal layer,
the cholesteric liquid crystal layer has a liquid crystal alignment pattern in which an orientation of an optical axis derived from the liquid crystal compound changes while continuously rotating in at least one in-plane direction,
in a case where a length over which the orientation of the optical axis derived from the liquid crystal compound rotates by 180° in a plane is set as a single period, the cholesteric liquid crystal layer has regions having different lengths of the single periods in the plane, and
the cholesteric liquid crystal layer has regions having different helical pitches of helical structures in the plane.

2. The optical unit according to claim 1,
wherein, in a region of the cholesteric liquid crystal layer where the length of the single period in the liquid crystal alignment pattern is short, the helical pitch is large.

3. The optical unit according to claim 1,
wherein the cholesteric liquid crystal layer has a region where the length of the single period in the liquid crystal alignment pattern is less than 1.0 μm.

4. The optical unit according to claim 1,
wherein any one of the first partial reflection element or the second partial reflection element includes a plurality of the cholesteric liquid crystal layers, and
at any one point in a plane, the plurality of the cholesteric liquid crystal layers have different lengths of the single periods and different helical pitches.

5. The optical unit according to claim 1,
wherein any one of the first partial reflection element or the second partial reflection element includes a first cholesteric liquid crystal layer, a second cholesteric liquid crystal layer, and a third cholesteric liquid crystal layer,
at any one point in a plane, the first to third cholesteric liquid crystal layers have different lengths of the single periods and different helical pitches,
in a case where the lengths of the single periods in the first to third cholesteric liquid crystal layers at the any one point in the plane are respectively represented by Λ1, Λ2, and Λ3, the first to third cholesteric liquid crystal layers have a region where Λ1<Λ2<Λ3 is satisfied, and
the first cholesteric liquid crystal layer has a region for diffracting blue light, the second cholesteric liquid crystal layer has a region for diffracting green light, and the third cholesteric liquid crystal layer has a region for diffracting red light.

6. The optical unit according to claim 1,
wherein the other of the first partial reflection element or the second partial reflection element is a volume hologram.

7. The optical unit according to claim 1,
wherein the optical unit comprises the first partial reflection element, the second partial reflection element, and a first transmissive type polarization diffraction element in this order, and
the first transmissive type polarization diffraction element transmits and refracts a part of light transmitted through the second partial reflection element.

8. The optical unit according to claim 7,
wherein the first transmissive type polarization diffraction element includes a liquid crystal layer formed of a liquid crystal composition containing a liquid crystal compound,
the liquid crystal layer has a liquid crystal alignment pattern in which an orientation of an optical axis derived from the liquid crystal compound changes while continuously rotating in at least one in-plane direction,
in a case where a length over which the orientation of the optical axis derived from the liquid crystal compound rotates by 180° in a plane is set as a single period, the liquid crystal layer has, in the plane, regions having different lengths of the single periods in the liquid crystal alignment pattern, and
in the plane, the liquid crystal layer has regions in which the optical axis derived from the liquid crystal compound is twisted and rotates in a thickness direction of the liquid crystal layer, and has regions having different total magnitudes of twisted angles in the thickness direction.

9. The optical unit according to claim 1,
wherein the optical unit comprises the first partial reflection element, the second partial reflection element, and a circularly polarizing plate in this order, and
the circularly polarizing plate transmits a part of light transmitted through the second partial reflection element.

10. An image display system comprising:
the optical unit according to claim 1; and
an image display element.

11. The image display system according to claim 10, further comprising:
an optical element disposed between the optical unit and the image display element,
wherein the optical element has a function of refracting light emitted from the image display element, and
the optical element has regions where refraction angles are different at different in-plane positions.

12. The image display system according to claim 10,
wherein the image display system includes the optical unit and the image display element,
the image display element includes an optical element which has a function of refracting light emitted from a light source of the image display element, and
the optical element has regions where refraction angles are different at different in-plane positions.

13. The image display system according to claim 11,
wherein the optical element includes a liquid crystal layer formed of a liquid crystal composition containing a liquid crystal compound,
the liquid crystal layer has a liquid crystal alignment pattern in which an orientation of an optical axis derived from the liquid crystal compound changes while continuously rotating in at least one in-plane direction, and
in a case where a length over which the orientation of the optical axis derived from the liquid crystal compound rotates by 180° in a plane is set as a single period, the liquid crystal layer has, in the plane, regions having different lengths of the single periods in the liquid crystal alignment pattern.

14. The image display system according to claim 12,
wherein the optical element includes a liquid crystal layer formed of a liquid crystal composition containing a liquid crystal compound,
the liquid crystal layer has a liquid crystal alignment pattern in which an orientation of an optical axis derived from the liquid crystal compound changes while continuously rotating in at least one in-plane direction, and
in a case where a length over which the orientation of the optical axis derived from the liquid crystal compound rotates by 180° in a plane is set as a single period, the liquid crystal layer has, in the plane, regions having different lengths of the single periods in the liquid crystal alignment pattern.

15. The optical unit according to claim 2,
wherein the cholesteric liquid crystal layer has a region where the length of the single period in the liquid crystal alignment pattern is less than 1.0 μm.

16. The optical unit according to claim 2,
wherein any one of the first partial reflection element or the second partial reflection element includes a plurality of the cholesteric liquid crystal layers, and
at any one point in a plane, the plurality of the cholesteric liquid crystal layers have different lengths of the single periods and different helical pitches.

17. The optical unit according to claim 2,
wherein any one of the first partial reflection element or the second partial reflection element includes a first cholesteric liquid crystal layer, a second cholesteric liquid crystal layer, and a third cholesteric liquid crystal layer,
at any one point in a plane, the first to third cholesteric liquid crystal layers have different lengths of the single periods and different helical pitches,
in a case where the lengths of the single periods in the first to third cholesteric liquid crystal layers at the any one point in the plane are respectively represented by Λ1, Λ2, and Λ3, the first to third cholesteric liquid crystal layers have a region where Λ1<Λ2<Λ3 is satisfied, and
the first cholesteric liquid crystal layer has a region for diffracting blue light, the second cholesteric liquid crystal layer has a region for diffracting green light, and the third cholesteric liquid crystal layer has a region for diffracting red light.

18. The optical unit according to claim 2,
wherein the other of the first partial reflection element or the second partial reflection element is a volume hologram.

19. The optical unit according to claim 2,
wherein the optical unit comprises the first partial reflection element, the second partial reflection element, and a first transmissive type polarization diffraction element in this order, and
the first transmissive type polarization diffraction element transmits and refracts a part of light transmitted through the second partial reflection element.

20. The optical unit according to claim 19,
wherein the first transmissive type polarization diffraction element includes a liquid crystal layer formed of a liquid crystal composition containing a liquid crystal compound,
the liquid crystal layer has a liquid crystal alignment pattern in which an orientation of an optical axis derived from the liquid crystal compound changes while continuously rotating in at least one in-plane direction,
in a case where a length over which the orientation of the optical axis derived from the liquid crystal compound rotates by 180° in a plane is set as a single period, the liquid crystal layer has, in the plane, regions having different lengths of the single periods in the liquid crystal alignment pattern, and
in the plane, the liquid crystal layer has regions in which the optical axis derived from the liquid crystal compound is twisted and rotates in a thickness direction of the liquid crystal layer, and has regions having different total magnitudes of twisted angles in the thickness direction.
